(19) United States
(12) Patent Application Publication
(10) Pub. No.: US 2009/0018028 A1
(43) Pub. Date: Jan. 15, 2009

(54) Self-Assembled Nucleic Acid Nanoarrays and Uses Therefor

(76) Inventors: Stuart Lindsay, Phoenix, AZ (US); Hao Yan, Chandler, AZ (US); John Chaput, Phoenix, AZ (US); Yan Liu, Chandler, AZ (US); Peiming Zhang, Gilbert, AZ (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/913,684

(22) PCT Filed: Feb. 15, 2006
(86) PCT No.: PCT/US06/05682

§ 371 Date: Sep. 8, 2008

Related U.S. Application Data
(60) Provisional application No. 60/680,329, filed on May 12, 2005.
(60) Provisional application No. 60/730,620, filed on Oct. 27, 2005.

(51) Int. Cl. C40B 30/04; C40B 40/06; C40B 40/08; C40B 50/04

(52) U.S. Cl. 506/9; 506/16; 506/25; 506/17

(57) ABSTRACT

The present invention provides self-assembling, finite nucleic acid tiling arrays, and methods for their synthesis and use, which overcome a major hurdle in self-assembled DNA nanostructures, and therefore have numerous potential applications for nanofabrication of complex structures and useful devices, as further disclosed herein.

### CROSS-REFERENCE

The present invention claims priority to U.S. Provisional Patent Application Ser. Nos. 60/680,329 filed May 12, 2005, and 60/730,620 filed Oct. 27, 2005, all of which are incorporated by reference herein in their entirety.

### GOVERNMENT FUNDING

The U.S. Government through the National Institute of Health provided financial assistance for this project under Grant Number 5 ROI CA085990-03, 1R21 HG03061, NSF (CCF-0453686, and NSF CCF-045368). Therefore, the United States Government may have certain rights to this invention.

### FIELD OF THE INVENTION

The present invention relates to the fields of nucleic acid-based tiling arrays, nanotechnology, and related fields.

### BACKGROUND OF THE INVENTION

Recent years have witnessed a substantial advance in using nucleic acids as smart materials to construct periodically patterned structures. For example, DNA is an extraordinarily versatile material for designing nano-architectural motifs, due in large part to its programmable G-C and A-T base pairing into well-defined secondary structures. These encoded structures are complemented by a sophisticated array of tools developed for DNA biotechnology: DNA can be manipulated using commercially available enzymes for site-selective DNA cleavage (restriction), ligation, labeling, transcription, replication, kination, and methylation. DNA nanotechnology is further empowered by well-established methods for purification, structural characterization, and by solid-phase synthesis, so that any designer DNA strands can be constructed.

Self-assembling nucleic acid tiling lattices represent a versatile system for nanoscale construction. Structure formation using nucleic acid ‘smart tiles’ begins with the chemical synthesis of single-stranded polynucleotides, which when properly annealed, self-assemble into nucleic acid tile building blocks through Watson-Crick base pairing. Recent successes in constructing self-assembled two-dimensional (2D) nucleic acid tiling arrays may lead to potential applications including nanoelectronics, nanomechanical devices, biosensors, programmable/autonomous molecular machines, and molecular computing systems.

The diversity of materials with known nucleic acid attachment chemistries considerably enhances the attractiveness of nucleic acid tiling assembly, which can be used to form superstructures upon which other materials may be assembled.

Self-assembling DNA-based nanostructures have previously been made and structures based on patterns of alternating tiles have been shown to bind molecules specifically. These prior self-assembling DNA tiling lattices provide a framework for nanoscale construction of periodic DNA arrays where individual elements in the array are not separately addressable. The programmed self-assembly of finite and/or non-periodic nucleic acid-based nanoarrays is a major challenge in nanotechnology and has numerous potential applications for nanofabrication of complex structures and useful devices.

A self-assembling, finite nucleic acid-based nanoarray that allowed a wide variety of discrete molecules to be placed at specific locations with nm-scale accuracy would find widespread use in, for example, the fields of nanoelectronics, nanomechanical devices, biosensors, programmable/autonomous molecular machines, molecular computing systems, diagnostic devices and ligand development for the pharmaceutical industry and other applications.

### SUMMARY OF THE INVENTION

In one aspect, the present invention provides finite nucleic acid tiling arrays, comprising a plurality of nucleic acid tiles joined to one another via sticky ends, wherein each nucleic acid tile comprises one or more sticky ends, and wherein a sticky end for a given nucleic acid tile is complementary to a single sticky end of another nucleic acid tile in the nucleic acid tiling array; wherein the nucleic acid tiles are present at predetermined positions within the nucleic acid tiling array as a result of programmed base pairing between the sticky ends of the nucleic acid tiles. In a preferred embodiment, one or more boundary tiles in the nucleic acid tiling array further comprise modification of one or more polynucleotides that terminate further self-assembly of the nucleic acid tiles. In a further preferred embodiment, the nucleic acid tiling array comprises an indexed feature to orient the tiling array. In another embodiment, each sticky end for a given nucleic acid tile is unique to it, and wherein each sticky end for a given nucleic acid tile is complementary to a single sticky end of one other nucleic acid tile in the nucleic acid tiling array. In a further embodiment, the number of unique tiles present in the nucleic acid tiling array is determined by a formula selected from the group consisting of:

(a) N/m, where m is 2, 3, 4, or 6 and represents a symmetry of the nucleic acid tiling array, and wherein N/m is an integral number; and

(b) N/m+1, where m is 2, 3, 4, or 6 and represents a symmetry of the nucleic acid tiling array, and wherein N/m is not an integral number.

In a further preferred embodiment, a plurality of the nucleic acid tiles further comprise a nucleic acid probe capable of binding to a target, wherein the nucleic acid probe is attached to the core polynucleotide structure. In a further preferred embodiment, the target is selected from the group consisting of DNA, RNA, polypeptides, lipids, carbohydrates, other organic molecules, inorganic molecules and metallic particles, magnets, and quantum dots. In another preferred embodiment, the DNA tiling array further comprises bound ligands.

In a second aspect, the present invention provides methods of making the nucleic acid tiling arrays of the invention, comprising

(a) forming nucleic acid tiles, comprising combining a stoichiometric amount of each polynucleotide in the nucleic acid tile under conditions suitable for specific hybridization of the polynucleotides to form the nucleic acid tile;

(b) combining the nucleic acid tiles, wherein a sticky end for a given nucleic acid tile is complementary to a single sticky end of another nucleic acid tile in the nucleic acid tiling array, and wherein each sticky end of a single nucleic acid tile specifically base pairs with a single sticky end on another nucleic acid tile, wherein the combining occurs under conditions suitable to promote specific hybridization of the sticky ends between different nucleic acid tiles; and

(c) wherein the specific hybridization of the sticky ends between different nucleic acid tiles results in formation of a finite nucleic acid tiling array.

In a third aspect, the present invention provides methods for detecting a ligand of interest, comprising:

(a) contacting a nucleic acid tiling array of the invention with a test sample thought to contain a ligand for which a probe is attached to the nucleic acid tiling array, under conditions to promote binding between the probe and the ligand; and

(b) detecting presence of the ligand bound to the probe on the DNA tiling array.

In a fourth aspect, the present invention provides nucleic acid tiling arrays, comprising:

(a) one or more nucleic acid tiles, wherein each nucleic acid tile in the nucleic acid tiling array comprises a plurality of nucleic acid probes capable of binding to a target, wherein the nucleic acid probes are attached at predetermined locations on the nucleic acid tile; and

(b) an indexing feature;

wherein the nucleic acid tiling array is of a predetermined size.

In a preferred embodiment of the fourth aspect of the invention, the nucleic acid tiling array comprises:

(a) a nucleic acid thread strand;

(b) a plurality of helper nucleic acid strands that are complementary to the nucleic acid thread strand; wherein a plurality of the helper nucleic acid strands further comprises a nucleic acid probe; and wherein the nucleic acid thread strand is folded into a desired shape by hybridization to the helper strands;

wherein the nucleic acid thread strand is not complementary to any of the nucleic acid probes, and wherein the predetermined size of the array is determined by the length and shape of the nucleic acid thread strand as folded by helper strands.

### BRIEF DESCRIPTION OF THE FIGURES

FIG. 1 is an exemplary 4 arm branched junction DNA tile.

FIG. 2A-D. Assembly of a finite-size, chemically addressable DNA nanoarray: (a) Each element is made from a cross-shaped DNA tile as shown by a planar strand pairing diagram (left) and 3D skeleton structure. (b) The 7 bp sticky ends and 16 bp ss-DNA tag are unique to each tile. The sticky end sequences are chosen so that each side hybridizes with one and only one partner to form a 3×3 array of 9 tiles. (c) The unpurified product of the hybridization reaction is shown in an AFM image. (d) A gallery of magnified images of single arrays.

FIG. 3A-F. Detection of single-molecule hybridization on the nanoarray. (a) An additional tile was added to the 9-element array to serve as an index—numbers 0-9 label each tile in the array. (b) Hybridization of the probe strand with the biotinylated target strand is labeled by streptavidin binding and detected by AFM as a bright spot at the probe position. (c) AFM images with expected signals for hybridization at tile 9. (d) AFM images with expected signals for hybridization at tile 5. (e) AFM images with expected signals for hybridization at tile 8. (f) The results of a control in which the arrays were exposed to biotinylated targets that were not complementary to any of the probes are shown as magnified images.

FIG. 4A-E. To verify the specific placement of each tile in the 9 tile array, a biotinylated strand was incorporated into certain tiles in turn, for example the center tile, the corners, the diagonals and the center tiles at each edge. The arrays were incubated with streptavidin, finding bound protein only at the predicted positions. Panels on the left are schematic drawing showing the expected position of the streptavidin (balls) on the array and panels on the right are corresponding AFM images, bright spots reveals the streptavidin.

FIG. 5 is the structure for an exemplary indexed 9-tile array containing DNA probes.

FIG. 6A-J are exemplary strand structure and sequences of individual tiles of the indexed 9 tile array of FIG. 5. Individual polynucleotide sequences can be found in Appendix A.

FIG. 7A-D. (a) An 8-helix bundle tile. A blunt ended tile is shown. (b) The design of a 5×5 fixed sized array based on the tile shown in (a). To form the 25 tile finite size array, total of 13 unique tiles are requires. Each unique tile is labeled differently (from A to M). The numbers represent the corresponding sticky ends. Totally 20 pairs of sticky ends are involved. (c) and (d). AFM images showing the formation of the 5×5 array as designed.

FIG. 8A-H. (a) A C₄ symmetric DNA tile. A blunt ended tile is shown. (b) The design of a 5×5 fixed sized array based on the tile shown in (a). To form the 25-tile finite size array, a total of 7 unique tiles are required in all 10 pairs of double sticky ends are involved. (c) and (d). AFM images showing the formation of the 5×5 array as designed. (e) and (f). When only the 4 corner tiles are used, a 2×2 array is formed. (g) and (h). When only the 3 center tiles are used, a 3×3 array is formed.

FIG. 9. Tile with C2 symmetry: Left: odd number of tiles (to form a 25 tile array, 13 unique tiles are needed); Right: Even number of tiles (to form a 16 tile array, 8 unique tiles and 12 pairs of sticky ends are needed); Bottom: The rule still apply even when the shapes of the C2 symmetry tile are different (e.g. square & rectangle, in this way, cavities of different dimensions can be obtained).

FIG. 10. Tile with C3 symmetry: Left: odd number of tiles (to form a 13 tile array, 5 unique tiles are needed); Right: Even number of tiles (to form 18 tile array, 6 unique tiles are needed); (only scheme is shown here).

FIG. 11. Tile with C4 symmetry: Left: odd number of tiles (to form a 25 tile array, 7 unique tile are needed); Right: Even number of tiles (to form a 16 tile array, 4 unique tiles are needed).

FIG. 12. Tile with C6 symmetry: Only even number of tiles exists in this case. To form a 24 tile array, 4 unique tiles are needed. (only scheme is shown here).

FIG. 13A-G. DNA tile structure and sequences from exemplary DNA tiling array shown in FIG. 7. Individual polynucleotide sequences can be found in Appendix A.

FIG. 14A-G. DNA tile structure and sequences from exemplary DNA tiling array shown in FIG. 8. Individual polynucleotide sequences can be found in Appendix A.

FIG. 15 is an exemplary nine tile array containing nine different aptamers.

FIG. 16 is an exemplary DNA thread strand-based tile.

FIG. 17 is an exemplary DNA tile incorporating locked nucleic acids. Individual polynucleotide sequences can be found in Appendix A.

FIG. 18 is an exemplary thread strand-based tile where the helper strands are part of further nucleic acid tiles.

FIG. 19 a further example of a thread strand-based tile. There are 360 single strand probes on the tile; in this case a number of the probes have the same sequence, so that when hybridized with a complementary strand the protruding dsDNA shows up in the AFM image as the letters “ASU.” The probes are spaced by about 4 nm, (A) AFM of field of tiles; (B) AFM image of individual tile.

### DETAILED DESCRIPTION OF THE INVENTION

All publications, patents and patent applications cited herein are hereby expressly incorporated by reference for all purposes.

Within this application, unless otherwise stated, the techniques utilized may be found in any of several well-known references such as: Molecular Cloning: A Laboratory Manual (Sambrook, et al., 1989, Cold Spring Harbor Laboratory Press) and PCR Protocols: A Guide to Methods and Applications (Innis, et al. 1990. Academic Press, San Diego, Calif.).

As used herein, the singular forms “a”, “an” and “the” include plural referents unless the context clearly dictates otherwise. For example, reference to a “nucleic acid” means one or more nucleic acids.

In a first aspect, the present invention provides a nucleic acid tiling array, comprising a plurality of nucleic acid tiles joined to one another via sticky ends, wherein each nucleic acid tile comprises one or more sticky ends, and wherein a sticky end for a given nucleic acid tile is complementary to a single sticky end of another nucleic acid tile in the nucleic acid tiling array; wherein the nucleic acid tiles are present at predetermined positions within the nucleic acid tiling array as a result of programmed base pairing between the sticky ends of the nucleic acid tiles.

As used herein, “nucleic acid” means DNA, RNA, peptide nucleic acids (“PNA”), and locked nucleic acids (“LNA”), nucleic acid-like structures, as well as combinations thereof and analogues thereof. Nucleic acid analogues include known analogues of natural nucleotides which have similar or improved binding properties. The term also encompasses nucleic-acid-like structures with synthetic backbones. DNA backbone analogues provided by the invention include phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholino carbamate, and peptide nucleic acids (PNAs), methylphosphonate linkages or alternating methylphosphonate and phosphodiester linkages (Strauss-Soukup (1997) Biochemistry 36:8692-8698), and benzylphosphonate linkages, as discussed in U.S. Pat. No. 6,664,057; see also Oligonucleotides and Analogues, a Practical Approach, edited by F. Eckstein, IRL Press at Oxford University Press (1991); Antisense Strategies, Annals of the New York Academy of Sciences, Volume 600, Eds. Baserga and Denhardt (NYAS1992); Milligan (1993) J. Med. Chem. 36:1923-1937; Antisense Research and Applications (1993, CRC Press).

In a preferred embodiment, the nucleic acid comprises or consists of DNA (ie: the nucleic acid tiling array comprises a DNA tiling array, with a plurality of DNA tiles, etc.)

As used herein, “programmed base pairing” means that the sticky ends for the different nucleic acid tiles are designed to ensure interactions of specific nucleic acid tiles through their complementary sticky ends, thus programming the position of the nucleic acid tile within the nucleic acid tiling array. As used herein, “predetermined positions” means that the ultimate position of each nucleic acid tile in the self-assembled nucleic acid tiling array is based on the sequence and position of its sticky ends and the sequence and position of the sticky ends of the other nucleic acid tiles in the nucleic acid tiling array, such that the plurality of nucleic acid tiles can only assemble in one specific way.

Since the position of all nucleic acid tiles in the array is predetermined, the boundary tiles are also predetermined, and thus the nucleic acid tiling arrays of the present invention have defined boundaries (ie: “finite” nucleic acid tiling arrays). The nucleic acid tiling arrays of the invention overcome a major hurdle in self-assembled nucleic acid nanostructures, and therefore have numerous potential applications for nanofabrication of complex structures and useful devices, as further disclosed herein

Each “nucleic acid tile” comprises (a) a structural element (also referred to herein as the polynucleotide “core”) constructed from a plurality of nucleic acid polynucleotides; and (b) 1 or more “sticky ends” per nucleic acid tile attached to the polynucleotide core. Those of skill in the art are well aware of the wide range of such polynucleotide cores, including but not limited to 4 arm branch junctions, 3 arm branch junctions, double crossovers, triple crossovers, parallelograms, 8 helix bundles, 6-tube formations, and structures assembled using one or more long strands of nucleic acid that are folded with the help of smaller ‘helper’ strands (See, for example, Yan, H. et al., Science 2003, 301, 1882-1884; U.S. Pat. No. 6,255,469; WO 97/41142; Seeman, N. C., Chem Biol, 2003. 10: p. 1151-9; Seeman, N. C. N., 2003. 421: p. 427-431; Winfree, E. et al., Nature, 1998. 394: p. 539-44; Fu, T. J. and N. C. Seeman, Biochemistry, 1993. 32: p. 3211-20; Seeman, N. C., J Theor Biol, 1982. 99: p. 237-47; Storhoff, J. J. and C. A. Mirkin, Chem. Rev., 1999. 99: p. 1849-1862; Yan et al., Proceedings of the National Academy of Sciences 100, Jul. 8, 2003 pp 8103-8108.) The choice of which nucleic acid tile type to use is also within the level of skill in the art, based on the teachings herein and the desired use. For example, an assembly of 4 arm branch junctions would prove useful for displaying small arrays of peptides (see below), whereas an array based on a long threading strand may prove useful for large gene-expression arrays.

Self-assembly of a plurality of nucleic acid tiles results in programmed base-pairing interactions between sticky ends on different nucleic acid tiles to form the nucleic acid tiling arrays of the invention.

As used herein, a “plurality” of nucleic acid tiles means 4 or more nucleic acid tiles. In various preferred embodiments, the nucleic acid tiling array contains at least 6, 9, 16, 25, 36, 49, 64, 81, 100, 121, 144, 169, 206, 225, 256, 289, 324, 361, or 400 nucleic acid tiles

As used herein, a “nucleic acid tiling array” is the assembled array of nucleic acid tiles of the invention based on specific Watson-Crick base pairing between sticky ends of different nucleic acid tiles. Each nucleic acid tile within the nucleic acid tiling array is located at a pre-determined position in the array, based on the complementarity of its “sticky ends” to sticky ends on a different nucleic acid tile. As will be apparent to those of skill in the art, a given nucleic acid tile may specifically bind to only one other nucleic acid tile in the nucleic acid tiling array (if the given nucleic acid tile is programmed with only a single sticky end), or it may interact with 2, 3, 4, 5, 6, 7, 8, 9, 10, 11, 12, or more other nucleic acid tiles in the nucleic acid tiling array if the given nucleic acid tile has 2, 3, 4, 5, 6, 7, 8, 9, 10, 11, 12, or more sticky ends, respectively. For example, closely packed arrays typically utilize 2-12 sticky ends, but more sticky ends might be used in an array that branched from a central point, as in a dendrimeric nucleic acid tiling array.

As discussed above, the nucleic acid tiles in the tiling array include “boundary tiles”, nucleic acid tiles that are programmed for self-assembly at the edge of the nucleic acid tiling array based on their sticky end composition. As a result, the nucleic acid tiling array is finite. In a preferred embodiment, one or more boundary tiles in the nucleic acid tiling array further comprise modification of one or more polynucleotides that terminate further self-assembly. In a non-limiting example, the modification comprises addition of “TTT” (or some other sequence that has no complement within the array) overhangs at the parts of each tile that lies at the edge of the array (or adjacent to holes in it) such that the array must not be continued beyond those points. Alternatively, no sticky ends are placed on those sections of the tiles that lie at the edges of the arrays, terminating them instead with blunt-ended nucleic acid, such as double helical DNA (and thus these boundary tiles only have sticky ends to tie into the existing array, but not to extend it).

In a further embodiment, sticky-ends can be added to the edge of the finite size arrays, thus allowing hierarchical assembly of larger arrays with defined dimensions. In this embodiment, sticky ends that are not complementary to any of the stick ends on the nucleic acid tiling array, are added to the edge of the array to permit complementary binding to any other structure of interest, such as a second finite array.

In a further preferred embodiment of this first aspect, the nucleic acid tiling array comprises an indexing feature to orient the tiling array and thus facilitate identification of each individual nucleic acid tile in the array. Any indexing feature can be used, so long as it is located at some spot on the array that has a lower symmetry than the array itself. Examples of such indexing features include, but are not limited to:

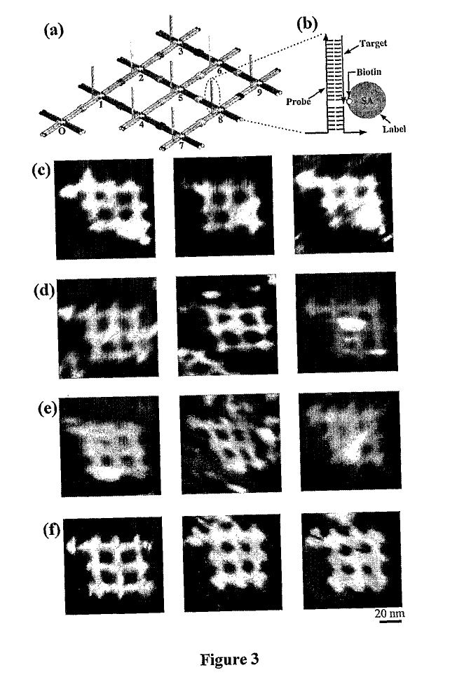

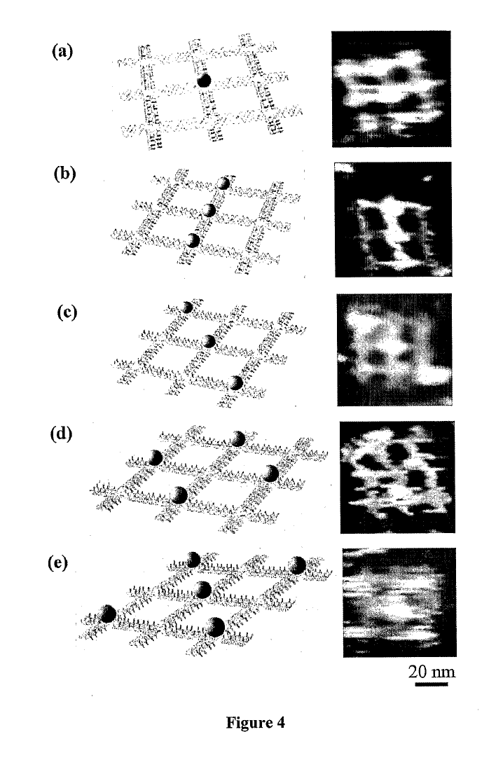

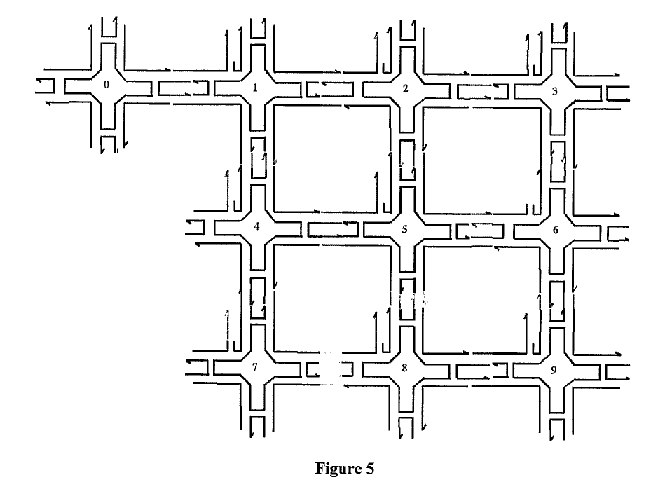

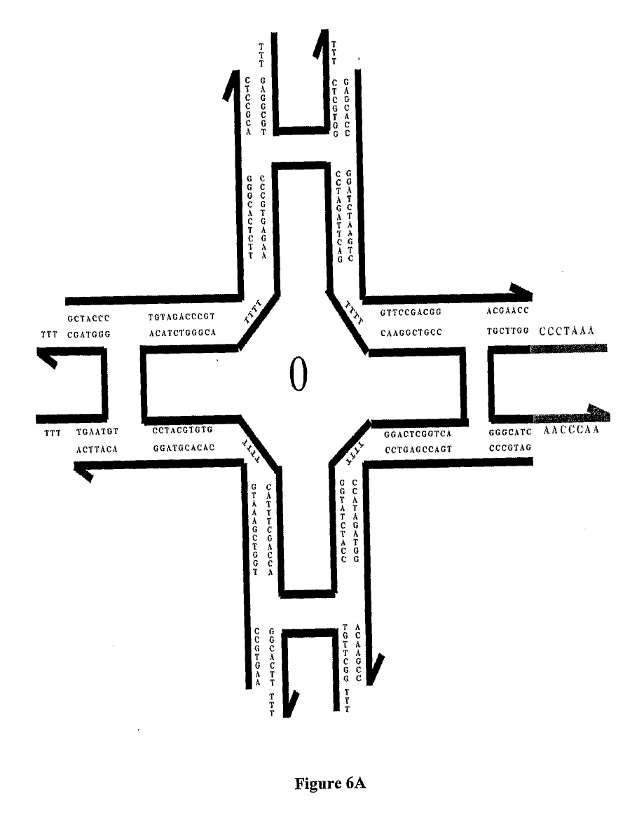

including one or more tiles that impart(s) an asymmetry to the array (see, for example, FIG. 3(a));

including one or more tiles that is/are differentially distinguishable from the other tiles (for example, by a detectable label); for example, a biotin molecule that could later be marked by exposing the array to streptavidin;

including any protrusion on an edge of the array that is offset from two edges by unequal amounts, which will serve to index the array even if it is imaged upside down;

including a high point on the array that is detectable;

introducing one or more gaps in the tiling array that introduce a detectable asymmetry; and

making the nucleic acid tiling array of low enough symmetry with respect to rotations and inversions that locations on it could be identified unambiguously; for example, a nucleic acid tiling array in the shape of a letter “L” with unequal sized arms would serve such a purpose.

As used herein, a “sticky end” is a single stranded base sequence attached to the polynucleotide core of a nucleic acid tile. For each sticky end, there is a complementary sticky end on a different nucleic acid tile with which it is designed to bind, via base pairing, within the nucleic acid tiling array. Each nucleic acid tile must contain at least one sticky end (for example, in a boundary nucleic acid tile of certain embodiments; see FIG. 3A), but may contain 2, 3, 4, 5, 6, 7, 8, 9, 10, 11, 12, or more sticky ends, depending on the design of the nucleic acid tiling array.

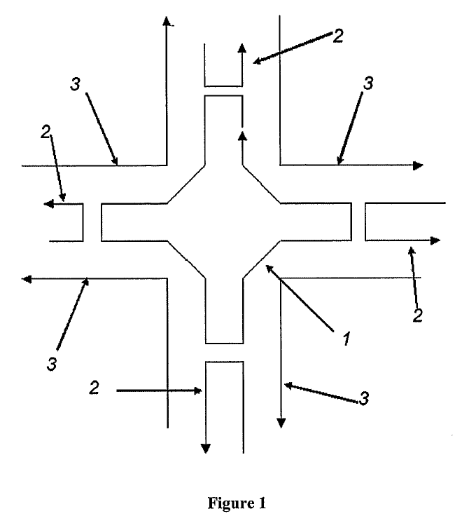

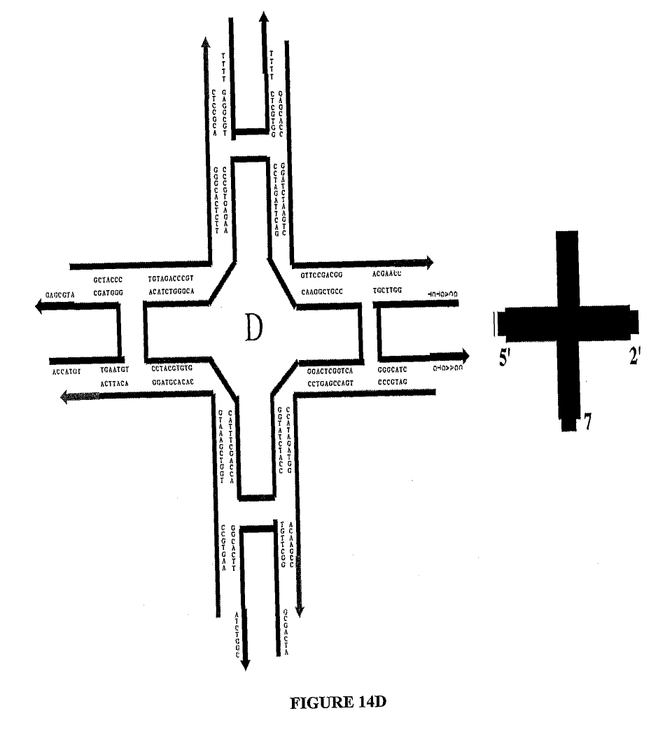

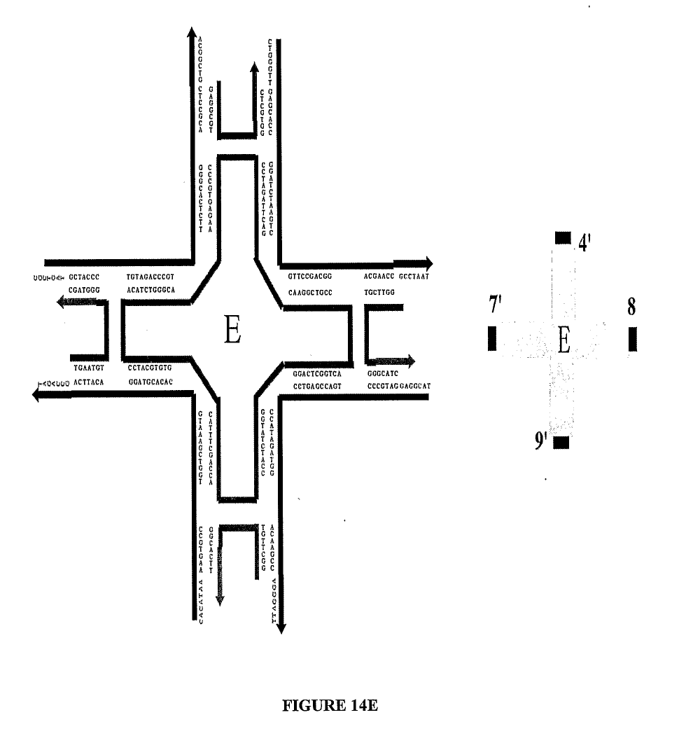

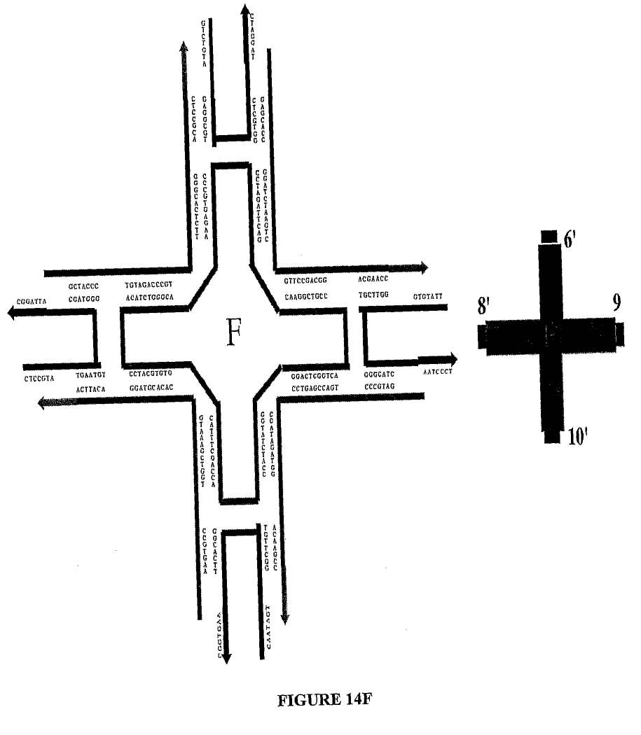

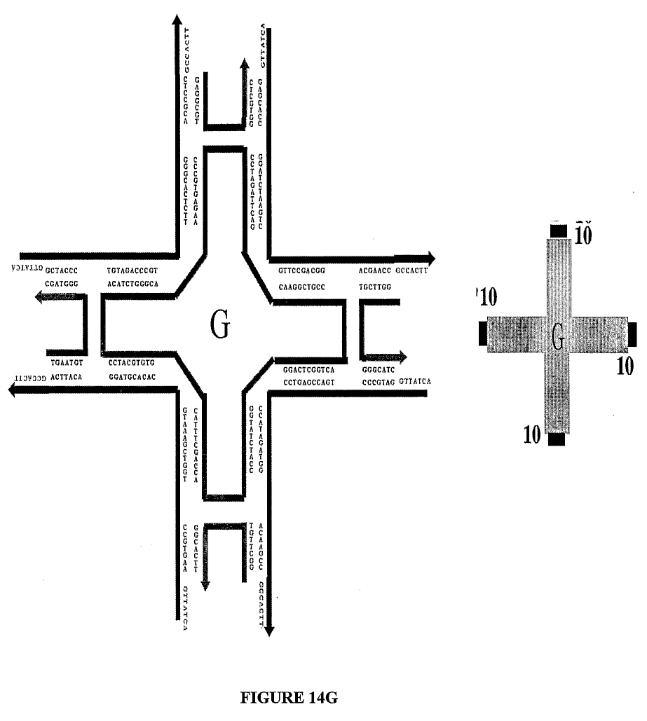

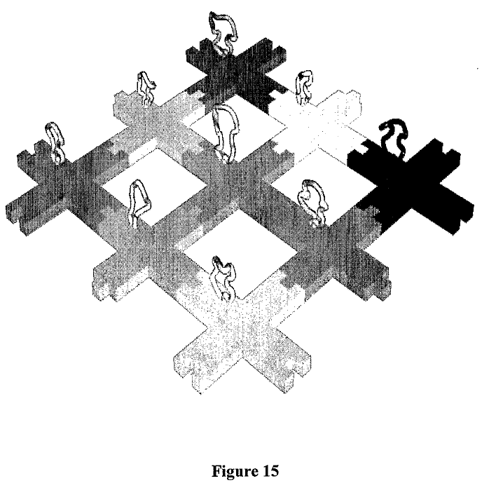

The sticky ends are incorporated into the nucleic acid tile as a portion of one or more of the core polynucleotides. It will be apparent to those of skill in the art, based on the teachings herein, that such incorporation can be carried out in a variety of ways, in part depending on the type of polynucleotide core used. See, for example, FIGS. 1, 5, 6A-6J, 7, 13A-13G, 14A-14G, and 15. As will be understood by those of skill in the art, the specific nucleic acid sequence of the core polynucleotides and sticky ends shown in these Figures is not a limitation of the present invention; the only sequence requirement is that a set of complementary polynucleotides capable of base-pairing be used.

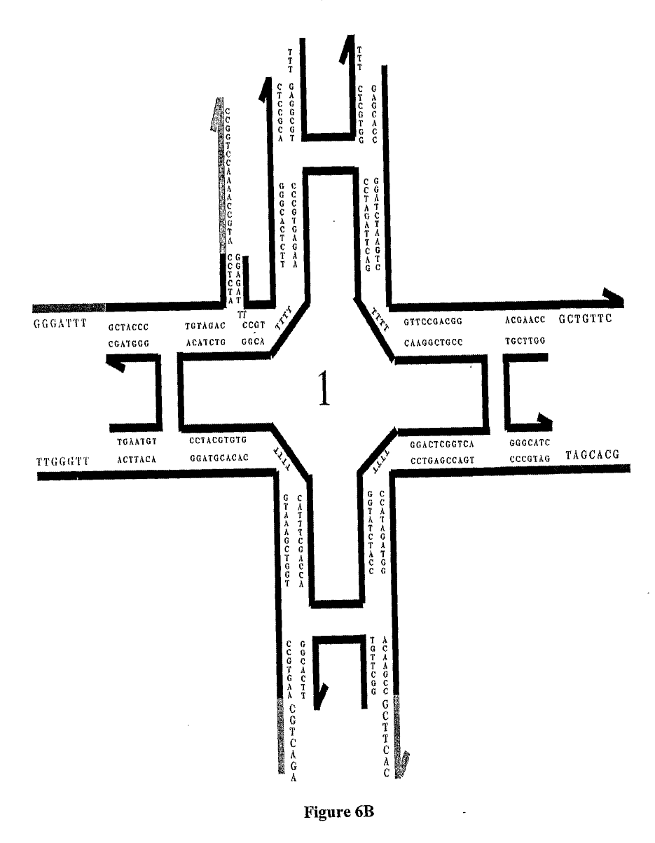

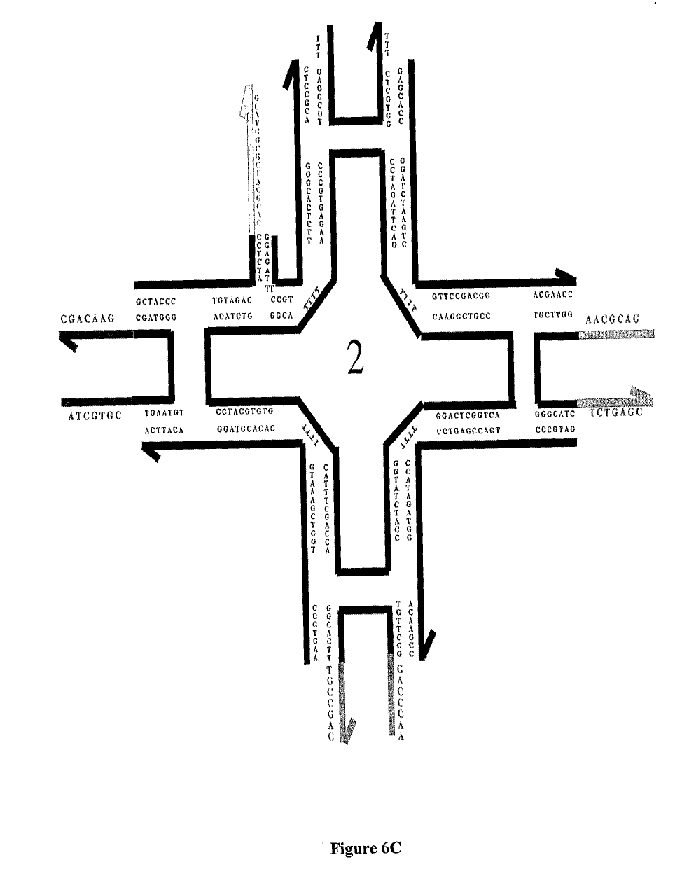

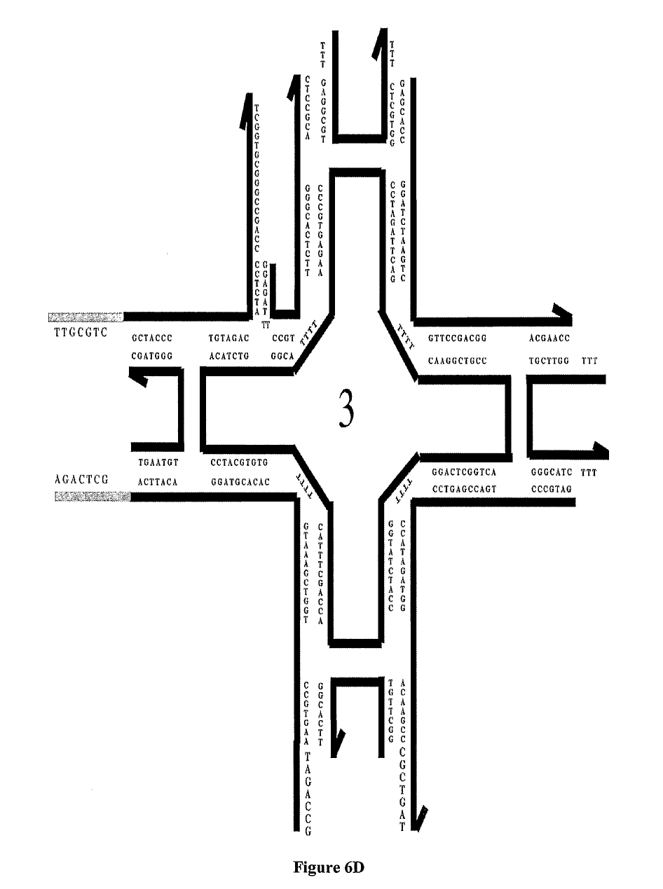

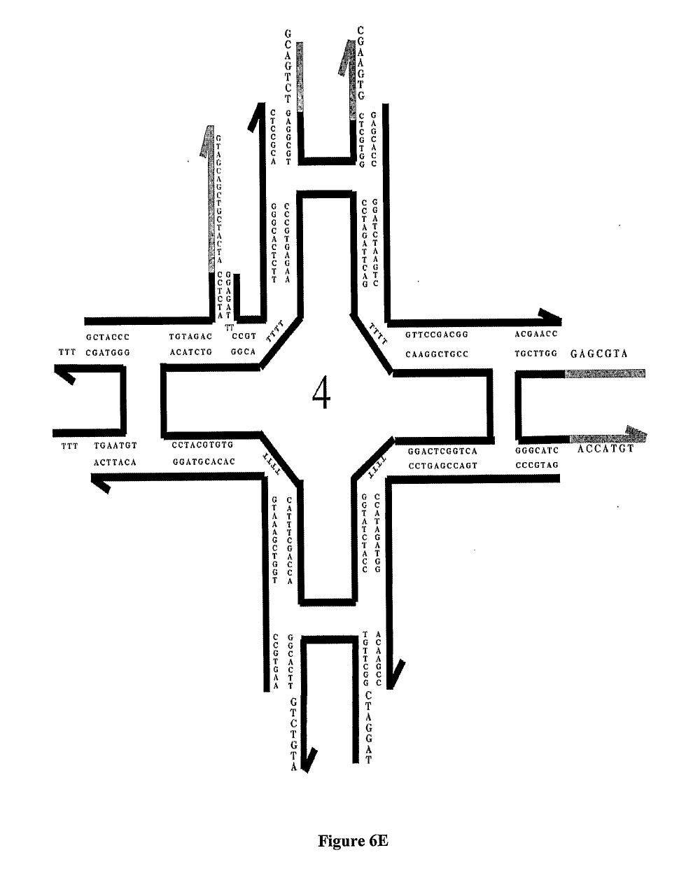

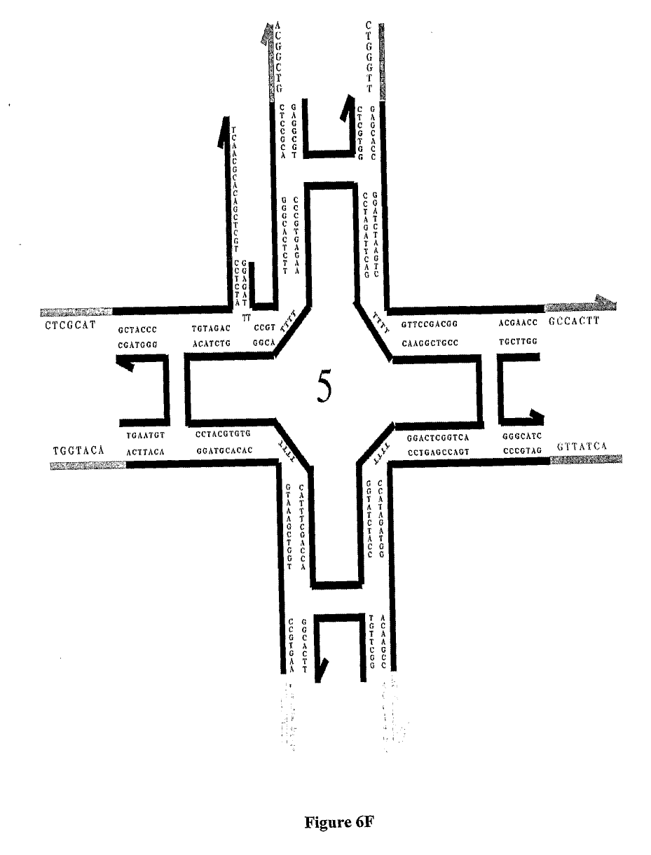

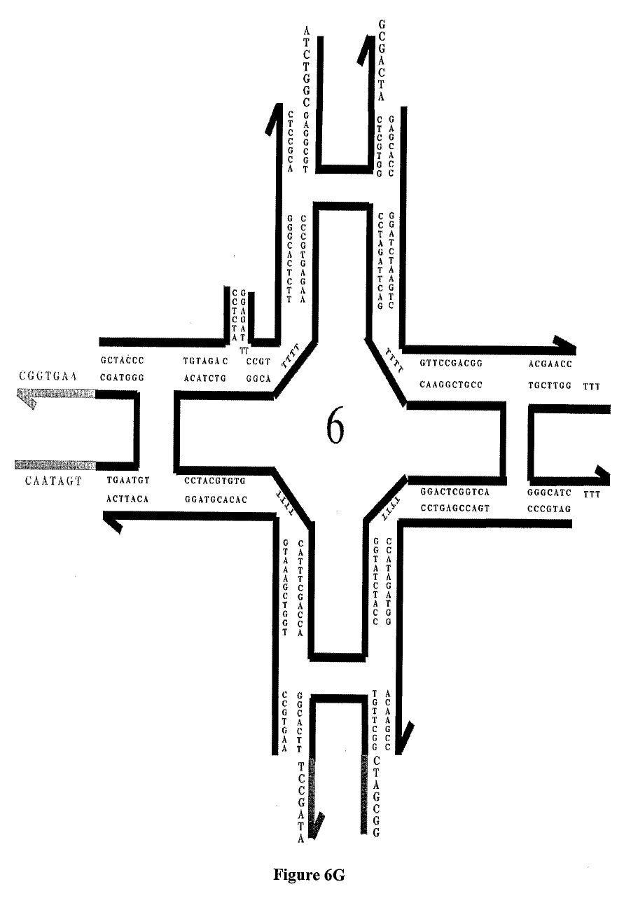

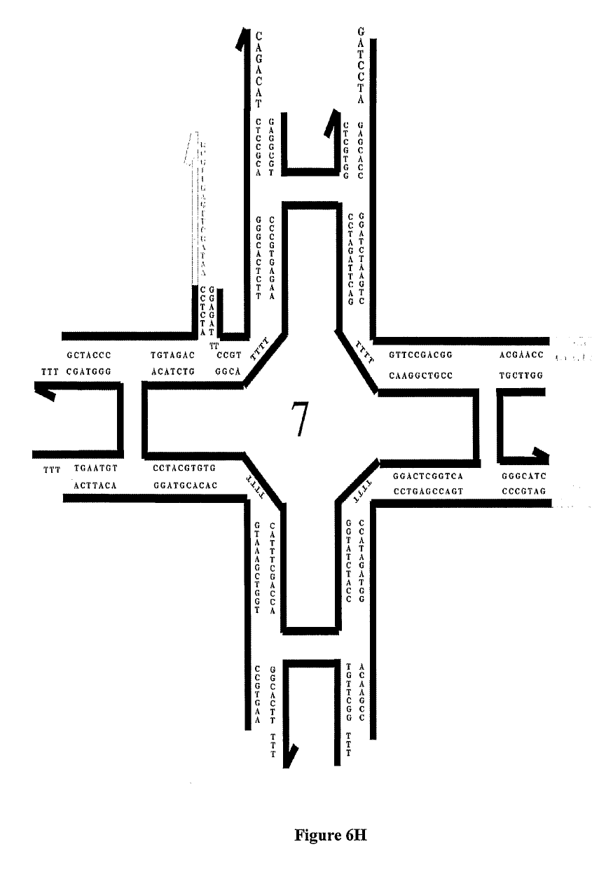

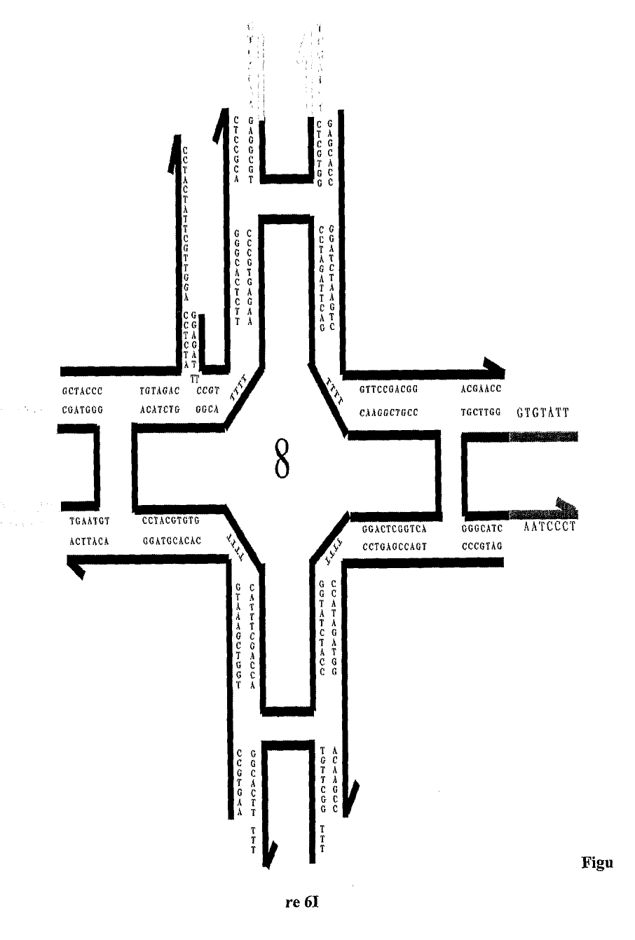

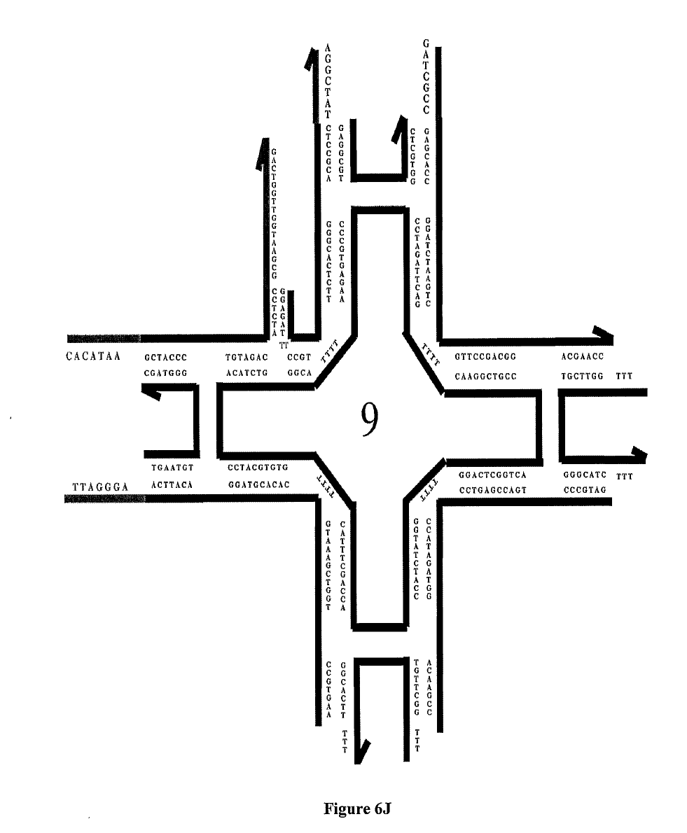

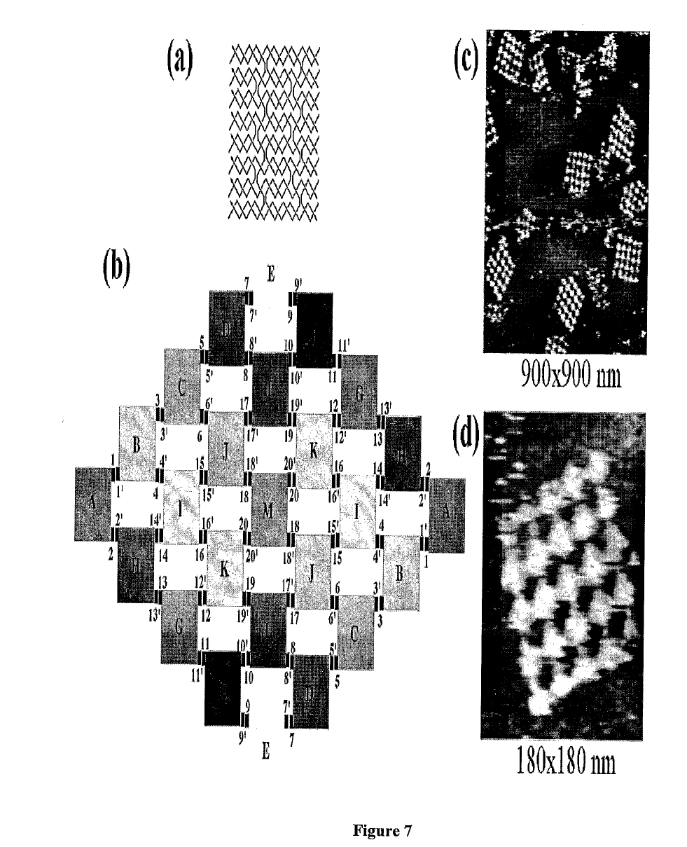

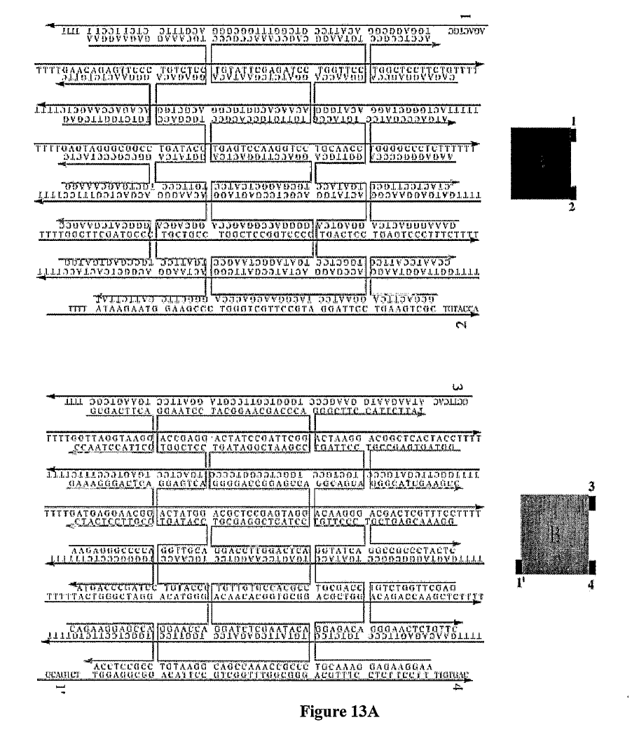

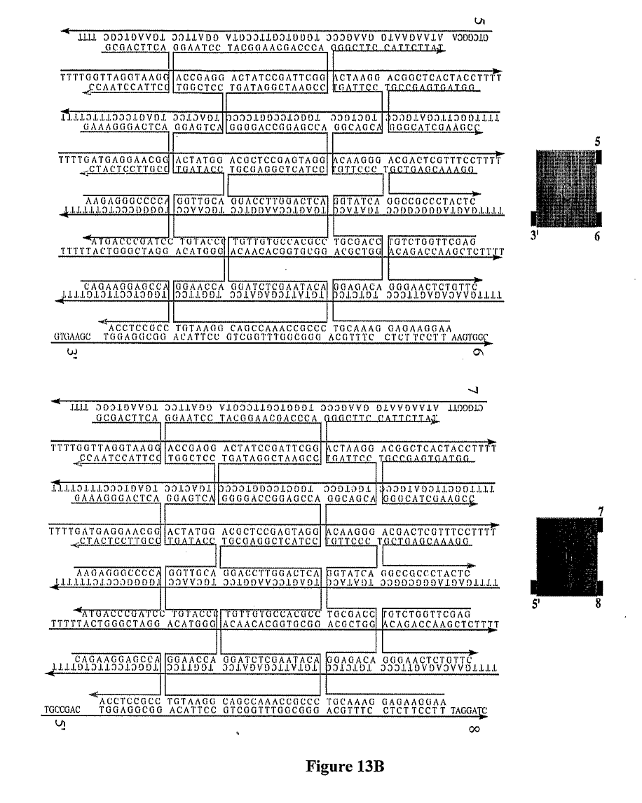

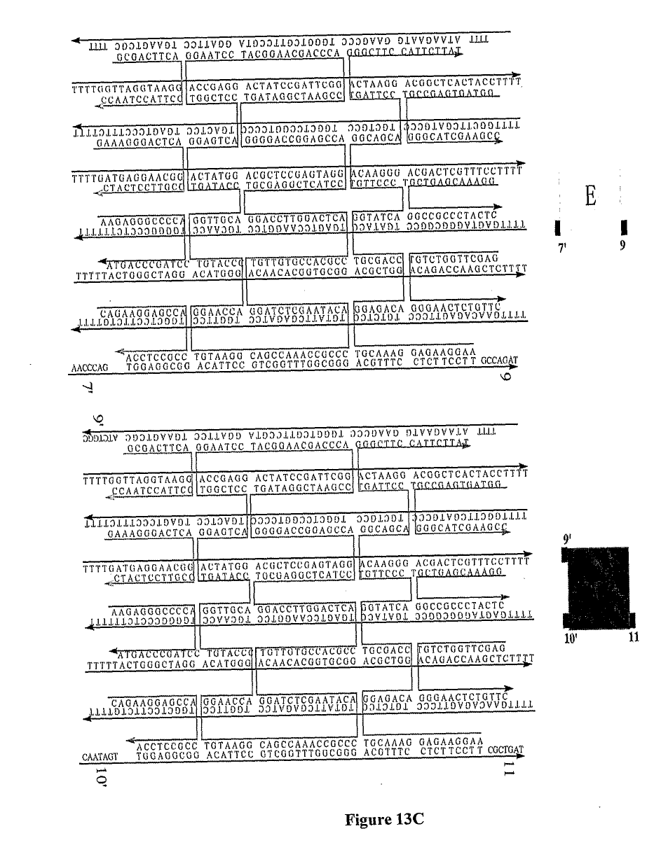

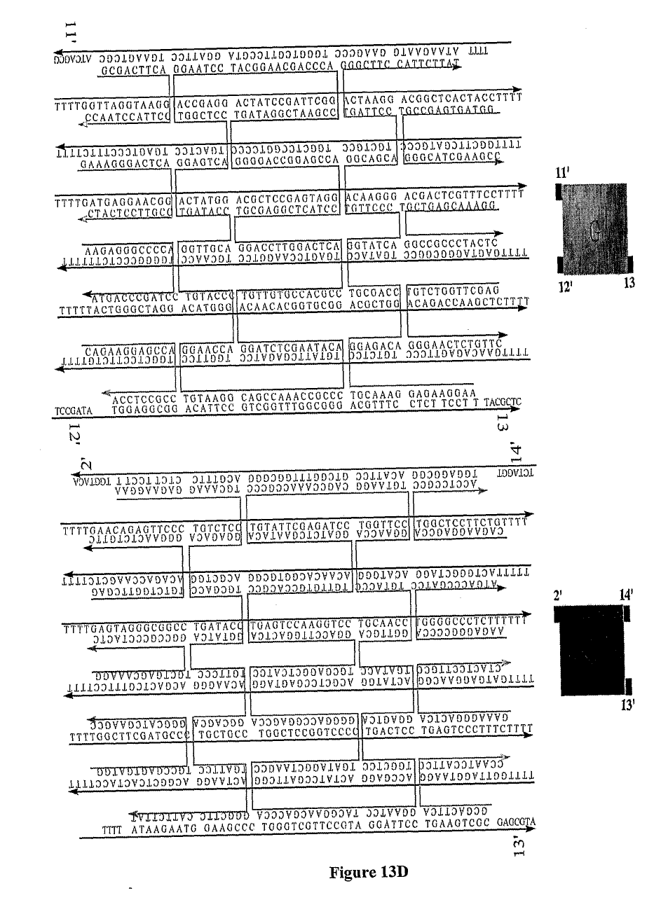

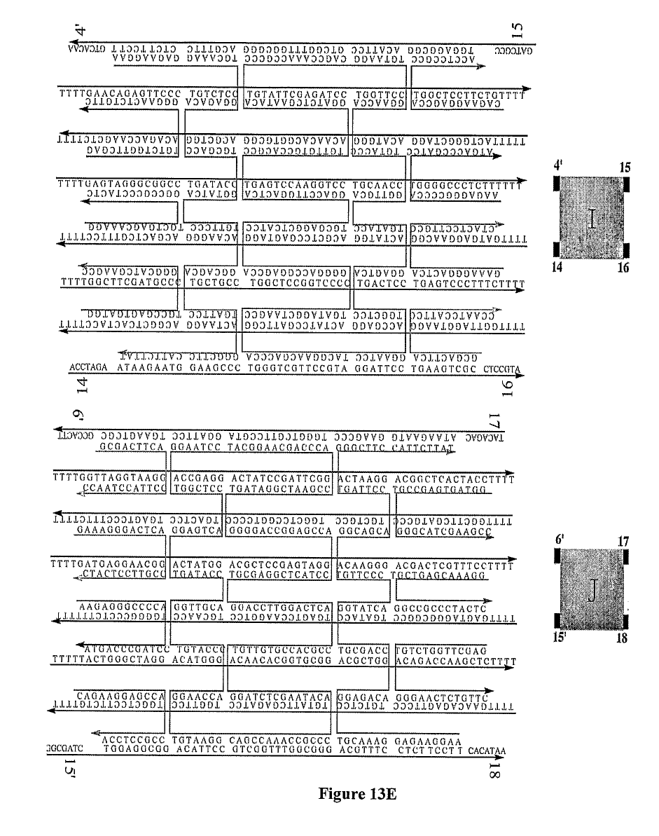

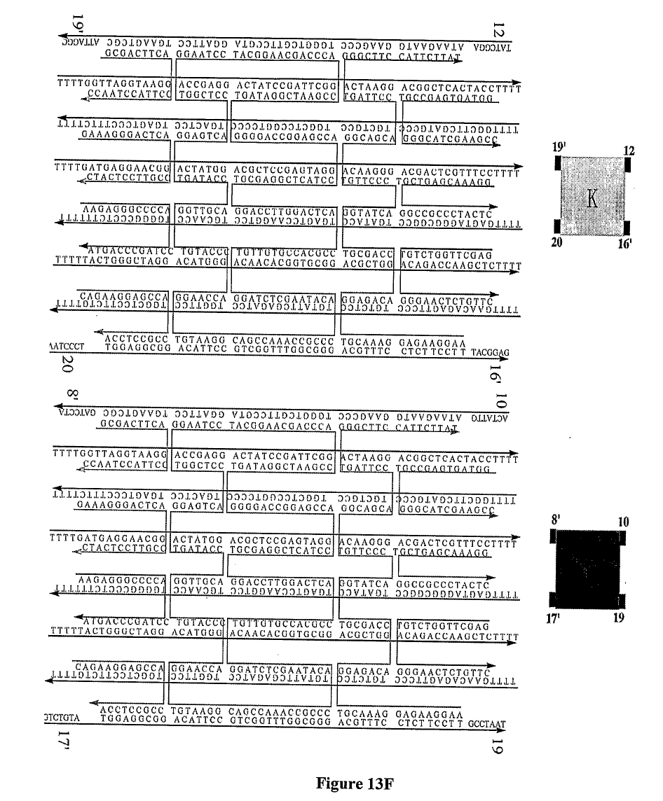

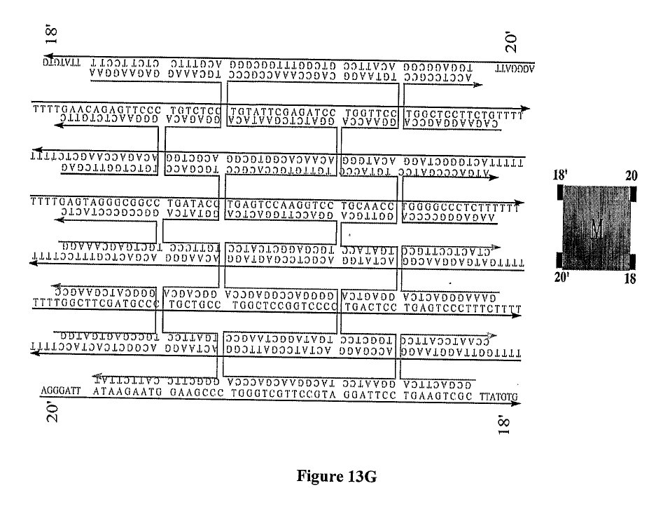

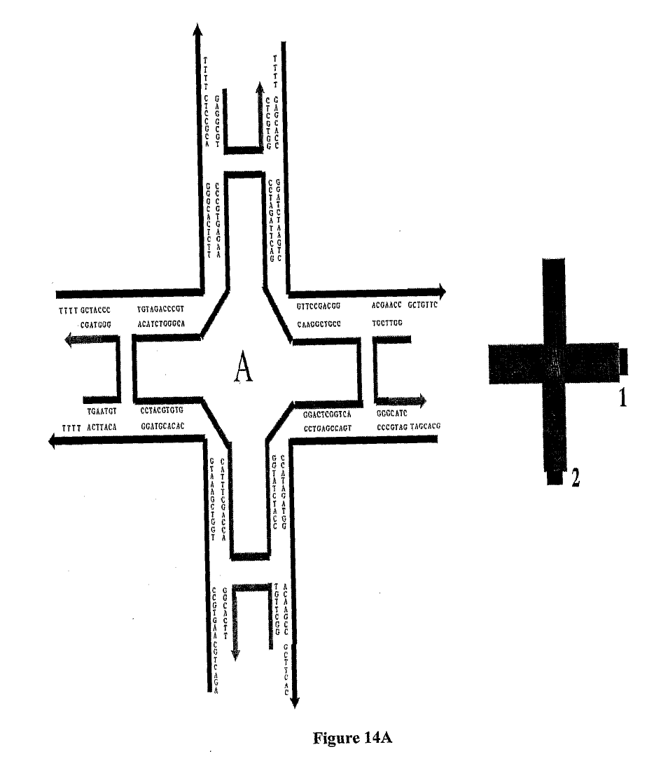

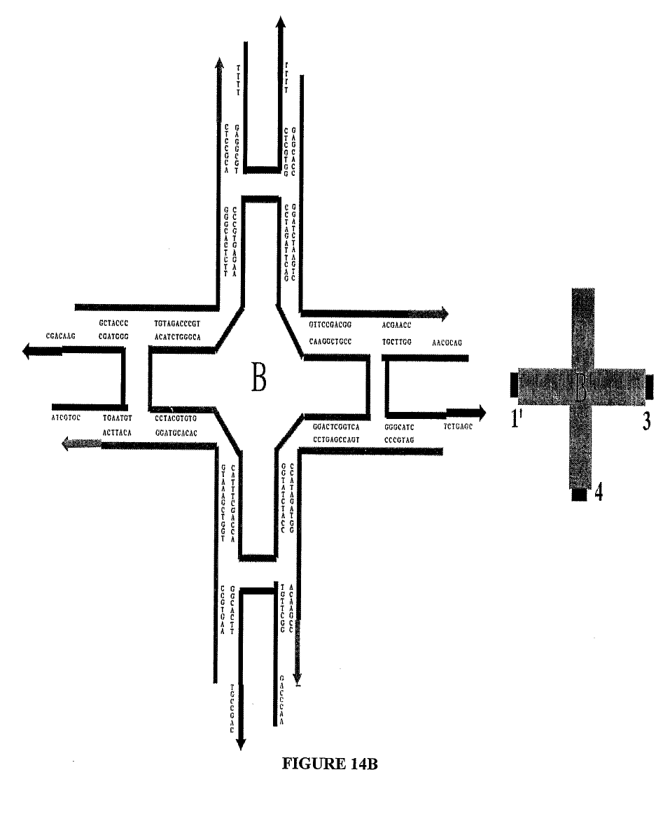

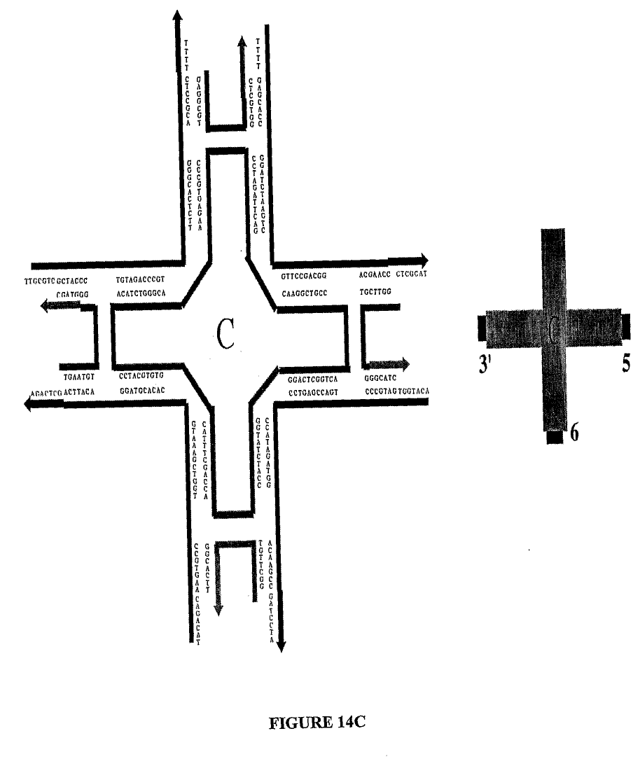

FIG. 1 shows in schematic form a 4-arm branch junction embodiment of a DNA tile that utilizes 9 polynucleotides: a single central polynucleotide (1) that base pairs with a series of 4 “helper” polynucleotides (3) to form the desired structure for the central polynucleotide. The DNA tile further contains 4 “linker” polynucleotides (2) that base pair with the helper polynucleotides. In this particular embodiment, either the helper polynucleotides or the linker polynucleotides do not base pair with each other over their entire length, but include sticky ends for specific base pairing with the complementary sticky ends on the DNA tile programmed to be adjacent to the tile at that position in the DNA tiling array. Further examples for 4-arm branch junction embodiments are shown in FIGS. 6A-6J and 14A-14G; examples for 8 helix bundle embodiments are shown in FIGS. 7 and 13A-13G. Appropriate sticky end design for other type of nucleic acid tiles will be apparent to those of skill in the art, based on the teachings herein.

The length of the sticky ends for each nucleic acid tile can vary, depending on the desired spacing between nucleic acid tiles, the number of nucleic acid tiles in the nucleic acid tiling array, the desired dimensions of the nucleic acid tiling array, and any other design parameters such as the desired distance between ligands attached to the array or between probes and ligands that might bind more than one probe cooperatively. The sticky ends do not have to be of identical length for a given nucleic acid tile or relative to other nucleic acid tiles in the nucleic acid tiling array, so long as a complementary sticky end of an identical length is present on the nucleic acid tile to which it is designed to base pair. Alternatively, the sticky ends on all of the nucleic acid tiles can be of identical length. Particularly preferred lengths of the sticky ends are 4, 5, 6, 7, 8, 9, or 10 nucleotides.

In one embodiment of this first aspect, each sticky end for a given nucleic acid tile is (a) different than the other sticky ends for that nucleic acid tile; (b) unique to that nucleic acid tile with respect to all other nucleic acid tiles in the array; and (c) complementary to a single sticky end of one other nucleic acid tile in the nucleic acid tiling array. As will be apparent to those of skill in the art, the polynucleotide structural element of each nucleic acid tile can be identical in this embodiment, so long as the sticky ends are unique. Thus, in this embodiment, a nucleic acid tiling array with “N” tiles is made by synthesizing “N” different tiles, each containing unique sticky-ends to connect to its neighboring tiles, so that each tile takes up a unique and well defined position in the array.

In a preferred embodiment of this first aspect of the invention, the nucleic acid tiles are not all unique (i.e.: some of the nucleic acid tiles may contain the same sticky ends). The nucleic acid tiling strategy in this embodiment takes advantage of the geometric symmetry of the nucleic acid tiling array. In general, to use a total of N tiles to construct a fixed size 2D nucleic acid tiling array with Cₘ symmetry, where m=2, 3, 4, or 6, the number of unique tiles the fixed size array requires is N/m, if N/m is an integral number, or Int (N/m)+1, if N/m is an non-integral number. This strategy is cost-effective in material, particularly when combined with embodiments where the polynucleotide structural element for each nucleic acid tile is identical. This embodiment minimizes polynucleotide design time and the sample preparation time dramatically. In these embodiments, the total number of unique sticky end pairs is preferably N*(N−1)/2. Examples of such array designs can be found in FIGS. 7-12, with exemplary tile sequences shown in FIGS. 13A-G and 14A-G.

In certain applications, a particular symmetry may prove valuable. For example, if the arrays are designed to hold metal particles for photonic arrays, one type of structure might be a ring array of metal spheres. In that case, a nucleic acid lattice of Cₙ (where n is equal to or greater than 6) would be valuable.

In a preferred embodiment of each of the above embodiments of the first aspect of the invention, each nucleic acid tile comprises an identical polynucleotide structural element, which limits the number of different polynucleotides that must be synthesized and assembled. In this embodiment, the nucleic acid tiles differ in their sticky ends, which program the predetermined position of each nucleic acid tile in the nucleic acid tiling array. As disclosed below, the nucleic acid tiles in this and all other embodiments may contain further components in addition to the polynucleotide structural element and the sticky ends, and these further compounds may differ between different nucleic acid tiles.

In a preferred embodiment of this first aspect, the resulting nucleic acid tiling array is “non-periodic,” meaning that the array does not include simple repetitive nucleic acid tile “patterns,” such as ABABAB; ABCDABCD; ABABDCDCABABDCDC. As disclosed above, this does not require that all of the tiles in the array be unique. The formation of non-periodic nucleic acid nanoarrays has been a major challenge in nanotechnology and this embodiment of the invention provides numerous potential applications for nanofabrication of complex structures and useful devices.

The dimensions of a given nucleic acid tile can be programmed, based on the length of the core polynucleotides and their programmed shape and size, the length of the sticky ends, and other design elements. Based on the teachings herein, those of skill in the art can prepare nucleic acid tiles of any desired size. In a preferred embodiment the length and width of individual nucleic acid tiles are between 3 nm and 50 nm, more preferably between 6 nm and 30 nm, and even more preferably between 7 nm and 20 nm.

The dimensions of the resulting nucleic acid tiling array can also be programmed, depending on the size of the individual nucleic acid tiles, the number of nucleic acid tiles, the length of the sticky ends, the desired spacing between individual nucleic acid tiles, and other design elements. Based on the teachings herein, those of skill in the art can prepare nucleic acid tiling arrays of any desired size, including arrays of at least 1-10 μm in length.

Synthesis of polynucleotides is well known in the art. It is highly desirable, but not essential, in making the polynucleotides for the nucleic acid tiles to appropriately design sequences to minimize undesired base pairing and undesired secondary structure formation. Computer programs for such purposes are well known in the art. (See, for example, Seeman, N. C., J Biomol Struct Dyn, 1990. 8: p. 573-81). It is further preferred that the polynucleotides are purified prior to nucleic acid tile assembly. Purification can be by any appropriate means, such as by gel electrophoretic techniques.

The nucleic acid tiling arrays of the invention can be made and stored as described herein. In various embodiments, the nucleic acid tiling array may be present in solution, in lyophilized form, or attached to a substrate. Non-limiting examples of substrates to which the nucleic acid tiling arrays can be attached include silicon, quartz, other piezoelectric materials such as langasite (La₃Ga₅SiO₁₄), nitrocellulose, nylon, glass, diazotized membranes (paper or nylon), polyformaldehyde, cellulose, cellulose acetate, paper, ceramics, metals, metalloids, semiconductive materials, coated beads, magnetic particles; plastics such as polyethylene, polypropylene, and polystyrene; and gel-forming materials, such as proteins (e.g., gelatins), lipopolysaccharides, silicates, agarose and polyacrylamides.

The nucleic acid tiling arrays of the invention can be attached to such surfaces using any means in the art. For example, one simple way to do this is with multiply charged cations (Mg, Ni, Cu etc.) that spontaneously attach to a negative surface like glass or mica, leaving extra charge to attach the nucleic acid. Another way to do this is with singly charged cations that are tethered to the surface chemically. An example would be aminopropyltriethoxysilane reacted with a surface containing hydroxyl groups. This attached to oxide surfaces by hydrolysis of the silanes, and leaves a positively charged amino group on the surface at neutral pH.

In a further preferred embodiment of this first aspect of the invention, a plurality of the nucleic acid tiles further comprise a nucleic acid probe. As used herein, the term “nucleic acid probe” refers to a nucleic acid sequence synthesized as part of one or more core polynucleotide structure in the nucleic acid tile that does not participate in base pairing with other core polynucleotide structures or adjacent nucleic acid tiles. Thus, the nucleic acid probe is available for interactions with various “targets” to which it binds directly or indirectly. Such targets include, but are not limited to, nucleic acids (RNA or DNA), polypeptides, lipids, carbohydrates, other organic molecules, inorganic molecules, metallic particles, magnets, quantum dots, and combinations thereof. In a preferred embodiment, the nucleic acid probe is a DNA probe.

This embodiment provides a self-assembling, finite nucleic acid-based nanoarray that allows a wide variety of discrete molecules to be placed at precise locations on the nucleic acid tiling array with nm-scale accuracy, and thus has widespread use in, for example, the fields of nanoelectronics, nanomechanical devices, biosensors, programmable/autonomous molecular machines, and molecular computing systems. Thus, in a further embodiment, the nucleic acid tiling arrays further comprise a plurality of targets bound to nucleic acid probes specific for those targets.

As will be apparent to those of skill in the art, in this embodiment, not all of the nucleic acid tiles in the nucleic acid tiling array are required to possess a nucleic acid probe. Thus, one or more of the nucleic acid tiles in the nucleic acid tiling array comprises a nucleic acid probe; more preferably a majority of the nucleic acid tiles in the array comprise a nucleic acid probe; more preferably all of the nucleic acid tiles comprise a nucleic acid probe with the optional exception of a small percentage of the nucleic acid tiles to serve as control tiles.

As will also be apparent to those of skill in the art, based on the teachings herein, the nucleic acid probe-containing tiles in an array may all contain the same nucleic acid probe; may all contain different nucleic acid probes, or a mixture thereof. Thus, the targets for binding to the nucleic acid probes can be the same for all nucleic acid tiles in a given nucleic acid tiling array, all different, or mixtures thereof.

In a preferred embodiment, each of the nucleic acid probe-containing nucleic acid tiles comprises more than one nucleic acid probe.

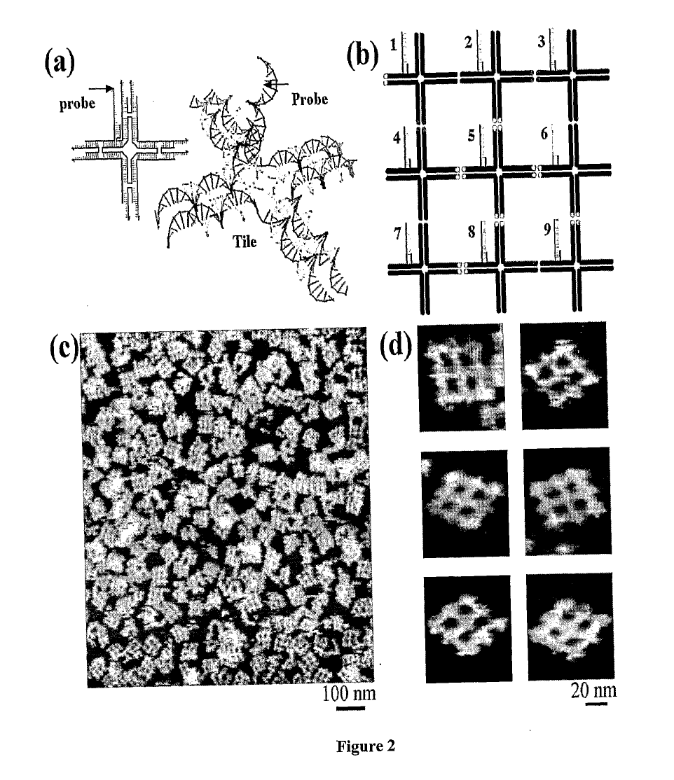

FIGS. 2-3, 5, 6B-6J, and 15 provide specific examples of DNA probe-containing DNA tiles. FIG. 6B-6J show polynucleotides modified to include a DNA probe: a 6 base pair dsDNA region with a single stranded overhang of 16 nucleotides. With this positioning of the overhanging sequence, the DNA probe has its 5′ end remote from the surface and extends perpendicular to the plane of the tile. By designing a unique DNA probe for each DNA tile on one of the external strands, a DNA tiling array is created with each DNA tile comprising a unique DNA probe. FIG. 6 shows how four DNA tiles of the type illustrated in FIG. 5 can be ligated to form a tile. FIG. 7 shows how an array of 16 DNA tiles can be assembled from tiles of the form shown in FIG. 6.

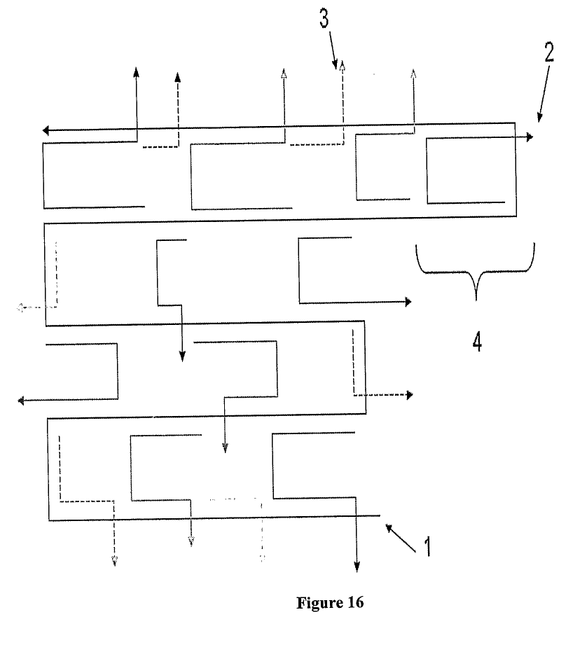

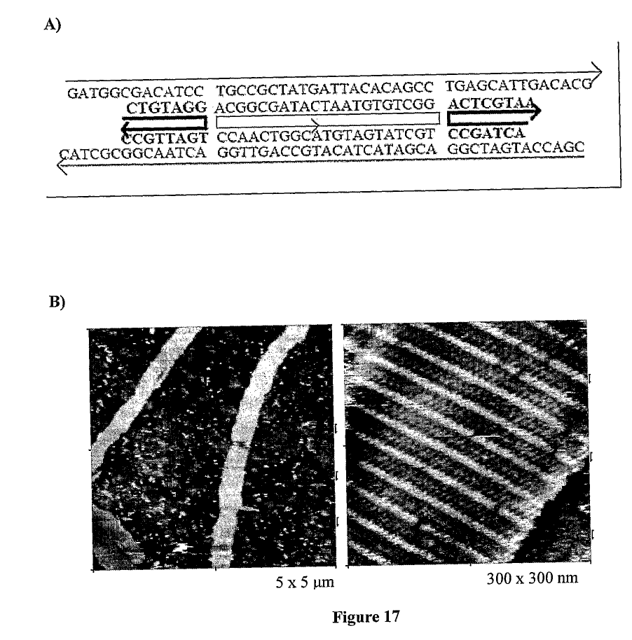

FIG. 17 provides an exemplary LNA/DNA double crossover tile. The LNA/DNA tile contains two double helices in the anti-parallel orientation with an odd number of bases between the double crossover. Three crossover strands hold the structure together: two LNA oligonucleotides of 15 bases on either end; and one DNA oligonucleotide of 42 bases in the middle. The tile contains a total of 168 bases of DNA or LNA, with six bases of sticky ends to join together with another tile to form a 2D array. When DNA is base paired with LNA the base pairs per turn is roughly 12.7, as compared to 10.5 base pairs per turn for DNA/DNA pairing. FIG. 17(A) shows the LNA/DNA tile with the two LNA oligonucleotides in bold face print. The arrows point to the 3′ end of either DNA or LNA strand. FIG. 17(b) shows atomic force microscopy images of the 2D LNA/DNA tile.

The particular nucleic acid probe sequences, length, or structure shown in these figures are not critical to the invention; the only requirement is that the nucleic acid probe be able to bind, directly or indirectly, one or more targets of interest. The nucleic acid probe may be single stranded, single stranded but subject to internal base pairing, or double stranded, and the nucleic acid probe may be of any length that is appropriate for the design of the nucleic acid tile of which the nucleic acid probe is a part, but constrained in length so that neighboring probes (either within a tile or between different tiles) do not interfere with target binding by the nucleic acid probe.

As used herein, “direct binding” means that the target binds directly to the nucleic acid probe. Such binding can be of any type, including base pairing with nucleic acids, or other interactions. Preferred targets for direct interaction include nucleic acids (DNA and RNA whether single stranded or double stranded; DNAzymes, aptameric sensors, signaling aptamers), polypeptides, lipids, carbohydrates, other organic molecules, inorganic molecules (including but not limited to insulators, conductors, semi-conductors, magnetic particles, metallic particles, optical sensors, etc.), magnets, quantum dots, and any other type of molecule to which a nucleic acid probe (such as an aptamer) is capable of binding.

As used herein, “indirect binding” means that the target binds to the nucleic acid probe through some intermediate molecule. One non-limiting example of indirect binding involves mRNA display, in which the mRNA portion of a genetically tagged polypeptide base pairs with the nucleic acid probe, resulting the polypeptide being presented at a precise location on the nucleic acid tile containing the complementary nucleic acid probe. Messenger RNA display involves production of mRNA-protein fusion molecules in vitro using the natural peptidyl transferase activity of the ribosome. In this reaction, messenger RNA is chemically modified to contain a puromycin residue at its 3′-end. During translation, the ribosome stalls upon reaching the DNA-puromycin linker, thereby enabling puromycin to enter the A-site and become covalently bound to the C-terminus of the nascent polypeptide chain in the adjoining P-site, thereby linking genotype and phenotype together in a single molecule. Other non-limiting examples would include chemical conjugation approaches that facilitate the formation of certain DNA-peptides, DNA-PNA, and PNA-Peptides, chimeric molecules, as well as other molecular biology approaches like ribosome display and DNA display.

A further non-limiting example of indirect binding to the nucleic acid probe involves preparing a mRNA-polypeptide fusion molecule comprising a ZnS binding polypeptide, such as A7 CNNPMHQNC (SEQ ID NO:389) or Z8 LRRSSEAHNSIV (SEQ ID NO:390), wherein the mRNA portion of the fusion molecule is complementary to the nucleic acid probe on one or more nucleic acid tiles. Thus, the ZnS polypeptides are indirectly bound to the nucleic acid probe. Furthermore, the nucleic acid tile can then be incubated with Na₂S and ZnCl₂, the chemical precursors to ZnS nanocrystals; following self-assembly, the resulting nucleic acid tile array comprises precisely position ZnS nanocrystals.

Those of skill in the art will recognize, based on the teachings herein, that any other molecules can be indirectly bound to the nucleic acid probe of the invention, including but not limited to nucleic acids (DNA and RNA whether single stranded or double stranded), lipids, carbohydrates, other organic molecules, inorganic molecules and metallic particles, magnets, and quantum dots.

Conditions for binding the target to the nucleic acid probe will depend on the nature of the DNA probe and the target, but can be determined by those of skill in the art, based on the teachings herein.

Thus, the invention provides nucleic acid tiles that self-assemble into finite arrays of known morphology with one or more tiles displaying a nucleic acid probe that can directly or indirectly bind a target of interest. Because the position of each tile in the array is unambiguously defined, the present invention provides designer, high-density nanometer scale molecule arrays, where the molecules are present at precise, well-defined locations. Therefore, in various embodiments, the present invention further provides molecule arrays, comprising a nucleic acid tiling array of the invention, wherein a plurality of nucleic acid tiles in the nucleic acid tiling array comprise one or more nucleic acid probes, and wherein the one or more nucleic acid probes in the plurality of nucleic acid tiles is bound to a target, wherein the target is selected from the group consisting of nucleic acids (DNA and RNA whether single stranded or double stranded; DNAzyme, aptameric sensors, signaling aptamers), polypeptides, lipids, carbohydrates, other organic molecules, inorganic molecules (including but not limited to insulators, conductors, semi-conductors, magnetic particles, metallic particles, optical sensors, etc.), magnets, quantum dots, and any other type of molecule to which a nucleic acid probe (such as an aptamer) is capable of binding

Depending upon the design of the individual tiles in the array, the size of the nucleic acid probe, the specific target, and other design feature, the density of target molecules on the nucleic acid tiling array can be as high as 2.5×10⁸ targets/cm².

In a second aspect, the present invention provides methods for making the nucleic acid tiling arrays of the first aspect of the invention, comprising

(a) forming nucleic acid tiles, comprising combining a stoichiometric amount of each polynucleotide in the nucleic acid tile under conditions suitable for specific hybridization of the polynucleotides to form the nucleic acid tile;

(b) combining the nucleic acid tiles, wherein a sticky end for a given nucleic acid tile is complementary to a single sticky end of another nucleic acid tile in the nucleic acid tiling array, and wherein each sticky end of a single nucleic acid tile specifically base pairs with a single sticky end on another nucleic acid tile, wherein the combining occurs under conditions suitable to promote specific hybridization of the sticky ends between different nucleic acid tiles; and

(c) wherein the specific hybridization of the sticky ends between different nucleic acid tiles results in formation of a finite nucleic acid tiling array.

In one embodiment, step (b) comprises combining all of the nucleic acid tiles together simultaneously, wherein assembly of the nucleic acid tiling array occurs in a single step after nucleic acid tile production. In an alternative embodiment, step (b) comprises sequentially combining the nucleic acid tiles in a multi-step assembly process, either by adding a single nucleic acid tile at a time to the combination, or adding multiple nucleic acid tiles at a time to the combination. This alternative embodiment may be preferable for making versions of the nucleic acid tiling array containing 9 or more nucleic acid tiles, to minimize partially hybridized product.

The particular hybridization buffers and other conditions employed can vary depending on the polynucleotide lengths and sequences, and are well within the level of skill in the art based on the teachings herein. Being made of nucleic acid, the arrays carry a considerable negative charge at low salt, and therefore hybridization in the presence of a significant amount of salt (e.g., 10 mM MgCl₂ or 600 mM or greater monovalent salt like NaCl) is preferred. Other typical annealing conditions include 1 M NaCl, 10 mM NaHPO₄ (pH7). Aptamers (when included as nucleic acid probes) typically require 10 mM MgCl₂ to fold properly. General parameters for hybridization conditions for nucleic acids are described in Sambrook et al., supra, and in Ausubel et al., 1987, Current Protocols in Molecular Biology, Greene Publishing and Wiley-Interscience, New York.

In a preferred embodiment of step (a), the stoichiometric amount of each polynucleotide in a nucleic acid tile is combined under denaturing conditions, such as between 90° C. and 99° C., followed by cooling to between 25° C. and 50° C. in appropriate hybridization buffer, as can be determined by those of skill in the art. In a preferred embodiment, annealing protocols involve a high temperature and low salt denaturing step, followed by a low temperature high salt annealing step. In this embodiment, the high salt concentrations are not added to the reaction until the polynucleotides are removed from the heat and placed on ice.

The polynucleotide concentration used can vary, and those of skill in the art, based on the teachings herein, can determine appropriate concentrations. In one embodiment, polynucleotide concentration in step (a) is between 1 nm and 10 μM.

In step (b) of nucleic acid tiling array assembly, the plurality of nucleic acid tiles are combined under conditions suitable to promote specific hybridization of the sticky ends between different nucleic acid tiles. In a preferred embodiment, such suitable conditions include incubation in appropriate hybridization solution at a beginning temperature of between 25° C. and 45° C., followed by cooling in the same hybridization buffer to between 5° C. and 25° C. over 1 hour to 24 hours. The specific condition chosen need to balance the needs between avoiding disassembly of the tiles, which generally have melting temperatures in the range of 50-65° C., and to eliminate the possible mismatches among the different sticky ends of the tiles. In a preferred embodiment, the buffer condition used comprises 40 mM Tris, 20 mM acetic acid, 2 mM EDTA, and 12.5 mM magnesium acetate, pH 8.0.

In a preferred embodiment, synthesis of the nucleic acid tiling arrays of the invention comprises separating free nucleic acid tiles and/or incompletely hybridized nucleic acid tiles from completely formed nucleic acid tiling arrays. Any appropriate separation method can be used, including but not limited to size exclusion chromatography, sucrose gradient centrifugation, and affinity based separation techniques. In a preferred embodiment, the nucleic acid tiling arrays are chemically modified so as to permit affinity-based separation techniques. Any chemical modification that permits such affinity-based separation techniques can be used, including but not limited to, chemically modifying the nucleic acid tiling array to contain one or more biotin residues, which can then be used for streptavidin-based affinity separation of the nucleic acid tiles.

Correct formation of the nucleic acid tiling arrays can be monitored by any appropriate technique, including but not limited to atomic force microscopy, sucrose gradient centrifugation, and agarose gel electrophoresis.

The nucleic acid tiling arrays can be used for a wide variety of purposes. In a third aspect, the present invention provides methods for detecting a ligand of interest, comprising:

(a) contacting a nucleic acid tiling array of the invention with a test sample thought to contain a ligand for which a probe is attached to the nucleic acid tiling array, under conditions to promote binding between the probe and the ligand; and

(b) detecting presence of the ligand bound to the probe on the nucleic acid tiling array.

In this aspect, the present invention provides an exquisitely sensitive biosensor, capable of single molecule detection. Using certain embodiments of the nucleic acid tiling array disclosed above, the methods can be used to conduct high throughput detection methods requiring very little test sample.

For example, a probe comprising the sequence CGAAGGAGACGACCA (SEQ ID NO. 384) will hybridize with its complementary strand with a binding free energy, ΔG (10 mM Mg, 25° C.) of −21 kcal/mole (http://ozone2.chem.wayne.edu/). This corresponds to a femto-molar dissociation constant. Thus, 10⁻¹⁴ moles of the target DNA (10-fold excess) should be adequate to saturate the probes on the nucleic acid array. A sample volume of 1 μl is easily handled (in contrast to the volume limitations imposed by macroscopic arrays). One μl of a 10⁻¹⁴ M solution contains 10⁻²⁰ moles or 6000 molecules. Thus, these arrays present a method for detecting nucleic acid at the level of a few thousand molecules. Microfluidic methods for concentrating DNA and handing much smaller volumes (down to 10 nl), well known to those skilled in the art, should permit detection of just a few hundred or even tens of target molecules.

In one embodiment the probe is the nucleic acid probe on the nucleic acid tile, as disclosed above, and the detection comprises detecting direct binding to the nucleic acid probe. The arrays can be hybridized in solution, removing the problems of conventional arrays where surface charges and chemistry can inhibit hybridization. In another embodiment, the method comprises detecting indirect binding to the nucleic acid probe, where another molecule is bound to the nucleic acid probe, as disclosed above. In this latter embodiment, the probe can comprise nucleic acids, polypeptides, lipids, polysaccharides, organic molecules, inorganic molecules, metallic particles, magnets, quantum dots, and antibodies.

Exemplary ligands include, but are not limited to, nucleic acids (DNA or RNA), polypeptides, lipids, carbohydrates, organic compounds, and inorganic compounds.

Exemplary test samples include, but are not limited to, clinical samples (bodily fluids such as blood, serum, urine, saliva, semen, and breath) air, compound libraries, cell extracts, tissue extracts, environmental samples, and isolated ligands.

The contacting can be carried out under any conditions suitable for binding of the probe to the ligand. The contacting can occur in solution, or can occur while the nucleic acid tiling array is attached to a solid surface, as described herein. Determination of appropriate conditions will depend on the type of probe, the ligand, and the test sample, and is well within the level of skill in the art.

In a preferred embodiment of this third aspect, the method further comprises removing unbound test sample from the nucleic acid tiling array prior to detection. Such removing can be done by any appropriate means in the art, such as by including a wash step in which the array is contacted with a buffer that will not interfere with probe-ligand binding, but will remove unbound materials. Determination of appropriate conditions for removing unbound test sample will depend on the type of probe, the ligand, and the test sample, and is well within the level of skill in the art.

Detection can be carried out by any appropriate method in the art, including but not limited to atomic force microscopy, the use of detectably labeled probe components or test samples followed by an appropriate detection scheme (ie, fluorescence detection, radioactive detection, etc.). Electrochemical means could also be used to detect binding at certain sites on the array though an altered voltammometric response when the array is placed on an electrode. In a preferred embodiment, detection is carried out by atomic force microscopy (“AFM”), with or without labeling of probe components or test samples. While AFM does not require labeling for detection, such labeling allows the possibility of both more precise determination of the sites of binding and also the possibility that different chemical species that bound could be independently identified. This would be useful, when, for example, seeking to identify proteins that bound to an array consisting of a library of DNA aptamers. For example, DNA containing a biotin label my be incorporated by hybridization, and detected by exposing the (now biotinylated) array to streptavidin. In another embodiment, DNA incorporating multiple different reagents may allow for imaging by means of recognition elements attached to the AFM probe (Stroh et al., Proc. Natl. Acad. Sci. (USA)., 101:12503-12507 (2004))

In one embodiment of this third aspect, the method is used to detect hybridization between the probe and the target. Such methods can be used, for example, in detecting specific DNA or RNA sequences (cDNAs; genomics DNAs, single nucleotide polymorphisms (“SNP”), mRNA expression), interaction distances between ligands selected to bind a protein, and DNA sequence analysis. Hybridization can be carried out with the array suspended in solution or attached to a solid surface.

In one non-limiting example of gene expression analysis, mRNA is converted to cDNA with reverse transcriptase, then hybridized with a solution of the nucleic acid tiling arrays. The final concentration of DNA can be between 0.1 and 1.0 μM in a buffer containing 20 mM Tris (pH 7.6), 2 mM EDTA, 12.5 mM MgCl₂ and the final volume can be as small as 10 μL. For AFM imaging, 5 μL sample are spotted on freshly cleaved mica (Ted Pella, Inc.) and left to adsorb to the surface for 3 min. Then, 30 μL of 1×TAE/Mg buffer is placed onto the mica. As an illustration, a 30 ul solution with 1 uM concentration will contain 30 μmol of DNA. If we have 400 bases for each tile, this corresponds to about 3600 nanogram total DNA in the tube, and 3×10¹² tiles.

In a non-limiting example of SNP analysis, allele-specific DNA probes with discriminating bases at 5′ end are incorporated into the nucleic acid tiles. The target DNA (PCR amplicons) is hybridized with the nucleic acid tiles. Once hybridization is achieved, the hybridized duplexes are labeled. A combinatorial library containing all possible 5 base sequences of a 5-base polynucleotide in length (for example), labeled at the 5′ end, is flowed into the solution containing the nucleic acid tiling arrays in the hybridizing solution. In the presence of T4 ligase, these short, labeled polynucleotides are ligated onto sites containing duplex and an overhang (that is all sites of hybridization). In this way, the label is covalently attached to the nucleic acid tiling array, and remains in place in subsequent processing steps. The label can be dioxigenin (dig), biotin, fluorescein or dinitrophenyl, small chemicals that are easily attached to the 5′ end of DNA following synthesis of the nucleic acid tiling array. Antibodies are available for each of these chemicals, and each is easily attached to an AFM tip.

The solution containing the labeled nucleic acid tiling arrays is then deposited onto a flat surface for AFM scanning. A mica surface treated with Mg will hold the nucleic acid tiling arrays in place while they are scanned in solution as described by Yan et al. (Science, 2003.301: p. 1882-1884). An AFM tip functionalized with an antibody to the label (as described by Stroh et al., Proc. Natl. Acad. Sci. (USA), 2004. 101: p. 12503-12507) is then used to form simultaneous topographical and recognition images. A preferred label/antibody combination is diG/andti-diG. AFM analysis results in a topographical image that serves as an index with which the array can be addressed. Thus, assuming one corner is uniquely indexed (see, for example, FIG. 3), the site, and thus sequence of the probe at each recognition spot is identified.

It is also possible that the sites of hybridization can be identified simply from an AFM image, by detection of the increased stiffness of duplex nucleic acid compared to single stranded nucleic acid.

In another embodiment, pairs of peptides can be bound to adjacent tiles to assess cooperative effects in ligand binding.

In a fourth aspect, the present invention provides nucleic acid tiling arrays, comprising:

(a) one or more nucleic acid tiles, wherein each nucleic acid tile in the nucleic acid tiling array comprises a plurality of nucleic acid probes capable of binding to a target, wherein the nucleic acid probes are attached at predetermined locations on the nucleic acid tile; and

(b) an indexing feature;

wherein the nucleic acid tiling array is of a predetermined size.

The definition and preferred embodiments for nucleic acids, the nucleic acid tiles, nucleic acid probes, nucleic acid tiling arrays, target, and the indexing feature of this fourth aspect of the invention (and the embodiments which follow), as well as the methods for making and using them, are as described above for the first, second, and third aspects of the invention.

In a most preferred embodiment of this fourth aspect of the invention (“Nucleic acid thread strand-based tile”), the nucleic acid tiling comprises:

(a) a nucleic acid thread strand;

(b) a plurality of helper nucleic acid strands that are complementary to parts of the nucleic acid thread strand; wherein a plurality of the helper nucleic acid strands further comprises a nucleic acid probe; and wherein the nucleic acid thread strand is folded into a desired shape by hybridization to the helper strands;

wherein the nucleic acid thread strand is not complementary to any of the nucleic acid probes, and wherein the predetermined size of the array is determined by the length and shape of the nucleic acid thread strand as folded by helper strands.

In a preferred embodiment, the nucleic acid thread strand, the nucleic acid helper strands, and the nucleic acid probe comprise or consist of DNA.

As used herein, “the nucleic acid thread strand is not complementary to any of the nucleic acid probes” means that the nucleic acid probes do not base pair with the thread strand over the length of the nucleic acid probe under the conditions used, and thus the helper strands are available for interactions with a target.

In this embodiment, no sticky ends are required for self-assembly.

This embodiment provides a self-assembling, finite nucleic acid thread strand tile that allows a wide variety of discrete molecules to be placed at precise locations on the nucleic acid thread strand tile with nm-scale accuracy, and thus has widespread use in, for example, the fields of nanoelectronics, nanomechanical devices, biosensors, programmable/autonomous molecular machines, and molecular computing systems. Thus, in a further embodiment, the nucleic acid thread strand tile further comprise a plurality of targets bound to nucleic acid probes specific for those targets.

The nucleic acid thread strand can be any suitable polynucleotide of appropriate length and sequence for the desired nucleic acid tile. In one embodiment, the nucleic acid thread strand is a genomic nucleic acid strand, or suitable fragments thereof, such as from a virus, bacterium, or indeed any organism from which long DNA can be extracted. The only caveat is that the chosen section of genomic nucleic acid should not have sequences that are complementary to the probe sequences, and they should not contain significant amounts of repeated sequences or other sequences that might form structures that interfere with assembly of the array (such the G-rich regions that might form quadruplexes as in telomere DNA).

In a preferred embodiment, genomic nucleic acid, or fragments thereof, is used as the nucleic acid thread for lengths above about 50 bp where synthetic nucleic acid becomes expensive and difficult to make. Lengths up to the full length of an organism's genome (ca. 10⁹ bp) are feasible if they met the sequence criteria described above.

The nucleic acid helper strands are complementary to regions of the nucleic acid thread and not to each other, and are designed to hybridize to the nucleic acid thread strand so as to constrain the nucleic acid thread strand into a desired shape. A plurality of the nucleic acid helper strands comprise nucleic acid probes. As used in this embodiment, the definition and preferred embodiments of “nucleic acid probes” are as defined above for the other aspects of the invention. In one embodiment, helper strands are between 10 and 50 nucleotides, not including any DNA probe that is part of the helper strand.

Based on the teachings herein, those of skill in the art can produce DNA thread-based tiles of any desired size and shape.

In a further embodiment, the nucleic acid thread-based tile further comprises nucleic acid filler strands that hybridize to the nucleic acid thread strand. These strands are not involved in shaping the nucleic acid thread strand, but add further structural integrity to the resulting nucleic acid tile. It is further preferred that a plurality of the nucleic acid filler strands further comprises a nucleic acid probe. In a further preferred embodiment, the nucleic acid filler strands comprise or consist of DNA.

In an even more preferred embodiment, each of the nucleic acid probes on the nucleic acid thread-based tile are unique, thus providing a large number of unique probes on the nucleic acid tile. In a further preferred embodiment, the single nucleic acid tile array comprises target bound to the nucleic acid probe. In various further preferred embodiments, the target can be any target as described above for the first, second, and third aspects of the invention, including but not limited to DNA, RNA, polypeptides, lipids, carbohydrates, other organic molecules, inorganic molecules and metallic particles, magnets, and quantum dots.

FIG. 16 provides an exemplary DNA thread-based tile. The threaded array (1) is a large piece of genomic DNA chosen to have no overlapping sequences that are complements of the probes. For example, if human sequences are the target, the DNA thread strand (1 in FIG. 1) could be an appropriately long viral genome. The DNA thread strand is folded into the desired shape (here a rectangle with a protruding indexing feature on the upper left) by helper strands, each chosen to go to the desired position in the array, and one or more of them bearing DNA probes. The helper strands are chosen to cross-link the scaffold strand (1) by hybridization and the formation of cross over structures, as shown by the strands in FIG. 16 (2 is an example). Other filler strands (also possibly carrying DNA probes) fill out the array and strengthen it (dashed strands exemplified by 3). The array carries an asymmetric indexing feature for imaging, here the piece labeled 4.

In another embodiment, one or more of the helper strands can be part of a larger nucleic acid structure. In one example, one or more helper strands protrude from one or more nucleic acid tiles, including but not limited to those disclosed in the first aspect of the invention (in this embodiment, not requiring sticky ends, but still with at least a plurality possessing nucleic acid probes). The helper strands fold the thread strand into place, and the nucleic acid tiles (and their nucleic acid probes) comprising the helper strands are thus precisely positioned on the thread strand. Other preferred embodiments of the individual nucleic acid tiles comprising the helper strand are as described for the first aspect of the invention. In a preferred embodiment, all of the helper strands in the thread strand-based tile protrude from individual nucleic acid tiles.

In another embodiment, one or more of the helper strands may protrude from one or more nucleic acid arrays (formed by combining two or more nucleic acid tiles), including but not limited to those disclosed in the first aspect of the invention. In this embodiment, one or more helper strands protrude from one or more tiling arrays and fold the thread strand into place, and the tiling arrays (and the nucleic acid tiles they are composed of, including nucleic acid probes) comprising the helper strands are thus precisely positioned on the thread strand. In this embodiment, it is possible, for example, to provide unlimited hierarchies of nucleic acid tiling arrays, including but not limited to the finite nucleic acid tiling arrays in the first aspect of the invention. In a preferred embodiment, all of the helper strands in the thread strand-based tile protrude from nucleic acid arrays.

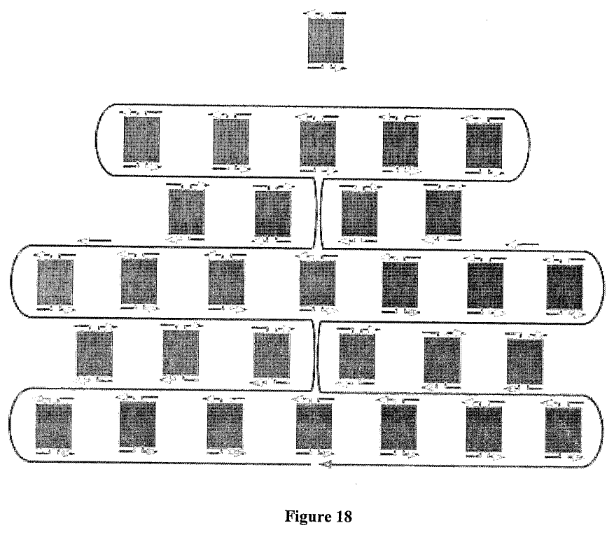

FIG. 18 is illustrates the use of a long scaffold strand to nucleate larger tiles into complex patterns. Each tile (darker rectangle shaped tile) will protrude single strands that will pair with part of the sequences in the scaffold. Therefore, each now acts as the same role of helper strands illustrated in the original DNA thread-strand based array. The tiles can be different geometry or size. The short protruding strands are distinct from tile to tile and this allows the unique positioning of the tiles along the scaffold lines.

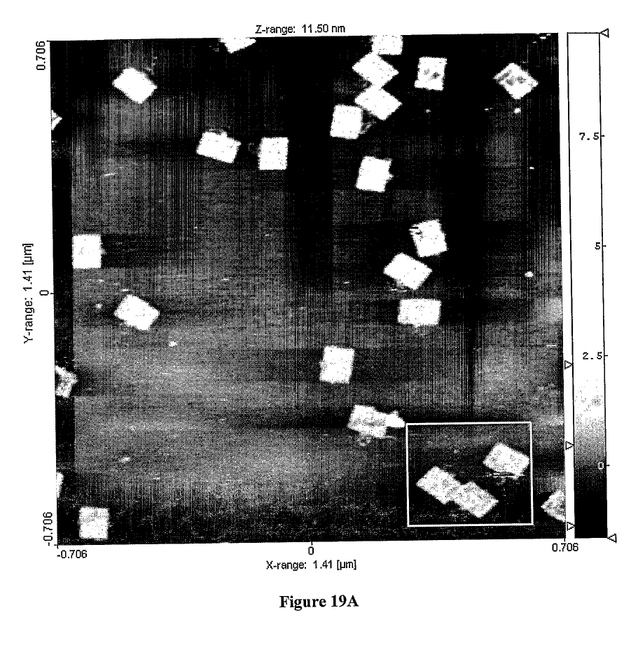

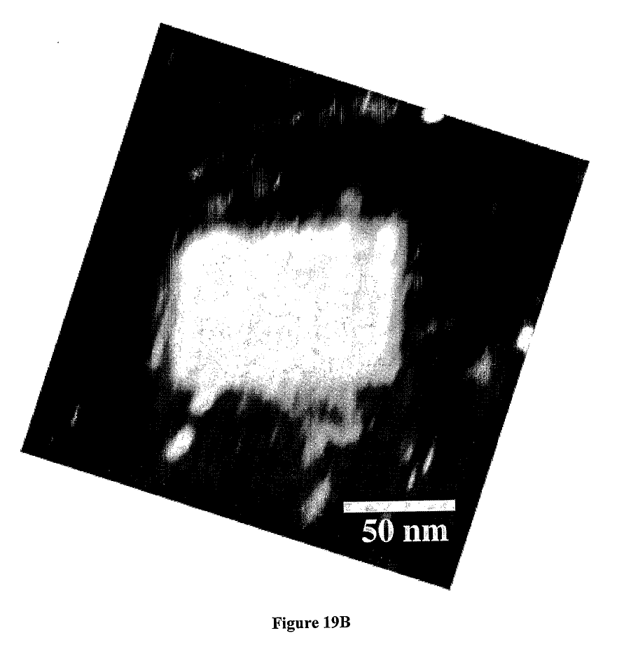

FIG. 19 an example of a thread strand-based tile. There are 360 single strand probes on the tile; in this case a number of the probes have the same sequence, so that when hybridized with a complementary strand the protruding dsDNA shows up in the AFM image as the letters “ASU.” The probes are spaced by about 4 nm. FIG. 19(A) shows an AFM image of a field of tiles, while FIG. 19(B) shows an AFM image of an individual tile. This demonstrates the use of thread strand-based tiles to create designer, high-density nanometer scale molecule arrays, where the molecules are present at precise, well-defined locations.

The dimensions of a given nucleic acid thread strand-based tile can be programmed, based on the available length and sequence of thread strand nucleic acid, and other design elements. For example, a 10,000 base thread strand nucleic acid could be formed into a nucleic acid tile covering an area of approximately 2 nm×10,000×0.3 nm or 6×10⁻¹⁵ m². This would correspond to a square of about 0.1 μm on each side. Depending upon the design of the thread strand-based nucleic acid tile, the size of the nucleic acid probe, the specific target, and other design feature, the density of target molecules on the nucleic acid tile can be as high as 1012 per square cm.

In this most preferred embodiment, the nucleic acid thread-based tile can be assembled in one step. A long template strand of nucleic acid is mixed with shorter ‘helper’ strands, usually in a large molar excess of the shorter strands. The strand sequences are chosen to fold the long template strand into the desired shape, as described by Yan et al. (Proceedings of the National Academy of Sciences 100, Jul. 8, 2003 pp 8103-8108.) The probe array is then achieved by using one or more helper strands with nucleic acid probes that are not complementary to any part of the template strand or the other helper strands. These will then protrude from the array, forming single stranded probe strands at known locations if the array contains an index feature as described earlier. General conditions for such hybridization are as disclosed above for the second aspect of the invention except that it is preferable to use a large molar excess of the helper strands in this approach.

As a specific example of preparation of the high-density DNA tile self-assembled around single strand long viral genome DNA scaffolds: Viral DNA such as M13 can be purchased from New England Biolabs. The circular single stranded DNA is then digested into a single strand using restriction enzyme cleavage at selected sites by hybridizing a short complementary strand at the restriction enzyme recognition site. All the short DNA helper strands are added to a solution containing the long scaffold strand in a ratio of 100:1 (large excess of helper strand) with the scaffold concentration at 1 nM. This ensures the helper strands goes into the array with a high yield. The arrays are annealed in 1×TAE/Mg buffer (40 mM Tris, 20 mM acetic acid, 2 mM EDTA, and 12.5 mM magnesium acetate, pH 8.0). The mixture solution is cooled slowly from 90° C. to 20° C. Monitoring to ensure correct assembly is carried out as described for the second aspect of the invention.

The nucleic acid thread-based tile can be made and stored as described above for the first aspect of the invention. In various embodiments, the nucleic acid thread-based tile may be present in solution, in lyophilized form, or attached to a substrate. Non-limiting examples of substrates to which the nucleic acid thread-based tile can be attached include silicon, quartz, other piezoelectric materials such as langasite (La₃Ga₅SiO₁₄), nitrocellulose, nylon, glass, diazotized membranes (paper or nylon), polyformaldehyde, cellulose, cellulose acetate, paper, ceramics, metals, metalloids, semiconductive materials, coated beads, magnetic particles; plastics such as polyethylene, polypropylene, and polystyrene; and gel-forming materials, such as proteins (e.g., gelatins), lipopolysaccharides, silicates, agarose and polyacrylamides.

The nucleic acid thread-based tile can be attached to such surfaces using any means in the art. For example, one simple way to do this is with multiply charged cations (Mg, Ni, Cu etc.) that spontaneously attach to a negative surface like glass or mica, leaving extra charge to attach the nucleic acid. Another way to do this is with singly charged cations that are tethered to the surface chemically. An example would be aminopropyltriethoxysilane reacted with surface hydroxyl groups. This attached to oxide surfaces by hydrolysis of the silanes, and leaves a positively charged amino group on the surface at neutral pH. Methods for using the nucleic acid thread strand tiles are as discussed above for each embodiment of the third aspect of the invention.

### EXAMPLE 1

### Addressable DNA Tile Nanogrids

In this example, we demonstrate the design and construction of fully addressable DNA tile nanogrids with each location bearing a unique biochemical label and show how they can be used to detect the hybridization of single DNA molecules.

A wide variety of nanostructures have been produced by hybridizing DNA polynucleotides to form structures that contain cross-over molecules. These tiles assemble into arrays with repeating structural motifs, for example as linear structures in which tiles alternate in an ABABAB . . . pattern. Our finite size addressable arrays are based on a recently developed cross-shaped DNA tile structure^{3d} which consists of four 4-arm DNA branch junctions. For the addressable array, a modified cross-shaped DNA tile structure is used (FIG. 2a showing diagram without DNA sequences)). Each tile has unique 7 bp sticky ends, chosen to hybridize with one, and only one other tile at each side. In addition, each tile contains a small double helical stub from which protrudes a 16 base single stranded probe that is unique to the tile. The sequences of all single stranded regions are chosen so as to avoid unwanted hybridizations using the SEQUIN program⁵. As a prototype, we assembled the 3×3 array of 9 tiles shown schematically in FIG. 2b (showing diagram without DNA sequences). We first hybridized all of the polynucleotides for each tile, pooled the tiles and hybridized the mix (see Methods). This step-wise assembly gave a high yield of intact arrays (>70%) by sampling and analyzing 5 scans each of 1 μm² area, in this analysis the overall yield was estimated by dividing the number of intact 9 tile arrays by the total number of the arrays (intact plus smaller arrays). In the design of the addressable DNA tile array, the outer edge of each of the outer tiles had TTT overhangs that terminated further self-assembly into any larger arrays. A typical AFM image of a preparation of 9-tile arrays spread onto mica is shown in FIG. 2c. The preparation has not been purified in any way, and was imaged in buffer solution after a drop containing the arrays had been placed on Ni²⁺ treated mica⁶ (see Methods). Most (>70%) of the arrays are complete and intact. Some partly assembled arrays are visible. A gallery of magnified images of individual arrays is shown in FIG. 2d. Each of the 9 tiles is clearly visible, and the structure has the expected 18 nm repeatd.

In order to confirm the specific placement of each tile, we incorporated a biotinylated strand into certain tiles in turn, for example the center tile, the corners, the diagonals and the center tiles at each edge. We then incubated the arrays with streptavidin, finding bound protein only at the predicted positions (see FIG. 7).

The arrays are preferably indexed if they are to be used as analytical devices, and the schematic arrangement of such an indexed array is shown in FIG. 3a; see FIG. 5 for a schematic view of the tiling array (without sequences); see FIG. 6A-J and Appendix A for details of the strand structure and polynucleotide sequences. An extra index tile has been added to the array (position ‘0’). We used this array to detect the hybridization of single molecules as follows: Complementary strands to the probe sequences at positions 5, 8 and 9 were biotinylated at their 3′ end. The arrays were incubated with one of these three polynucleotides, or with a control polynucleotide that was also biotinylated, but not complementary to one of the probe sequences, After hybridization, the arrays were incubated with streptavidin, used here as a marker to label locations that acquired a biotinylated strand by hybridization (as illustrated in FIG. 3b). FIGS. 3c, d and e show AFM images demonstrating the detection of DNA hybridization to the probe at position 9, 5 and 8, respectively. The position that the streptavidin bound was evident as a white blob in the image. Statistical analysis (Table 1) shows that 64 intact arrays incubated with sequences complementary to the probe at position 5 yielded 40 intact arrays with streptavidin at position 5 and none at other positions. Hybridization on probe 8 yielded 36 (out of 54 arrays) with bound streptavidin at position 8 and none elsewhere. Hybridization on probe 9 yielded 46 (out of 72 arrays) with bound streptavidin at position 9 and none elsewhere. In contrast, control experiments incubated with an excess of biotinylated but non-complementary DNA yielded no streptavidin binding (see Methods). FIG. 3d shows 3 examples of AFM images obtained for the control experiment. Thus, single molecule hybridization was detected on these arrays with an average efficiency of 64%.

TABLE 1

| probe location | number of 9-tiles | strand hybridization |
|---|---|---|
| Tile 5 | 64 | 40 |
| Tile 8 | 54 | 36 |
| Tile 9 | 72 | 46 |
| control | 69 | 0 |

In experiments with streptavidin labeled arrays, we never found images that appeared to have the labeled face of the array towards the mica surface. It appears that the interaction between the DNA and the Ni-treated mica is strong enough to make ‘upside down’ arrangements of labeled arrays improbable. Therefore, the measured labeling efficiencies quoted above are indicative of the overall efficiency of hybridization and streptavidin labeling. As a further control, we examined arrays that were hybridized with complementary target DNA but that were not streptavidin labeled (data not shown). High-resolution images showed some changes (possibly owing to an increased stiffness in the hybridized strands vs. the ssDNA) but no evidence of the white blobs that mark the streptavidin binding in these images.

Even these small (3×3) arrays should prove useful for probing cooperative interactions between pairs of tethered peptides, by investigating cooperative effects in ligand binding, for example. The array would permit 12 possible pairs of nearest neighbor interactions to be probed, enough to try out all ten possible pairings of 5 distinct peptides. A small-scale addressable array may also find applications in investigating proximity effect between proteins or other macromolecules. By increasing the length of the sticky-ends to allow more space for unique sequence designs, there appears to be no fundamental limit to the size of the array that could be built. Larger arrays are preferably assembled in sequential steps to minimize the amount of partially hybridized product. A 15,000 probe gene expression array would be only a little over 1 micron on each side assembled by this technology, opening an entirely new vista in molecular assembly and the analysis of spatial interactions between diverse biologically relevant molecules.

### Methods:

Formation of the array. The strand sequences for each individual DNA tile used for the addressable array are given in FIGS. 6A-6J and Appendix A. The core structure of the cross-shaped tiles was copied from the ref. 5, a random set of different 7 base sequences were used as different sticky ends of the individual tiles, which were assigned arbitrarily to each tiles. The sticky-end sequences were checked with SEQUIN program to confirm that there were no mismatches in sequence. Custom polynucleotides were purchased from Integrated DNA Technology (www.idtdna.com) and purified by 10% or 20% denaturing PAGE. The concentration of each strand was estimated by measuring OD₂₆₀. Each individual tile was assembled by mixing a stoichiometric quantity of the strands involved in the tile in 1×TAE/Mg buffer (20 mM Tris, pH 7.6, 2 mM EDTA, 12.5 mM MgCl₂). The final concentration of each DNA tile was 1.0 μM, and the final volume was 60 μL. The polynucleotide mixtures were cooled slowly from 94° C. to 30° C. in PCR machine at a cooling rate of 4° C. every 5 minutes to ensure hybridization of the strands in the tile. Then a stoichiometric volume (20 μL) of the tiles were mixed, and the mixture was program cooled from 33 to 10° C. in a PCR machine at a cooling speed of 0.2 degree per minute to ensure the proper hybridization of the sticky ends between the tiles to form the 9-tile or indexed 9-tile array.
Hybridization and labeling of target strands to the array. 1 uM of the biotinylated target strands were added at 20° C. to allow the hybridization to the 16 bp probe strands. K_{d} of the 16 bp hybridization at 20° C. is estimated to be ˜7.5×10⁻¹⁴ M using MFOLD program [Mfold web server for nucleic acid folding and hybridization prediction. Nucleic Acids Res. 31 (13), 3406-15, (2003)]. After the hybridization, Streptavidin (final concentration: 1.0 μM in 1×TAE/Mg buffer) was added to the DNA array at room temperature to make a final 1:1 mole ratio of streptavidin and the biotinylated target strand on the DNA array. The mixture was incubated for 1 hour at room temperature before imaging. In the control experiment incubated with an excess of biotinylated but non-complementary DNA, streptavidin was removed using the Microcon YM-100 filters (Millipore Corporation) following the protocol described in the product.
AFM imaging. AFM imaging was performed under 1×TAE/Mg in a fluid cell on PicoPlus AFM (Molecular Imaging) in AAC mode, using the tip on the thinner and shorter cantilever of the NP-S tips (Veeco Inc.). A piece of freshly cleaved mica (Ted Pella, Inc.) was first assembled at the bottom of the fluid cell on the sample plate. 2 μL of 1 mM NiCl₂ solution was spotted on mica, and left to adsorb on the surface for 2 min. Then 2 μL of the sample (10 times diluted in 1×TAE/Mg buffer) was added to the spot. Finally, 400 μL 1×TAE/Mg buffer was added onto the mica in the fluid cell. The Ni²⁺ adsorbed on mica surface can help the DNA array stay on the surface in the scanning.

To verify the specific placement of each tile in the 9 tile array, we incorporated a biotinylated strand into certain tiles in turn, for example the center tile, the corners, the diagonals and the center tiles at each edge. (FIG. 7) We then incubated the arrays with streptavidin, finding bound protein only at the predicted positions. Panels on the left are schematic drawing showing the expected position of the streptavidin (balls) on the array and panels on the right are corresponding AFM images, bright spots reveals the streptavidin.

### DNA Strand Structures and Sequences:

| | |
|---|---|
| Target strand for position 5: | |
| 5′-AGTTGCGTGTCGAGCA-3′-Biotin | (SEQ ID NO:385) |
| Target strand for position 8: | |
| 5′-GGATGATAAGCAACCT-3′-Biotin | (SEQ ID NO:386) |
| Target strand for position 9: | |
| 5′-CTGACCAACCATTCGC-3′-Biotin | (SEQ ID NO:387) |
| Strand for the control experiment: | |
| 5′-C ATA CCT GTC GAT GCA-3′-Biotin | (SEQ ID NO:388) |

### EXAMPLE 1 REFERENCES

(1) Seeman, N. C. Nature 421, 427-431 (2003).
(2) Seeman, N. C. J Theor Biol 99, 237-47 (1982).
(3) (a) Winfree, E.; Liu, F.; Wenzler, L. A.; Seeman, N. C. Nature 1998, 394, 539-544. (b) LaBean, T. H.; Yan, H.; Kopatsch, J.; Liu, F.; Winfree, E.; Reif, J. H.; Seeman, N. C. J. Am. Chem. Soc. 2000, 122, 1848-1860. (c) Mao, C.; Sun, W.; Seeman, N. C. J. Am. Chem. Soc. 1999, 121, 5437-5443. (d) Yan, H.; Park, S. H.; Finkelstein, G.; Reif, J. H.; LaBean, T. H. Science 2003, 301, 1882-1884. (e) Liu, D.; Wang, M.; Deng, Z.; Walulu, R.; Mao, C. J. Am. Chem. Soc. 2004, 126, 2324-2325. (f) Ding, B.; Sha, R.; Seeman, N. C. J. Am. Chem. Soc. 2004, 126, 10230-10231. (g) Rothemund, P. W. K.; Papadakis, N.; Winfree, E. PLoS Biology 2004, 2, 2041-2053. (h) Shih, W. M.; Quispe, J. D.; Joyce, G. F. Nature 2004, 427, 618-621. (i) Malo, J.; Mitchell, J. C.; Venien-Bryan, C.; Harris, J. R.; Wille, H.; Sherratt, D. J.; Turberfield, A. J. Angew. Chem., Int. Ed. 2005, 44, 3057-3061. 0) Mathieu, F.; Liao, S.; Kopatsch, J.; Wang, T.; Mao, C.; Seeman, N. C. Nano Lett. 2005, 5, 661-665. (k) Park, S. H.; Barish, R.; Li, H.; Reif, J. H.; Finkelstein, G.; Yan, H.; LaBean, T. H. Nano Lett. 2005, 5, 693-696. (1) Park, S. H. et al. Nano Lett. 2005, 5, 729-733. (m) Chworos, A.; Severcan, I.; Koyfman, A. Y.; Weinkam, P.; Oroudjev, E.; Hansma, H. G.; Jaeger, L. Science 2004, 306, 2068-2072. (n) Chelyapov, N.; Brun, Y.; Gopalkrishnan, M.; Reishus, D.; Shaw, B.; Adleman, L. J. Am. Chem. Soc. 2004, 126, 13924-13925.
(4) Holliday, R. Genet. Res. 5, 282-304 (1964).
(5) Seeman, N. C. J Biomol StructDyn 8, 573-81 (1990).
(6) Hansma, H. G., Laney, D. E. Biophysical Journal, 70, 1933-1939 (1996).

### EXAMPLE 2

### Finite Size DNA Tiling Arrays

Structural DNA nanotechnology aims at the construction of well-defined nano- to micrometer scale structures from simple DNA building blocks. In recent years, predictable self-assembly of DNA tiles composed of branched junctions to construct periodic 1-dimensional (1D) and 2-dimensional (2D) patterned lattices has been demonstrated². DNA and RNA lattices of more complex patterns have also become possible through algorithmic self-assembly^{2g,2l}. The use of self-assembled DNA nanostructures as templates to organize metallic nanoparticles³ or as molecular lithographic masks to produce well-ordered gold replicas⁴ has made DNA self-assembly a promising tool for potential nanoelectronic applications. However, previous examples of self-assembled DNA lattices lack control of the final lattice size because terminating events are not programmed into the self-assembly. Such control is crucial since future nanoelectronic devices assembled on a DNA based molecular print-board would require the DNA scaffolds to have defined boundaries, thus self-assembly of finite size DNA nanoarrays represents an immediate challenge for structural DNA nanotechnology.

One way to self-assemble a finite size DNA nanoarray with N tiles is to synthesize N different tiles, each containing unique sticky-ends to connect to its neighboring tiles, so that each tile takes up a unique and well defined position in the array.

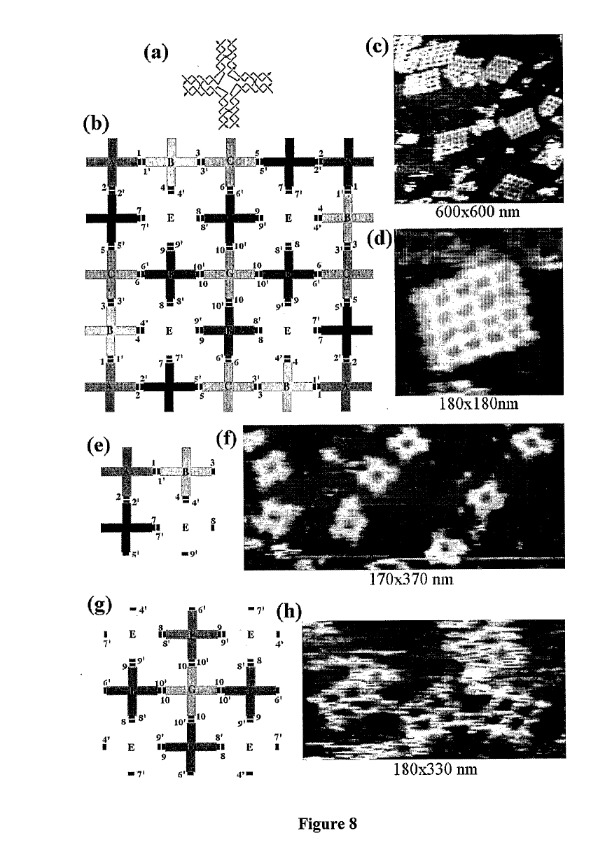

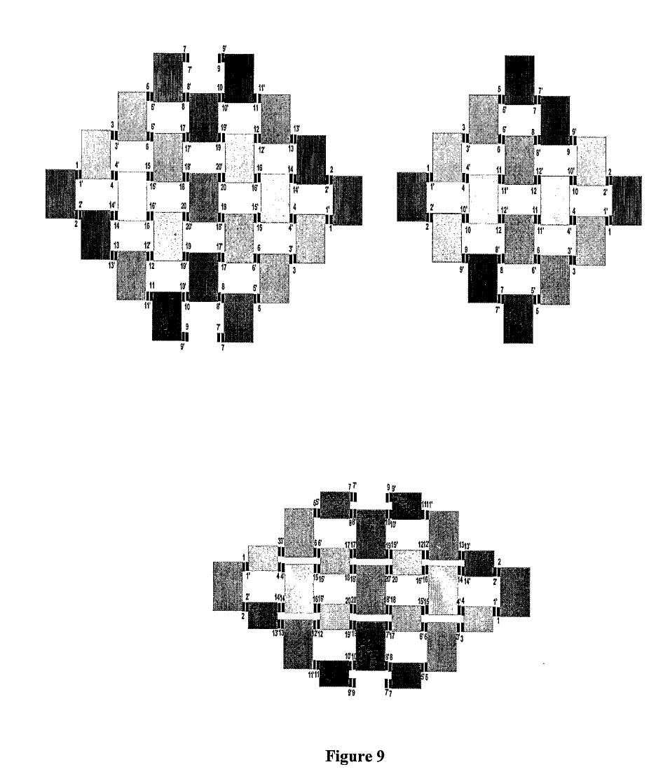

Here we report a novel and more cost-effective strategy to produce finite size DNA arrays. This strategy takes advantage of the geometric symmetry of the tile structure. In general, to use a total of N tiles to construct a fixed size 2D array with Cₘ symmetry, where m=2, 3, 4, or 6, the number of unique tiles the fixed size array requires is N/m, if N/m is an integral number, or Int(N/m)+1, if N/m is an non-integral number. We herein demonstrate two examples of fixed size arrays with C₂ and C₄ fold symmetry. Specifically, a 5×5 array formed from DNA tiles with C₂ symmetry requires 13 unique tiles instead of 25 (FIG. 7A-B); while a 5×5 array formed from DNA tiles with C₄ symmetry requires 7 unique cross-shaped tiles instead of 25 (FIG. 8A-B). Therefore, this strategy is cost-effective in material. Furthermore, within each self-assembled finite size array, the unique tiles all share the same core strand sequences, so only the individual sticky ends need to be different to result in a single way of connectivity between the tiles. This minimizes the design time and the sample preparation time dramatically. Thus, the finite sized DNA nanoarrays can be constructed efficiently.

FIGS. 7a and 7b show an example of a 5×5 fixed size array self-assembled from a DNA tile containing C₂ symmetry. This is a new tile structure we recently constructed²ⁿ, which has 8 DNA helixes joined together in a plane with two crossovers running from one helix to its neighboring helixes. The dimension of a single 8-helix bundle tile is ˜17 nm along the helix axis, and ˜14 nm perpendicular to the helix axis in the plane. The sticky ends can only point along the direction of the helix axis. The structure has C₂ symmetry with the symmetry axis perpendicular to the tile plane. The reason that we chose the 8-helix structure to demonstrate the fixed size array is because the large cavity resulting from this tile assembly can easily be visualized by atomic force microscopy (AFM). The 13 unique tiles are different only in the sticky ends pointing out from the 5′ ends of the outmost helix in the tiles and are each labeled by a different letter in FIG. 7b. The sticky-end associations are labeled by the corresponding numbers, e.g. n pairs with n′. To form the array, a two-step annealing procedure was used. We first formed each individual tile separately by combining their component DNA strands stoichiometrically and cooling from 90° C. to 40° C. and then combine all the 13 tiles in the correct ratios together into one solution at 40° C. and followed by further cooling to 10° C. FIG. 7c shows an AFM image of the sample deposited onto a mica surface. The magnified image shown in FIG. 7d reveals a well-defined fixed size array with 25 tiles. The dimension of each individual tile measures 16.9×14.2 nm, consistent with our design parameters. The dimension of the 5×5 array measures 110 nm on each side. No 2D arrays larger than the designed dimensions are observed and the overall geometry of the 5×5 array evidences a C₂ symmetry.

We have further demonstrated the symmetric assembly strategy using another tile structure that has C₄ symmetry. We recently constructed a family of DNA tiles^{2d} which resemble a cross structure composed of four 4-arm DNA branch junctions. Self-assembly from a single unit of the cross structure resulted in 2D nanogrids, which display periodic square cavities. The tile structure contains a 4-fold symmetry perpendicular to the tile plane (FIG. 8a; see FIGS. 17A-G for polynucleotide sequences used in the tiles). FIG. 8b illustrates the formation of a 5×5 fixed size array from the cross structure requiring only 7 unique tiles, each tile labeled by a different letter. AFM images in FIGS. 8c and 8d clearly demonstrate the correct formation of the 5×5 fixed size array from the cross-shaped tile structure. The dimension of the cavity is about 17.2×16.8 nm, which matches the design parameters. It is notable that the 5×5 array observed by AFM most of time do not show a perfect square, but rather a diamond shape. This is due to the flexibility of the cross shaped tile, in which the acute angle of the cross may range from 90 degrees to as little as 45 degrees under a stress. However, this does not affect the integrity of the tile nor the connectivity of the sticky ends.

It should also be noted that within the same design, instead of using all different unique tiles, one can use a smaller number of tiles to form smaller finite size arrays. For example, in FIG. 8b, if one uses the 4 corner tiles of A, B, D and E, a finite size 2×2 4-tile array can be produced (FIGS. 8e, f). On the other hand, if one only uses the 3 center tiles of G, F and E, a 3×3 9-tile array can be produced (FIGS. 8g, h). In principle, if one used the 4 side tiles of A, B, C and D, a 16 tile square with a large cavity space should be formed, but due to the flexibility of the individual tiles and less cooperativity of the assembly, a perfect square of this size has not been observed.

It is also an interesting observation that for the fixed size array formed by these cross tiles, when only one or two tiles on the outside are missing, the overall shape of the array does not change. However, if one or two tiles in the center are missing, some other array shapes can be formed, such as a triangle or a 5-point star shape (See Methods). Again, this is due to the flexibility of the cross-shaped tile and the occasions of such arrays are rare although it is statistically possible in a molecular self-assembly. Because the 8-helix bundle tile in FIG. 7 is a very rigid motif, other shaped fixed sized arrays based on this tile were not observed.

In summary, we have defined a novel strategy to produce fixed size DNA nanoarrays. We have proved the working principle of this strategy by demonstrating the formation of fixed size array with two different symmetries. By adding sticky-ends to the outside frame of the fixed size arrays, individual fixed size array could be further used to form larger arrays with defined dimensions in a hierarchical way. The strategy reported here provides a powerful means to produce molecular lithographic masks for nanoelectronic device constructions or templates for small-scale protein nanoarrays. The high parallelism and accurate control at nanometer scale precision offered by DNA self-assembly, when combined with top-down methods may lead to nanofabrication with complex molecular architectures.

### EXAMPLE 2 REFERENCES

(1) Seeman, N. C. Nature 2003, 421, 427-431.
(2) (a) Winfree, E.; Liu, F.; Wenzier, L. A.; Seeman, N. C. Nature 1998, 394, 539-544. (b) LaBean, T. H.; Yan, H.; Kopatsch, J.; Liu, F.; Winfree, E.; Reif, J. H.; Seeman, N. C. J. Am. Chem. Soc. 2000, 122, 1848-1860. (c) Mao, C.; Sun, W.; Seeman, N. C. J. Am. Chem. Soc. 1999, 121, 5437-5443. (d) Yan, H.; Park, S. H.; Finkelstein, G.; Reif, J. H.; LaBean, T. H. Science 2003, 301, 1882-1884. (e) Liu, D.; Wang, M.; Deng, Z.; Walulu, R.; Mao, C. J. Am. Chem. Soc. 2004, 126, 2324-2325. (f) Ding, B.; Sha, R.; Seeman, N. C. J. Am. Chem. Soc. 2004, 126, 10230-10231. (g) Rothemund, P. W. K.; Papadakis, N.; Winfree, E. PLoS Biology 2004, 2, 2041-2053. (h) Shih, W. M.; Quispe, J. D.; Joyce, G. F. Nature 2004, 427, 618-621. (i) Malo, J.; Mitchell, J. C.; Venien-Bryan, C.; Harris, J. R.; Wille, H.; Sherratt, D. J.; Turberfield, A. J. Angew. Chem., Int. Ed. 2005, 44, 3057-3061. 0) Mathieu, F.; Liao, S.; Kopatsch, J.; Wang, T.; Mao, C.; Seeman, N. C. Nano Lett. 2005, 5, 661-665. (k) Park, S. H.; Barish, R.; Li, H.; Reif, J. H.; Finkelstein, G.; Yan, H.; LaBean, T. H. Nano Lett. 2005, 5, 693-696. (1) Chworos, A.; Severcan, I.; Koyfman, A. Y.; Weinkam, P.; Oroudjev, E.; Hansma, H. G.; Jaeger, L. Science 2004, 306, 2068-2072. (m) Chelyapov, N.; Brun, Y.; Gopalkrishnan, M.; Reishus, D.; Shaw, B.; Adleman, L. J. Am. Chem. Soc. 2004, 126, 13924-13925. (n) Ke, Y.; Liu, Y.; Zhang, J.; Yan, H., in preparation.
(3) (a) Loweth, C. J., et al. Angew. Chem., Int. Ed. 1999, 38, 1808-1812. (b) Xiao, S., et al. J. Nanopart. Res. 2002, 4, 313. (c) Li, H.; Park, S. H.; Reif, J. H.; LaBean, T. H.; Yan, H. J. Am. Chem. Soc. 2004, 126, 418-419. (d) Le, J. D.; Pinto, Y.; Seeman, N. C.; Musier-Forsynth, K.; Taton, T. A.; Kiehl, R. A. Nano. Lett. 2004, 4, 2343. (e) Niemeyer, C. M.; Koehler, J.; Wuerdemann, C. ChemBioChem 2002, 3, 242. (f) Deng, Z.; Tian, Y.; Lee, S.; Ribbe, A. E.; Mao, C. Angew. Chem., Int. Ed. 2005, 44, 3582-3585.
(4) Deng, Z.; Mao, C. Angew. Chem., Int. Ed. 2004, 43, 4068-4070.
(5) Soloveichik, D, Winfree, E. DNA Computing, Lecture Notes in Computer Science. 2005, 3384: 344-354.

### Material and Methods:

Complex Design The sequence of the 8-helix bundle tiles were designed with the program SEQUIN (1) to minimize mismatches and sequence symmetry. The strand sequences for the each individual tiles are given below. The core structure of the 4-arined tiles was copied from the ref (2). A random set of different 6-base or 7-base sequences were used as different sticky ends of the individual tiles, which were assigned to each tiles.
DNA Assembly Custom polynucleotides were purchased from Integrated DNA Technology (www.idtdna.com) and purified by denaturing PAGE. The concentration of each strand was measured and estimated by measuring OD260. Each individual tiles were assembled by mixing a stoichiometric quantity of the strands involved in the tile in 1×TAE/Mg buffer (20 mM Tris, pH 7.6, 2 mM EDTA, 12.5 mM MgCl2). The final concentration of DNA was 1.0 μM, and the final volume was 60 μL. The polynucleotide mixtures were cooled slowly from 90° C. to room temperature in 2 L water placed in a styrofoam box over 16 hours to facilitate hybridization. Non-denaturing PAGE gel was used to confirm the assembly of each individual tiles. Then a stoichiometric volume of the tiles were mixed at 40° C. on a heat block, and the mixture was program cooled from 40° to 10° C. in a PCR machine. The cooling was cycled 5 times in a 5° C. step at a speed of 0.2 degree per minute. The initial moderate heating and cycled slow cooling was chosen to balance the needs between to avoid the disassembly of the tiles, which have melting temperatures in the range of 50-65° C., and to eliminate the possible mismatches among the different sticky ends of the tiles.
AFM Imaging. Imaging was performed under 1×TAE/Mg in a fluid cell on PicoPlus AFM (Molecular Imaging) in AAC mode, using the tip on the thinner and shorter cantilever of the NP-S tips (Veeco Inc.). A piece of freshly cleaved mica (Ted Pella, Inc.) was first assembled as the bottom of the fluid cell on the sample plate. A 2 μL of 1 mM NiCl2 solution was spotted on mica, and left to adsorb on the surface for 2 min. Then a 2 μL of the sample (10 times diluted in 1×TAE/Mg buffer) was added to the spot. Finally, 400 μL 1×TAE/Mg buffer was added onto the mica in the fluid cell. The Ni2+ adsorbed on mica surface can help the DNA array stay on the surface during the scanning (3).

### MATERIALS AND METHODS REFERENCES

1. N. C. Seeman, J. Biomol. Struct. Dyns. 1990, 8, 573.
2. Yan, H.; Park, S. H.; Finkelstein, G.; Reif, J. H.; LaBean, T. H. Science 2003, 301, 1882-1884
3. Hansma, H. G.; Laney, D. E. Biophysical Journal, 1996, 70, 1933-1939 S2
   Detailed Explanations of our Defined Rule for the Symmetric Finite Size Array with C2, C3, C4 and C6 Geometric Symmetry and the Possible Scenarios with Odd or Even Number of Tiles Involved.
   The rule: In general, to use a total of N tiles to construct a fixed size 2D arrays with Cm symmetry, where m=2, 3, 4, or 6, the number of unique tiles the fixed size array requires is N/m, if N/m is an integral number, or Int(N/m)+1, if N/m is an non-integral number.

Scenario 1 (FIG. 9): Tile with C2 symmetry: Left: odd number of tiles (to form a 25 tile array, 13 unique tiles are needed); Right: Even number of tiles (to form a 16 tile array, 8 unique tiles and 12 pairs of sticky ends are needed); Bottom: The rule still apply even when the shapes of the C2 symmetry tile are different (e.g. square & rectangle, in this way, cavities of different dimensions can be obtained).

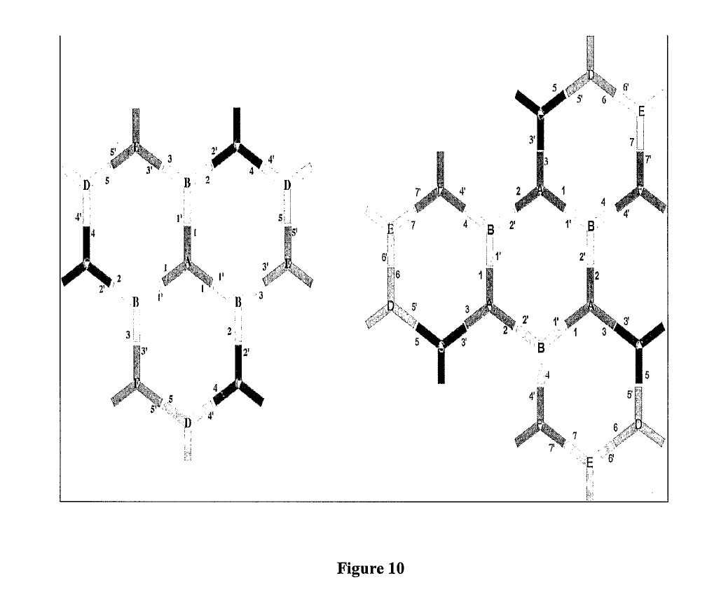

Scenario 2 (FIG. 10): Tile with C3 symmetry: Left: odd number of tiles (to form a 13 tile array, 5 unique tiles are needed); Right: Even number of tiles (to form 18 tile array, 6 unique tiles are needed); (only scheme is shown here).

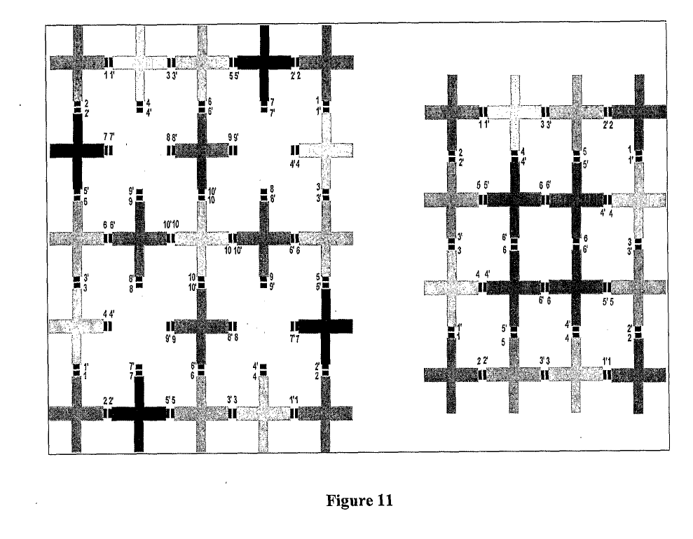

Scenario 3 (FIG. 11): Tile with C4 symmetry: Left: odd number of tiles (to form a 25 tile array, 7 unique tile are needed); Right: Even number of tiles (to form a 16 tile array, 4 unique tiles are needed).

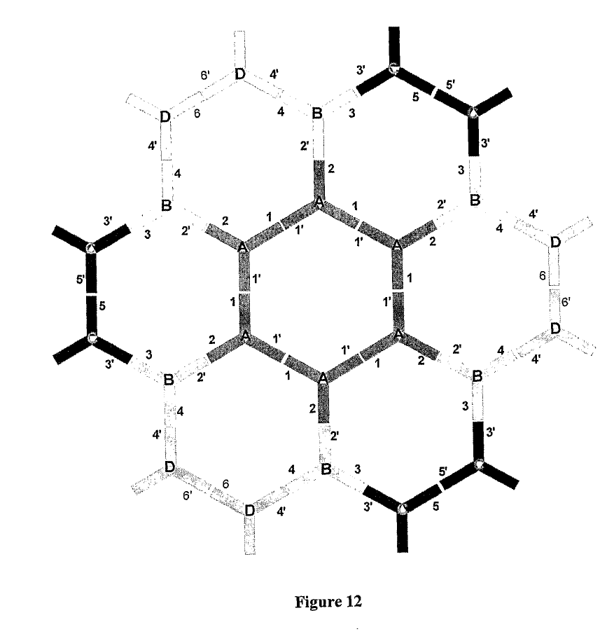

Scenario 4 (FIG. 12): Tile with C6 symmetry: Only even number of tiles exists in this case. To form a 24 tile array, 4 unique tiles are needed. (only scheme is shown here).

APPENDIX A
Polynucleotide sequences shown in FIGS. 6A-J; 13A-G; and 14A-G:

| | |
|---|---|
| FIG. 6a, Tile 0 | |
| T0-1 | |
| GCTACCCTGTAGACCCGTTTCTCACGGGACGCCTC | (SEQ ID NO:1) |
| T0-2 | |
| 5′-TTTGAGGCGTGGTGCTCTTT-3′ | (SEQ ID NO:2) |
| T0-3 | |
| 5′-GAGCACCGGATCTAAGTCGTTCCGACGGACGAACC-3′ | (SEQ ID NO:3) |
| T0-4 | |
| 5′-AAATCCCGGTTCGTGGGCATCAACCCAA-3′ | (SEQ ID NO:4) |
| T0-5 | |
| 5′-GATGCCCTGACCGAGTCCCCATAGATGGACAACCC-3′ | (SEQ ID NO:5) |
| T0-6 | |
| 5′-TTTGGCTTGTGGCACTTTTT-3′ | (SEQ ID NO:6) |
| T0-7 | |
| 5′-AAGTGCCAGGTCGAAATGCACACGTAGGACATTCA-3′ | (SEQ ID NO:7) |
| T0-8 | |
| 5′-TTTTGAATGTGGGTAGCTTT-3′ | (SEQ ID NO:8) |
| T0-9 | |
| 5′-GATCCCCCGTGAGAATTTTACGGGTCTACACCTACGTGTGTTTTCATTTCG | (SEQ ID NO:9) |
| ACCACCATCTATGGTTTTGGACTCGGTCACCGTCGGAACTTTTGACTTA-3′ | |

***************************************

| | |
|---|---|
| FIG. 6B, Tile 1 | |
| T1-1A | |
| 5′-GGGATTTGCTACCCTGTAGACATCTCCATGCCAAAACCTGGCC-3′ | (SEQ ID NO:10) |
| T1-1B | |
| 5′-GGAGATTTCCGTTTCTCACGGGACGCCTC-3′ | (SEQ ID NO:11) |
| T1-2 | |
| 5′-TTTGAGGCGTGGTGCTCTTT-3′ | (SEQ ID NO:12) |
| T1-3 | |
| 5′-GAGCACCGGATCTAAGTCGTTCCGACGGACGAACCGCTGTTC-3′ | (SEQ ID NO:13) |
| T1-4 | |
| 5′-GGTTCGTGGGCATC-3′ | (SEQ ID NO:14) |
| T1-5 | |
| 5′-GCACGATGATGCCCTGACCGAGTCCCCATAGATGGACAAGCCGCTTCAC-3′ | (SEQ ID NO:15) |
| T1-6 | |
| 5′-GGCTTGTGGCACTT-3′ | (SEQ ID NO:16) |
| T1-7 | |
| 5′-AGACTGCAAGTGCCAGGTCGAAATGCACACGTAGGACATTCATTGGGT | (SEQ ID NO:17) |
| T-3′ | |
| T1-8 | |
| 5′-TGAATGTGGGTAGC-3′ | (SEQ ID NO:18) |
| T1-9 | |
| 5′-GATCCCCCGTGAGAATTTTACGGGTCTACACCTACGTGTGTTTTCATTTCG | (SEQ ID NO:19) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6C, Tile 2 | |
| T2-1A | |
| 5′-GCTACCCTGTAGACATCTCCCACGCATCGCGGTACG-3′ | (SEQ ID NO:20) |
| T2-1B | |
| 5′-GGAGATTTCCGTTTCTCACGGGACGCCTC-3′ | (SEQ ID NO:21) |
| T2-2 | |
| 5′-TTTGAGGCGTGGTGCTCTTT-3′ | (SEQ ID NO:22) |
| T2-3 | |
| 5′-GAGCACCGGATCTAAGTCGTTCCGACGGACGAACC-3′ | (SEQ ID NO:23) |
| T2-4 | |
| 5′-GACGCAAGGTTCGTGGGCATCTCTGAGC-3′ | (SEQ ID NO:24) |
| T2-5 | |
| 5′-GATGCCCTGACCGAGTCCCCATAGATGGACAAGCC-3′ | (SEQ ID NO:25) |
| T2-6 | |
| 5′-AACCCAGGGCTTGTGGCACTTTGCCGAC-3′ | (SEQ ID NO:26) |
| T2-7 | |
| 5′-AAGTGCCAGGTCGAAATGCACACGTAGGACATTCA-3′ | (SEQ ID NO:27) |
| T2-8 | |
| 5′-ATCGTGCTGAATGTGGGTAGCGAACAGC-3′ | (SEQ ID NO:28) |
| T2-9 | |
| 5′-GATCCCCCGTGAGAATTTTACGGGTCTACACCTACGTGTGTTTTCATTTCG | (SEQ ID NO:29) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6D, Tile 3 | |
| T3-1A | |
| 5′-TTGCGTCGCTACCCTGTAGACATCTCCCCAGCCGGGCGTGGCT-3′ | (SEQ ID NO:30) |
| T3-1B | |
| 5′-GGAGATTTCCGTTTCTCACGGGACGCCTC-3′ | (SEQ ID NO:31) |
| T3-2 | |
| 5′-TTTGAGGCGTGGTGCTCTTT-3′ | (SEQ ID NO:32) |
| T3-3 | |
| 5′-GAGCACCGGATCTAAGTCGTTCCGACGGACGAACC-3′ | (SEQ ID NO:33) |
| T3-4 | |
| 5′-TTTGGTTCGTGGGCATCTTT-3′ | (SEQ ID NO:34) |
| T3-5 | |
| 5′-GATGCCCTGACCGAGTCCCCATAGATGGACAAGCCCGCTGAT-3′ | (SEQ ID NO:35) |
| T3-6 | |
| 5′-GGCTTGTGGCACTT-3′ | (SEQ ID NO:36) |
| T3-7 | |
| 5′-GCCAGATAAGTGCCAGGTCGAAATGCACACGTAGGACATTCAGCTCAG | (SEQ ID NO:37) |
| A-3′ | |
| T3-8 | |
| 5′-TGAATGTGGGTAGC-3′ | (SEQ ID NO:38) |
| T3-9 | |
| 5′-GATCCCCCGTGAGAATTTTACGGGTCTACACCTACGTGTGTTTTCATTTCG | (SEQ ID NO:39) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6E, Tile 4 | |
| T4-1A | |
| 5′-GCTACCCTGTAGACATCTCCATCATCGTCGACGATG-3′ | (SEQ ID NO:40) |
| T4-1B | |
| 5′-GGAGATTTCCGTTTCTCACGGGACGCCTC-3′ | (SEQ ID NO:41) |
| T4-2 | |
| 5′-GCAGTCTGAGGCGTGGTGCTCGTGAAGC-3′ | (SEQ ID NO:42) |
| T4-3 | |
| 5′-GAGCACCGGATCTAAGTCGTTCCGACGGACGAACC-3′ | (SEQ ID NO:43) |
| T4-4 | |
| 5′-ATGCGAGGGTTCGTGGGCATCACCATGT-3′ | (SEQ ID NO:44) |
| T4-5 | |
| 5′-GATGCCCTGACCGAGTCCCCATAGATGGACAAGCC-3′ | (SEQ ID NO:45) |
| T4-6 | |
| 5′-TAGGATCGGCTTGTGGCACTTGTCTGTA-3′ | (SEQ ID NO:46) |
| T4-7 | |
| 5′-AAGTGCCAGGTCGAAATGCACACGTAGGACATTCA-3′ | (SEQ ID NO:47) |
| T4-8 | |
| 5′-TTTTGAATGTGGGTAGCTTT-3′ | (SEQ ID NO:48) |
| T4-9 | |
| 5′-GATCCCCCGTGAGAATTTTACGGGTCTACACCTACGTGTGTTTTCATTTCG | (SEQ ID NO:49) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6F, Tile 5 | |
| T5-1A | |
| 5′-CTCGCATGCTACCCTGTAGACATCTCCTGCTCGACACGCAACT-3′ | (SEQ ID NO:50) |
| T5-1B | |
| 5′-GGAGATTTCCGTTTCTCACGGGACGCCTCGTCGGCA-3′ | (SEQ ID NO:51) |
| T5-2 | |
| 5′-GAGGCGTGGTGCTC-3′ | (SEQ ID NO:52) |
| T5-3 | |
| 5′-CTGGGTTGAGCACCGGATCTAAGTCGTTCCGACGGACGAACCGCCACT | (SEQ ID NO:53) |
| T-3′ | |
| T5-4 | |
| 5′-GGTTCGTGGGCATC-3′ | (SEQ ID NO:54) |
| T5-5 | |
| 5′-ACTATTGGATGCCCTGACCGAGTCCCCATAGATGGACAAGCCACCTAG | (SEQ ID NO:55) |
| A-3′ | |
| T5-6 | |
| 5′-GGCTTGTGGCACTT-3′ | (SEQ ID NO:56) |
| T5-7 | |
| 5′-TTGTGACAAGTGCCAGGTCGAAATGCACACGTAGGACATTCAACATGG | SEQ ID NO:57) |
| T-3′ | |
| T5-8 | |
| 5′-TGAATGTGGGTAGC-3′ | (SEQ ID NO:58) |
| T5-9 | |
| 5′-GATCCCCCGTGAGAATTTTACGGGTCTACACCTACGTGTGTTTTCATTTCG | (SEQ ID NO:59) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6G, Tile 6 | |
| T6-1A | |
| 5′-GCTACCCTGTAGACATCTCCACCCCCGGCTGCAACA-3′ | (SEQ ID NO:60) |
| T6-1B | |
| 5′-GGAGATTTCCGTTTCTCACGGGACGCCTC-3′ | (SEQ ID NO:61) |
| T6-2 | |
| 5′-ATCTGGCGAGGCGTGGTGCTCATCAGCG-3′ | (SEQ ID NO:62) |
| T6-3 | |
| 5′-GAGCACCGGATCTAAGTCGTTCCGACGGACGAACC-3′ | (SEQ ID NO:63) |
| T6-4 | |
| 5′-TTTGGTTCGTGGGCATCTTT-3′ | (SEQ ID NO:64) |
| T6-5 | |
| 5′-GATGCCCTGACCGAGTCCCCATAGATGGACAAGCC-3′ | (SEQ ID NO:65) |
| T6-6 | |
| 5′-GGCGATCGGCTTGTGGCACTTTCCGATA-3′ | (SEQ ID NO:66) |
| T6-7 | |
| 5′-AAGTGCCAGGTCGAAATGCACACGTAGGACATTCA-3′ | (SEQ ID NO:67) |
| T6-8 | |
| 5′-CAATAGTTGAATGTGGGTAGCAAGTGGC-3′ | (SEQ ID NO:68) |
| T6-9 | |
| 5′-GATCCCCCGTGAGAATTTTACGGGTCTACACCTACGTGTGTTTTCATTTCG | (SEQ ID NO:69) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6H, Tile 7 | |
| T7-1A | |
| 5′-GCTACCCTGTAGACATCTCCAATAGCTTGAGTTGCG-3′ | (SEQ ID NO:70) |
| T7-1B | |
| 5′-GGAGATTTCCGTTTCTCACGGGACGCCTCTACAGAC-3′ | (SEQ ID NO:71) |
| T7-2 | |
| 5′-GAGGCGTGGTGCTC-3′ | (SEQ ID NO:72) |
| T7-3 | |
| 5′-GATCCTAGAGCACCGGATCTAAGTCGTTCCGACGGACGAACCGCCTAA | (SEQ ID NO:73) |
| T-3′ | |
| T7-4 | |
| 5′-GGTTCGTGGGCATC-3′ | (SEQ ID NO:74) |
| T7-5 | |
| 5′-TACGGAGGATGCCCTGACCGAGTCCCCATAGATGGACAAGCC-3′ | (SEQ ID NO:75) |
| T7-6 | |
| 5′-TTTGGCTTGTGGCACTTTTT-3′ | (SEQ ID NO:76) |
| T7-7 | |
| 5′-AAGTGCCAGGTCGAAATGCACACGTAGGACATTCA-3′ | (SEQ ID NO:77) |
| T7-8 | |
| 5′-TTTTGAATGTGGGTAGCTTT-3′ | (SEQ ID NO:78) |
| T7-9 | |
| 5′-GATCCCCCGTGAGAATTTTACGGGTCTACACCTACGTGTGTTTTCATTTCG | (SEQ ID NO:79) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6I, Tile 8 | |
| T8-1A | |
| 5′-GCTACCCTGTAGACATCTCCAGGTTGCTTATCATCC-3′ | (SEQ ID NO:80) |
| T8-1B | |
| 5′-GGAGATTTCCGTTTCTCACGGGACGCCTC-3′ | (SEQ ID NO:81) |
| T8-2 | |
| 5′-GTCACAAGAGGCGTGGTGCTCTCTAGGT-3′ | (SEQ ID NO:82) |
| T8-3 | |
| 5′-GAGCACCGGATCTAAGTCGTTCCGACGGACGAACC-3′ | (SEQ ID NO:83) |
| T8-4 | |
| 5′-TTATGTGGGTTCGTGGGCATCAATCCCT-3′ | (SEQ ID NO:84) |
| T8-5 | |
| 5′-GATGCCCTGACCGAGTCCCCATAGATGGACAAGCC-3′ | (SEQ ID NO:85) |
| T8-6 | |
| 5′-TTTGGCTTGTGGCACTTTTT-3′ | (SEQ ID NO:86) |
| T8-7 | |
| 5′-AAGTGCCAGGTCGAAATGCACACGTAGGACATTCA-3′ | (SEQ ID NO:87) |
| T8-8 | |
| 5′-CTCCGTATGAATGTGGGTAGCATTAGGC-3′ | (SEQ ID NO:88) |
| T8-9 | |
| 5′-GATCCCCCGTGAGAATTTTACGGGTCTACACCTACGTGTGTTTTCATTTCG | (SEQ ID NO:89) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 6d, Tile 9 | |
| T9-1A | |
| 5′-CACATAAGCTACCCTGTAGACATCTCCGCGAATGGTTGGTCAG-3′ | (SEQ ID NO:90) |
| T9-1B | |
| 5′-GGAGATTTCCGTTTCTCACGGGACGCCTCTATCGGA-3′ | (SEQ ID NO:91) |
| T9-2 | |
| 5′-GAGGCGTGGTGCTC-3′ | (SEQ ID NO:92) |
| T9-3 | |
| 5′-GATCGCCGAGCACCGGATCTAAGTCGTTCCGACGGACGAACC-3′ | (SEQ ID NO:93) |
| T9-4 | |
| 5′-TTTGGTTCGTGGGCATCTTT-3′ | (SEQ ID NO:94) |
| T9-5 | |
| 5′-GATGCCCTGACCGAGTCCCCATAGATGGACAAGCC-3′ | (SEQ ID NO:95) |
| T9-6 | |
| 5′-TTTGGCTTGTGGCACTTTTT-3′ | (SEQ ID NO:96) |
| T9-7 | |
| 5′-AAGTGCCAGGTCGAAATGCACACGTAGGACATTCAAGGGATT-3′ | (SEQ ID NO:97) |
| T9-8 | |
| 5′-TGAATGTGGGTAGC-3′ | (SEQ ID NO:95) |
| T9-9 | |
| 5′-GATCCCCCGTGAGAATTTTACGGGTCTACACCTACGTGTGTTTTCATTTCG | (SEQ ID NO:99) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 14a, Tile A | |
| 5 × 5-A1 | |
| 5′-TTTTGCTACCCTGTAGACCCGTTTCTCACGGGACGCCTCTTTT-3′ | (SEQ ID NO:100) |
| 5 × 5-A2 | |
| 5′-TTTTGAGCACCGGATCTAAGTCGTTCCGACGGACGAACCGCTGTTC-3′ | (SEQ ID NO:101) |
| 5 × 5-A3 | |
| 5′-GCACCATGATGCCCTGACCGAGTCCCCATAGATGGACAAGCCGCTTCA | (SEQ ID NO:102) |
| C-3 | |
| 5 × 5-A4 | |
| 5′-AGACTGCAAGTGCCTGGTCGAAATGCACACGTAGGACATTCATTTT-3′ | (SEQ ID NO:103) |
| 5 × 5-A5 | |
| 5′-GAGGCGTGGTGCTC-3′ | (SEQ ID NO:104) |
| 5 × 5-A6 | |
| 5′-GGTTCGTGGGCATC-3′ | (SEQ ID NO:105) |
| 5 × 5-A7 | |
| 5′-GGCTTGTGGCACTT-3′ | (SEQ ID NO:106) |
| 5 × 5-A8 | |
| 5′-TGAATGTGGGTAGC-3′ | (SEQ ID NO:107) |
| 5 × 5-A9 | |
| 5′-GATCCCCCGTGAGAATTTTACGGGTCTACACCTACGTGTGTTTTCATTTCG | (SEQ ID NO:108) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 14b, Tile B | |
| 5 × 5-B1 | |
| 5′-GCTACCCTGTAGACCCGTTTCTCACGGGACGCCTC-3′ | (SEQ ID NO:109) |
| 5 × 5-B2 | |
| 5′-GAGCACCGGATCTAAGTCGTTCCGACGGACGAACC-3′ | (SEQ ID NO:110) |
| 5 × 5-B3 | |
| 5′-GATGCCCTGACCGAGTCCCCATAGATGGACAAGCC-3′ | (SEQ ID NO:111) |
| 5 × 5-B4 | |
| 5′-AAGTGCCTGGTCGAAATGCACACGTAGGACATTCA-3′ | (SEQ ID NO:112) |
| 5 × 5-B5 | |
| 5′-TTTTGAGGCGTGGTGCTCTTTT-3′ | (SEQ ID NO:113) |
| 5 × 5-B6 | |
| 5′-GACGCAAGGTTCGTGGGCATCTCTGAGC-3′ | (SEQ ID NO:114) |
| 5 × 5-B7 | |
| 5′-AACCCAGGGCTTGTGGCACTTTGCCGAC-3′ | (SEQ ID NO:115) |
| 5 × 5-B8 | |
| 5′-ATCGTGCTGAATGTGGGTAGCGAACAGC-3′ | (SEQ ID NO:116) |
| 5 × 5-B9 | |
| 5′-GATCCCCCGTGAGAATTTTACGGGTCTACACCTACGTGTGTTTTCATTTCG | (SEQ ID NO:117) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 14c, Tile C | |
| 5 × 5-C1 | |
| 5′-TTGCGTCGCTACCCTGTAGACCCGTTTCTCACGGGACGCCTCTTTT-3′ | (SEQ ID NO:118) |
| 5 × 5-C2 | |
| 5′-TTTTGAGCACCGCATCTAAGTCGTTCCGACGGACGAACCCTCGCAT-3′ | (SEQ ID NO:119) |
| 5 × 5-C3 | |
| 5′-ACATGGTGATGCCCTGACCGAGTCCCCATAGATGCACAAGCCGATCCT | (SEQ ID NO:120) |
| A-3′ | |
| 5 × 5-C4 | |
| 5′-TACAGACAAGTGCCTGGTCGAAATGCACACGTAGGACATTCAGCTCAG | (SEQ ID NO:121) |
| A-3′ | |
| 5 × 5-C5 | |
| 5′-GAGGCGTGGTGCTC-3′ | (SEQ ID NO:122) |
| 5 × 5-C6 | |
| 5′-GGTTCGTGGGCATC-3′ | (SEQ ID NO:123) |
| 5 × 5-C7 | |
| 5′-GGCTTGTGGCACTT-3′ | (SEQ ID NO:124) |
| 5 × 5-C8 | |
| 5′-TGAATGTGGGTAGC-3′ | (SEQ ID NO:125) |
| 5 × 5-C9 | |
| 5′-GATCCCCCGTGAGAATTTTACGGGTCTACACCTACGTGTGTTTTCATTTCG | (SEQ ID NO:126) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 14d, Tile D | |
| 5 × 5-D1 | |
| 5′-GCTACCCTGTAGACCCGTTTCTCACGGGACGCCTC-3′ | (SEQ ID NO:127) |
| 5 × 5-D2 | |
| 5′-GAGCACCGGATCTAAGTCGTTCCGACGGACGAACC-3′ | (SEQ ID NO:128) |
| 5 × 5-D3 | |
| 5′-GATGCCCTGACCGAGTCCCCATAGATGGACAAGCC-3′ | (SEQ ID NO:129) |
| 5 × 5-D4 | |
| 5′-AAGTGCCTGGTCGAAATGCACACGTAGGACATTCA-3′ | (SEQ ID NO:130) |
| 5 × 5-D5 | |
| 5′-TTTTGAGGCGTGGTGCTCTTTT-3′ | (SEQ ID NO:131) |
| 5 × 5-D6 | |
| 5′-GCAGTCTGGTTCGTGGGCATCGTGAAGC-3′ | (SEQ ID NO:132) |
| 5 × 5-D7 | |
| 5′-ATCAGCGGGCTTGTGGCACTTATCTGGC-3′ | (SEQ ID NO:133) |
| 5 × 5-D8 | |
| 5′-ACCATGTTGAATGTGGGTAGCATGCGAG-3′ | (SEQ ID NO:134) |
| 5 × 5-D9 | |
| 5′-GATCCCCCGTGAGAATTTTACGGGTCTACACCTACGTGTGTTTTCATTTCG | (SEQ ID NO:135) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 14e, Tile E | |
| 5 × 5-E1 | |
| 5′-CGCTGATGCTACCCTGTAGACCCGTTTCTCACGGGACGCCTCGTCGGC | (SEQ ID NO:136) |
| A-3′ | |
| 5 × 5-E2 | |
| 5′-CTGGGTTGAGCACCGGATCTAAGTCGTTCCGACGGACGAACCGCCTAA | (SEQ ID NO:137) |
| T-3′ | |
| 5 × 5-E3 | |
| 5′-TACGGAGGATGCCCTGACCGAGTCCCCATAGATGGACAAGCCAGGGAT | (SEQ ID NO:138) |
| T-3′ | |
| 5 × 5-E4 | |
| 5′-CACATAAAAGTGCCTGGTCGAAATGCACACGTAGGACATTCAGCCAGA | (SEQ ID NO:139) |
| T-3′ | |
| 5 × 5-E5 | |
| 5′-GAGGCGTGGTGCTC-3′ | (SEQ ID NO:140) |
| 5 × 5-E6 | |
| 5′-GGTTCGTGGGCATC-3′ | (SEQ ID NO:141) |
| 5 × 5-E7 | |
| 5′-GGCTTGTCGCACTT-3′ | (SEQ ID NO:142) |
| 5 × 5-E8 | |
| 5′-TGAATGTGGGTAGC-3′ | (SEQ ID NO:143) |
| 5 × 5-E9 | |
| 5′-GATCCCCCGTGAGAATTTTACGGGTCTACACCTACGTGTGTTTTCATTTCG | (SEQ ID NO:144) |
| ACCACCATCTATGGTTTTGGACTCGGTCACCGTCCGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 14f, Tile F | |
| 5 × 5-F1 | |
| 5′-GCTACCCTGTAGACCCGTTTCTCACGGGACGCCTC-3′ | (SEQ ID NO:145) |
| 5 × 5-F2 | |
| 5′-GAGCACCGGATCTAAGTCGTTCCGACGGACGAACC-3′ | (SEQ ID NO:146) |
| 5 × 5-F3 | |
| 5′-GATGCCCTGACCGAGTCCCCATAGATGGACAAGCC-3′ | (SEQ ID NO:147) |
| 5 × 5-F4 | |
| 5′-AAGTGCCTGGTCGAAATGCACACGTAGGACATTCA-3′ | (SEQ ID NO:148) |
| 5 × 5-F5 | |
| 5′-GTCTGTAGAGGCGTGGTGCTCTAGGATC-3′ | (SEQ ID NO:149) |
| 5 × 5-F6 | |
| 5′-TTATGTGGGTTCGTGGGCATCAATCCCT-3′ | (SEQ ID NO:150) |
| 5 × 5-F7 | |
| 5′-CAATAGTGGCTTGTGGCACTTAAGTGGC-3′ | (SEQ ID NO:151) |
| 5 × 5-F8 | |
| 5′-CTCCGTATGAATGTGGGTAGC2ATTAGGC-3′ | (SEQ ID NO:152) |
| 5 × 5-F9 | |
| 5′-GATCCCCCGTGAGAATTTTACGGGTCTACACCTACGTGTGTTTTCATTTCG | (SEQ ID NO:153) |
| ACCACCATCTATGGTTTTGGACTCGGTCACCGTCGGAACTTTTGACTTA-3′ | |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪

| | |
|---|---|
| FIG. 14g, Tile G | |
| 5 × 5-G1 | |
| 5′-ACTATTGGCTACCCTGTAGACCCGTTTCTCACGGGACGCCTCGCCACT | (SEQ ID NO:154) |
| T-3′ | |
| 5 × 5-G2 | |
| 5′-ACTATTGGAGCACCGGATCTAAGTCGTTCCGACGGACGAACCGCCACT | (SEQ ID NO:155) |
| T-3′ | |
| 5 × 5-G3 | |
| 5′-ACTATTGGATGCCCTGACCGAGTCCCCATAGATGGACAAGCCGCCACT | (SEQ ID NO:156) |
| T-3′ | |
| 5 × 5-G4 | |
| 5′-ACTATTGAAGTGCCTGGTCGAAATGCACACGTAGGACATTCAGCCACT | (SEQ ID NO:157) |
| T-3′ | |
| 5 × 5-G5 | |
| 5′-GAGGCGTGGTGCTC-3′ | (SEQ ID NO:158) |
| 5 × 5-G6 | |
| 5′-GGTTCGTGGGCATC-3′ | (SEQ ID NO:159) |
| 5 × 5-G7 | |
| 5′-GGCTTGTGGCACTT-3′ | (SEQ ID NO:160) |
| 5 × 5-G8 | |
| 5′-TGAATGTGGGTAGC-3′ | (SEQ ID NO:161) |
| 5 × 5-G9 | |
| 5′-GATCCCCCGTGAGAATTTTACGGGTCTACACCTACGTGTGTTTTCATTTCG | (SEQ ID NO:162) |
| ACCACCATCTATGGTTTTGGACTCGGTCACCGTCGGAACTTTTGACTTA-3′ | |

FIG. 13a, 8 helix structure used in the fixed size array, Tile A:

| | |
|---|---|
| 5′-AGGGATTATAAGAATGGAAGCCCTGGGTCGTTCCGTAGGATTCCTGAAGTC | (SEQ ID NO:163) |
| GCTTATGTG | |
| 5′-AGGGATTTGGAGGCGGACATTCCGTCGGTTTGGCGGGACGTTTCCTCTTCC | (SEQ ID NO:164) |
| TTTTATGTG | |
| 5′-AAGGAAGAGGAAACGTGGAGACACCAGCGTGGTATCACCCTTGTGGCAGCA | (SEQ ID NO:165) |
| CCTTAGTGGGCTTCCATTCTTAT | |
| 5′-GGTTAGGTAAGGACCGAGGACTATCCGATTCGGACTAAGGACGGCTCACTA | (SEQ ID NO:166) |
| CC | |
| 5′-GGCTTCGATGCCCTGCTGCCTGGCTCCGGTCCCCTGACTCCTGAGTCCCTT | (SEQ ID NO:167) |
| TC | |
| 5′-GATGAGGAACGGACTATGGACGCTCCGAGTAGGACAAGGGACGACTCGTTT | (SEQ ID NO:168) |
| CC | |
| 5′-GAGTAGGGCGGCCTGATACCTGAGTCCAAGGTCCTGCAACCTGGGGCCCTC | (SEQ ID NO:169) |
| TT | |
| 5′-TACTGGGCTAGGACATGGGACAACACGGTGCGGACGCTGGACAGACCAAGC | (SEQ ID NO:170) |
| TC | |
| 5′-GAACAGAGTTCCCTGTCTCCTGTATTCGAGATCCTGGTTCCTGGCTCCTTC | (SEQ ID NO:171) |
| TG | |
| 5′-GGAGCGTGGACCTTGGACTCACCGCACCGTGTTGTGGATCTCGAATACACC | (SEQ ID NO:172) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:173) |
| 5′-GGAAACGAGTCGTGGCCGCCCTACTC | (SEQ ID NO:174) |
| 5′-GAGCTTGGTCTGTGGGAACTCTGTTC | (SEQ ID NO:175) |
| 5′-GCGACTTCACCTTACCTAACC | (SEQ ID NO:176) |
| 5′-GAAAGGGACTCACCGTTCCTCATC | (SEQ ID NO:177) |
| 5′-AAGAGGGCCCCACCTAGCCCAGTA | (SEQ ID NO:178) |
| 5′-CAGAAGGAGCCACCGCCTCCA | (SEQ ID NO:179) |
| ************** | |

FIG. 13a, 8 helix structure used in the fixed size array, Tile B:

| | |
|---|---|
| 5′-ACCTAGAATAAGAATGGAAGCCCTGGGTCGTTCCGTAGGATTCCTGAAGTC | (SEQ ID NO:180) |
| GCCTCCGTA | |
| 5′-GATCGCCTGGAGGCGGACATTCCGTCGGTTTGGCGGGACGTTTCCTCTTCC | (SEQ ID NO:181) |
| TTGTCACAA | |
| 5′-AAGGAAGAGGAAACGTGGAGACACCAGCGTGGTATCACCCTTGTGGCAGCA | (SEQ ID NO:182) |
| CCTTAGTGGGCTTCCATTCTTAT | |
| 5′-GGTTAGGTAAGGACCGAGGACTATCCGATTCGGACTAAGGACGGCTCACTA | (SEQ ID NO:183) |
| CC | |
| 5′-GGCTTCGATGCCCTGCTGCCTGGCTCCGGTCCCCTGACTCCTGAGTCCCTT | (SEQ ID NO:184) |
| TC | |
| 5′-GATGAGGAACGGACTATGGACGCTCCGAGTAGGACAAGGGACGACTCGTTT | (SEQ ID NO:185) |
| CC | |
| 5′-GAGTAGGGCGGCCTGATACCTGAGTCCAAGGTCCTGCAACCTGGGGCCCTC | (SEQ ID NO:186) |
| TT | |
| 5′-TACTGGGCTAGGACATGGGACAACACGGTGCGGACGCTGGACAGACCAAGC | (SEQ ID NO:187) |
| TC | |
| 5′-GAACAGAGTTCCCTGTCTCCTGTATTCGAGATCCTGGTTCCTGGCTCCTTC | (SEQ ID NO:188) |
| TG | |
| 5′-GGAGCGTGGACCTTGGACTCACCGCACCGTGTTGTGGATCTCGAATACACC | (SEQ ID NO:189) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:190) |
| 5′-GGAAACGAGTCGTGGCCGCCCTACTC | (SEQ ID NO:191) |
| 5′-GAGCTTGGTCTGTGGGAACTCTGTTC | (SEQ ID NO:192) |
| 5′-GCGACTTCACCTTACCTAACC | (SEQ ID NO:193) |
| 5′-GAAAGGGACTCACCGTTCCTCATC | (SEQ ID NO:194) |
| 5′-AAGAGGGCCCCACCTAGCCCAGTA | (SEQ ID NO:195) |
| 5′-CAGAAGGAGCCACCGCCTCCA | (SEQ ID NO:196) |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪
FIG. 13b, 8 helix structure used in the fixed size array, Tile C:

| | |
|---|---|
| 5′-TATCGGAATAAGAATGGAAGCCCTGGGTCGTTCCGTAGGATTCCTGAACTC | (SEQ ID NO:197) |
| GCATTAGGC | |
| 5′-AATCCCTTGGAGGCGGACATTCCGTCGGTTTGGCGGGACGTTTCCTCTTCC | (SEQ ID NO:198) |
| TTTACGGAG | |
| 5′-AAGGAAGAGGAAACGTGGAGACACCAGCGTGGTATCACCCTTGTGGCACCA | (SEQ ID NO:199) |
| CCTTAGTGGGCTTCCATTCTTAT | |
| 5′-GGTTAGGTAAGGACCGAGGACTATCCGATTCGGACTAACGACGCCTCACTA | (SEQ ID NO:200) |
| CC | |
| 5′-GGCTTCGATCCCCTGCTGCCTGGCTCCGGTCCCCTGACTCCTGAGTCCCTT | (SEQ ID NO:201) |
| TC | |
| 5′-GATGAGGAACGGACTATGGACGCTCCGAGTAGGACAAGGGACGACTCGTTT | (SEQ ID NO:202) |
| CC | |
| 5′-GAGTAGGGCGGCCTGATACCTGAGTCCAAGGTCCTGCAACCTGGGGCCCTC | (SEQ ID NO:203) |
| TT | |
| 5′-TACTGGGCTAGGACATGGGACAACACGGTGCGGACGCTGGACAGACCAAGC | (SEQ ID NO:204) |
| TC | |
| 5′-GAACAGAGTTCCCTGTCTCCTGTATTCGAGATCCTGGTTCCTGGCTCCTTC | (SEQ ID NO:205) |
| TG | |
| 5′-GGAGCGTGGACCTTGGACTCACCGCACCGTGTTGTGGATCTCGAATACACC | (SEQ ID NO:206) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:207) |
| 5′-GGAAACGAGTCGTGGCCGCCCTACTC | (SEQ ID NO:208) |
| 5′-GAGCTTGGTCTGTGGGAACTCTGTTC | (SEQ ID NO:209) |
| 5′-GCGACTTCACCTTACCTAACC | (SEQ ID NO:210) |
| 5′-GAAAGGGACTCACCGTTCCTCATC | (SEQ ID NO:211) |
| 5′-AAGAGGGCCCCACCTAGCCCAGTA | (SEQ ID NO:212) |
| 5′-CAGAAGGAGCCACCGCCTCCA | (SEQ ID NO:213) |
| ************ | |

FIG. 13b, 8 helix structure used in the fixed size array, Tile D:

| | |
|---|---|
| 5′-ACTATTGATAAGAATGGAAGCCCTGGGTCGTTCCGTAGGATTCCTGAAGTC | (SEQ ID NO:214) |
| GCGATCCTA | |
| 5′-GTCTGTATGGAGGCGGACATTCCGTCGGTTTGGCGGGACGTTTCCTCTTCC | (SEQ ID NO:215) |
| TTGCCTAAT | |
| 5′-AAGGAAGAGGAAACGTGGAGACACCAGCGTGGTATCACCCTTGTGGCAGCA | (SEQ ID NO:216) |
| CCTTAGTGGGCTTCCATTCTTAT | |
| 5′-GGTTAGGTAAGGACCGAGGACTATCCGATTCGGACTAAGGACGGCTCACTA | (SEQ ID NO:217) |
| CC | |
| 5′-GGCTTCGATGCCCTGCTGCCTGGCTCCGGTCCCCTGACTCCTGAGTCCCTT | (SEQ ID NO:218) |
| TC | |
| 5′-GATGAGGAACGGACTATGGACGCTCCGAGTAGGACAAGGGACGACTCGTTT | (SEQ ID NO:219) |
| CC | |
| 5′-GAGTAGGGCGGCCTGATACCTGAGTCCAAGGTCCTGCAACCTGGGGCCCTC | (SEQ ID NO:220) |
| TT | |
| 5′-TACTGGGCTAGGACATGGGACAACACGGTGCGGACGCTGGACAGACCAAGC | (SEQ ID NO:221) |
| TC | |
| 5′-GAACAGAGTTCCCTGTCTCCTGTATTCGAGATCCTGGTTCCTGGCTCCTTC | (SEQ ID NO:222) |
| TG | |
| 5′-GGAGCGTGGACCTTGGACTCACCGCACCGTGTTGTGGATCTCGAATACACC | (SEQ ID NO:223) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:224) |
| 5′-GGAAACGAGTCGTGGCCGCCCTACTC | (SEQ ID NO:225) |
| 5′-GAGCTTGGTCTGTGGGAACTCTGTTC | (SEQ ID NO:226) |
| 5′-GCGACTTCACCTTACCTAACC | (SEQ ID NO:227) |
| 5′-GAAAGGGACTCACCGTTCCTCATC | (SEQ ID NO:228) |
| 5′-AAGAGGGCCCCACCTAGCCCAGTA | (SEQ ID NO:229) |
| 5′-CAGAAGGAGCCACCGCCTCCA | (SEQ ID NO:230) |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪
FIG. 13c, 8 helix structure used in thefixed size array, Tile E:

| | |
|---|---|
| 5′-TACAGACATAAGAATGGAAGCCCTGGGTCGTTCCGTAGGATTCCTGAAGTC | (SEQ ID NO:231) |
| GCGCCACTT | |
| 5′-GGCGATCTGGAGGCGGACATTCCGTCGGTTTGGCGGGACGTTTCCTCTTCC | (SEQ ID NO:232) |
| TTCACATT | |
| 5′-AAGCAAGAGGAAACGTGGAGACACCAGCGTGGTATCACCCTTGTGGCAGCA | (SEQ ID NO:233) |
| CCTTAGTGGGCTTCCATTCTTAT | |
| 5′-GGTTAGGTAAGGACCGAGGACTATCCGATTCGGACTAAGGACGGCTCACTA | (SEQ ID NO:234) |
| CC | |
| 5′-GGCTTCGATGCCCTGCTGCCTGGCTCCGGTCCCCTGACTCCTGAGTCCCTT | (SEQ ID NO:235) |
| TC | |
| 5′-GATGAGGAACGGACTATGGACGCTCCGAGTAGGACAAGGGACGACTCGTTT | (SEQ ID NO:236) |
| CC | |
| 5′-GAGTAGGGCGGCCTGATACCTGAGTCCAAGGTCCTGCAACCTGGGGCCCTC | (SEQ ID NO:237) |
| TT | |
| 5′-TACTGGGCTAGGACATGGGACAACACGGTGCGGACGCTGGACAGACCAAGC | (SEQ ID NO:238) |
| TC | |
| 5′-GAACAGAGTTCCCTGTCTCCTGTATTCGAGATCCTGGTTCCTGGCTCCTTC | (SEQ ID NO:239) |
| TG | |
| 5′-GGAGCGTGGACCTTGGACTCACCGCACCGTGTTGTGGATCTCGAATACACC | (SEQ ID NO:240) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:241) |
| 5′-GGAAACGAGTCGTGGCCGCCCTACTC | (SEQ ID NO:242) |
| 5′-GAGCTTGGTCTGTGGGAACTCTGTTC | (SEQ ID NO:243) |
| 5′-GCGACTTCACCTTACCTAACC | (SEQ ID NO:244) |
| 5′-GAAAGGGACTCACCGTTCCTCATC | (SEQ ID NO:245) |
| 5′-AAGAGGGCCCCACCTAGCCCAGTA | (SEQ ID NO:246) |
| 5′-CAGAAGGAGCCACCGCCTCCA | (SEQ ID NO:247) |

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪
FIG. 13c, 8 helix structure used in the fixedlsize array, Tile F:

| | |
|---|---|
| 5′-TTTTATAAGAATGGAAGCCCTGGGTCGTTCCGTAGGATTCCTGAAGTCGCT | (SEQ ID NO:248) |
| GTACCA | |
| 5′-AGACTGCTGGAGGCGGACATTCCGTCGGTTTGGCGGGACGTTTCCTCTTCC | (SEQ ID NO:249) |
| TTTTTT | |
| 5′-AAGGAAGAGGAAACGTGGAGACACCAGCGTGGTATCACCCTTGTGGCAGCA | (SEQ ID NO:250) |
| CCTTACTGGGCTTCCATTCTTAT | |
| 5′-GGTTAGGTAAGGACCGAGGACTATCCGATTCGGACTAAGGACGGCTCACTA | (SEQ ID NO:251) |
| CC | |
| 5′-GGCTTCGATGCCCTGCTGCCTGGCTCCGGTCCCCTGACTCCTGAGTCCCTT | (SEQ ID NO:252) |
| TC | |
| 5′-GATGAGGAACGGACTATGGACGCTCCGAGTAGGACAAGGGACGACTCGTTT | (SEQ ID NO:253) |
| CC | |
| 5′-GAGTAGGGCGGCCTGATACCTGAGTCCAAGGTCCTGCAACCTGGGGCCCTC | (SEQ ID NO:254) |
| TT | |
| 5′-TACTGGGCTAGGACATGGGACAACACGGTGCGGACGCTGGACAGACCAAGC | (SEQ ID NO:255) |
| TC | |
| 5′-GAACAGAGTTCCCTGTCTCCTGTATTCGAGATCCTGGTTCCTGGCTCCTTC | (SEQ ID NO:256) |
| TG | |
| 5′-GGAGCGTGGACCTTGGACTCACCGCACCGTGTTGTGGATCTCGAATACACC | (SEQ ID NO:257) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:258) |
| 5′-GGAAACGAGTCGTGGCCGCCCTACTC | (SEQ ID NO:259) |
| 5′-GAGCTTGGTCTGTGGGAACTCTGTTC | (SEQ ID NO:260) |
| 5′-GCGACTTCACCTTACCTAACC | (SEQ ID NO:261) |
| 5′-GAAAGGGACTCACCGTTCCTCATC | (SEQ ID NO:262) |
| 5′-AAGAGGGCCCCACCTAGCCCAGTA | (SEQ ID NO:263) |
| 5′-CAGAAGGAGCCACCGCCTCCA | (SEQ ID NO:264) |
| ************ | |

FIG. 13d, 8 helix structure used in the fixed size array, Tile G:

| | |
|---|---|
| 5′-TTTTATAAGAATGGAAGCCCTGGGTCGTTCCGTAGGATTCCTGAAGTCGCG | (SEQ ID NO:265) |
| AGCGTA | |
| 5′-TCTAGGTTGGAGGCGGACATTCCGTCGGTTTGGCGGGACGTTTCCTCTTCC | (SEQ ID NO:266) |
| TTTGGTACA | |
| 5′-AAGGAAGAGGAAACGTGGAGACACCAGCGTGGTATCACCCTTGTGGCAGCA | (SEQ ID NO:267) |
| CCTTAGTGGGCTTCCATTCTTAT | |
| 5′-GGTTAGGTAAGGACCGAGGACTATCCGATTCGGACTAAGGACGGCTCACTA | (SEQ ID NO:268) |
| CC | |
| 5′-GGCTTCGATGCCCTGCTGCCTGGCTCCGGTCCCCTGACTCCTGAGTCCCTT | (SEQ ID NO:269) |
| TC | |
| 5′-GATGAGGAACGGACTATGGACGCTCCGAGTAGGACAAGGGACGACTCGTTT | (SEQ ID NO:270) |
| CC | |
| 5′-GAGTAGGGCGGCCTGATACCTGAGTCCAAGGTCCTGCAACCTGGGGCCCTC | (SEQ ID NO:271) |
| TT | |
| 5′-TACTGGGCTAGGACATGGGACAACACGGTGCGGACGCTGGACAGACCAAGC | (SEQ ID NO:272) |
| TC | |
| 5′-GAACAGAGTTCCCTGTCTCCTGTATTCGAGATCCTGGTTCCTGGCTCCTTC | (SEQ ID NO:273) |
| TG | |
| 5′-GGAGCGTGGACCTTGGACTCACCGCACCGTGTTGTGGATCTCGAATACACC | (SEQ ID NO:274) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:275) |
| 5′-GGAAACGAGTCGTGGCCGCCCTACTC | (SEQ ID NO:276) |
| 5′-GAGCTTGGTCTGTGGGAACTCTGTTC | (SEQ ID NO:277) |
| 5′-GCGACTTCACCTTACCTAACC | (SEQ ID NO:278) |
| 5′-GAAAGGGACTCACCGTTCCTCATC | (SEQ ID NO:279) |
| 5′-AAGAGGGCCCCACCTAGCCCAGTA | (SEQ ID NO:280) |
| 5′-CAGAAGGAGCCACCGCCTCCA | (SEQ ID NO:281) |
| *********** | |

FIG. 13d, 8 helix structure used in the fixed size array, Tile H:

| | |
|---|---|
| 5′-TTTTATAAGAATGGAAGCCCTGGGTCGTTCCGTAGGATTCCTGAAGTCGCA | (SEQ ID NO:282) |
| TCAGCG | |
| 5′-TCCGATATGGAGGCGGACATTCCGTCGGTTTGGCGGGACGTTTCCTCTTCC | (SEQ ID NO:283) |
| TTTACGCTC | |
| 5′-AAGGAAGAGGAAACGTGGAGACACCAGCGTGGTATCACCCTTGTGGCAGCA | (SEQ ID NO:284) |
| CCTTAGTGGGCTTCCATTCTTAT | |
| 5′-GGTTAGGTAAGGACCGAGGACTATCCGATTCGGACTAAGGACGGCTCACTA | (SEQ ID NO:285) |
| CC | |
| 5′-GGCTTCGATGCCCTGCTGCCTGGCTCCGGTCCCCTGACTCCTGAGTCCCTT | (SEQ ID NO:286) |
| TC | |
| 5′-GATGAGGAACGGACTATGGACGCTCCGAGTAGGACAAGGGACGACTCCTTT | (SEQ ID NO:287) |
| CC | |
| 5′-GAGTAGGGCGGCCTGATACCTGAGTCCAAGGTCCTGCAACCTGGGGCCCTC | (SEQ ID NO:288) |
| TT | |
| 5′-TACTGGGCTAGGACATGGGACAACACGGTGCGGACGCTGGACAGACCAAGC | (SEQ ID NO:289) |
| TC | |
| 5′-GAACAGAGTTCCCTGTCTCCTGTATTCGAGATCCTGGTTCCTGGCTCCTTC | (SEQ ID NO:290) |
| TG | |
| 5′-GGAGCGTGGACCTTGGACTCACCGCACCGTGTTGTGGATCTCGAATACACC | (SEQ ID NO:291) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:292) |
| 5′-GGAAACGAGTCGTGGCCGCCCTACTC | (SEQ ID NO:293) |
| 5′-GAGCTTGGTCTCTGGGAACTCTGTTC | (SEQ ID NO:294) |
| 5′-GCGACTTCACCTTACCTAACC | (SEQ ID NO:295) |
| 5′-GAAAGGGACTCACCGTTCCTCATC | (SEQ ID NO:296) |
| 5′-AAGAGGGCCCCACCTAGCCCAGTA | (SEQ ID NO:297) |
| 5′-CAGAAGGAGCCACCGCCTCCA | (SEQ ID NO:298) |
| ************* | |

FIG. 13e, 8 helix structure used in the fixed size array. Tile I:

| | |
|---|---|
| 5′-TTTTATAAGAATGGAAGCCCTGGGTCGTTCCGTAGGATTCCTGAAGTCGCA | (SEQ ID NO:299) |
| TCTGGC | |
| 5′-CAATAGTTGGAGGCGGACATTCCGTCGGTTTGGCGGGACGTTTCCTCTTCC | (SEQ ID NO:300) |
| TTCGCTGAT | |
| 5′-AAGGAAGAGGAAACGTGGAGACACCAGCGTGGTATCACCCTTGTGGCAGCA | (SEQ ID NO:301) |
| CCTTAGTGGGCTTCCATTCTTAT | |
| 5′-GGTTAGGTAAGGACCGAGGACTATCCGATTCGGACTAAGGACGGCTCACTA | (SEQ ID NO:302) |
| CC | |
| 5′-GGCTTCGATGCCCTOCTOCCTGGCTCCGGTCCCCTGACTCCTGAGTCCCTT | (SEQ ID NO:303) |
| TC | |
| 5′-GATGAGGAACGGACTATGGACGCTCCGAGTAGGACAAGGGACGACTCGTTT | (SEQ ID NO:304) |
| CC | |
| 5′-GAGTAGGGCGGCCTGATACCTGAGTCCAAGGTCCTGCAACCTGGGGCCCTC | (SEQ ID NO:305) |
| TT | |
| 5′-TACTGGGCTAGGACATGGGACAACACGGTGCGGACGCTGGACAGACCAAGC | (SEQ ID NO:306) |
| TC | |
| 5′-GAACAGAGTTCCCTGTCTCCTGTATTCGAGATCCTGGTTCCTGGCTCCTTC | (SEQ ID NO:307) |
| TG | |
| 5′-GGAGCGTGGACCTTGGACTCACCGCACCGTGTTGTGGATCTCGAATACACC | (SEQ ID NO:308) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:309) |
| 5′-GGAAACGAGTCGTGGCCGCCCTACTC | (SEQ ID NO:310) |
| 5′-GAGCTTGGTCTGTGGGAACTCTGTTC | (SEQ ID NO:311) |
| 5′-GCGACTTCACCTTACCTAACC | (SEQ ID NO:312) |
| 5′-GAAAGGGACTCACCGTTCCTCATC | (SEQ ID NO:313) |
| 5′-AAGACGGCCCCACCTAGCCCAGTA | (SEQ ID NO:314) |
| 5′-CAGAAGGAGCCACCGCCTCCA | (SEQ ID NO:315) |
| *********** | |

FIG. 13e, 8 helix structure used in the fixed size array, Tile J:

| | |
|---|---|
| 5′-TTTTATAAGAATGGAAGCCCTGGGTCGTTCCGTAGGATTCCTGAAGTCGCT | (SEQ ID NO:316) |
| TTT | |
| 5′-AACCCAGTGGAGGCGGACATTCCGTCGGTTTGGCGGGACGTTTCCTCTTCC | (SEQ ID NO:317) |
| TTGCCAGAT | |
| 5′-AAGGAAGAGGAAACGTGGAGACACCAGCGTGGTATCACCCTTGTGGCAGCA | (SEQ ID NO:318) |
| CCTTAGTGGGCTTCCATTCTTAT | |
| 5′-GGTTAGGTAAGGACCGAGGACTATCCGATTCGGACTAAGGACGGCTCACTA | (SEQ ID NO:319) |
| CC | |
| 5′-GGCTTCGATGCCCTGCTGCCTGGCTCCGGTCCCCTGACTCCTGAGTCCCTT | (SEQ ID NO:320) |
| TC | |
| 5′-GATGAGGAACGGACTATGGACGCTCCGAGTAGGACAAGGGACGACTCGTTT | (SEQ ID NO:321) |
| CC | |
| 5′-GAGTAGGGCGGCCTGATACCTGAGTCCAAGGTCCTGCAACCTGGGGCCCTC | (SEQ ID NO:322) |
| TT | |
| 5′-TACTGGGCTAGGACATGGGACAACACGGTGCGGACGCTGGACAGACCAAGC | (SEQ ID NO:323) |
| TC | |
| 5′-GAACAGAGTTCCCTGTCTCCTGTATTCGAGATCCTGGTTCCTGGCTCCTTC | (SEQ ID NO:324) |
| TG | |
| 5′-GGAGCGTGGACCTTGGACTCACCGCACCGTGTTGTGGATCTCGAATACACC | (SEQ ID NO:325) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTCAGCCGTGGGCATCGAAGCC | (SEQ ID NO:326) |
| 5′-GGAAACGAGTCGTGGCCGCCCTACTC | (SEQ ID NO:327) |
| 5′-GAGCTTGGTCTGTGGGAACTCTGTTC | (SEQ ID NO:328) |
| 5′-GCGACTTCACCTTACCTAACC | (SEQ ID NO:329) |
| 5′-GAAAGGGACTCACCGTTCCTCATC | (SEQ ID NO:330) |
| 5′-AAGAGGGCCCCACCTAGCCCAGTA | (SEQ ID NO:331) |
| 5′-CAGAAGGAGCCACCGCCTCCA | (SEQ ID NO:332) |
| ************** | |

FIG. 13f, 8 helix structure used in the fixed size array, Tile K:

| | |
|---|---|
| 5′-CTGGGTTATAAGAATGGAAGCCCTGGGTCGTTCCGTAGGATTCCTGAAGTC | (SEQ ID NO:333) |
| GCTTTT | |
| 5′-TGCCGACTGGAGGCGGACATTCCGTCGGTTTGGCGGGACGTTTCCTCTTCC | (SEQ ID NO:334) |
| TTTAGGATC | |
| 5′-AAGGAAGAGGAAACGTGGAGACACCAGCGTGGTATCACCCTTGTGGCAGCA | (SEQ ID NO:335) |
| CCTTAGTGGGCTTCCATTCTTAT | |
| 5′-GGTTAGGTAAGGACCGAGGACTATCCGATTCGGACTAAGGACGGCTCACTA | (SEQ ID NO:336) |
| CC | |
| 5′-GGCTTCGATGCCCTGCTGCCTGGCTCCGGTCCCCTGACTCCTGAGTCCCTT | (SEQ ID NO:337) |
| TC | |
| 5′-GATGAGGAACGGACTATGGACGCTCCGAGTAGGACAAGGGACGACTCGTTT | (SEQ ID NO:338) |
| CC | |
| 5′-GAGTAGGGCGGCCTGATACCTGAGTCCAAGGTCCTGCAACCTGGGGCCCTC | (SEQ ID NO:339) |
| TT | |
| 5′-TACTGGGCTAGGACATGGGACAACACGGTGCGGACGCTGGACAGACCAAGC | (SEQ ID NO:340) |
| TC | |
| 5′-GAACAGAGTTCCCTGTCTCCTGTATTCGAGATCCTGGTTCCTGGCTCCTTC | (SEQ ID NO:341) |
| TG | |
| 5′-GGAGCGTGGACCTTGGACTCACCGCACCGTGTTGTGGATCTCGAATACACC | (SEQ ID NO:342) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:343) |
| 5′-GGAAACGAGTCGTGGCCGCCCTACTC | (SEQ ID NO:344) |
| 5′-GAGCTTGGTCTGTGGGAACTCTGTTC | (SEQ ID NO:345) |
| 5′-GCGACTTCACCTTACCTAACC | (SEQ ID NO:346) |
| 5′-GAAAGGGACTCACCGTTCCTCATC | (SEQ ID NO:347) |
| 5′-AAGAGGGCCCCACCTAGCCCAGTA | (SEQ ID NO:348) |
| 5′-CAGAAGGAGCCACCGCCTCCA | (SEQ ID NO:349) |
| ******* | |

FIG. 13f, 8 helix structure used in the fixed size array, Tile L:

| | |
|---|---|
| 5′-GTCGGCAATAAGAATGGAAGCCCTGGGTCGTTCCGTAGGATTCCTGAAGTC | (SEQ ID NO:350) |
| GCTTTT | |
| 5′-GTGAAGCTGGAGGCGGACATTCCGTCGGTTTGGCGGGACGTTTCCTCTTCC | (SEQ ID NO:351) |
| TTAAGTGGC | |
| 5′-AAGGAAGAGGAAACGTGGAGACACCAGCGTGGTATCACCCTTGTGGCAGCA | (SEQ ID NO:352) |
| CCTTAGTGGGCTTCCATTCTTAT | |
| 5′-GGTTAGGTAAGGACCGAGGACTATCCGATTCGGACTAAGGACGGCTCACTA | (SEQ ID NO:353) |
| CC | |
| 5′-GGCTTCGATGCCCTGCTGCCTGGCTCCGGTCCCCTGACTCCTGAGTCCCTT | (SEQ ID NO:354) |
| TC | |
| 5′-GATGAGGAACGGACTATGGACGCTCCGAGTAGGACAAGGGACGACTCGTTT | (SEQ ID NO:355) |
| CC | |
| 5′-GAGTAGGGCGGCCTGATACCTGAGTCCAAGGTCCTGCAACCTGGGGCCCTC | (SEQ ID NO:356) |
| TT | |
| 5′-TACTGGGCTAGGACATGGGACAACACGGTGCGGACGCTGGACAGACCAAGC | (SEQ ID NO:357) |
| TC | |
| 5′-GAACAGAGTTCCCTGTCTCCTGTATTCGAGATCCTGGTTCCTGGCTCCTTC | (SEQ ID NO:358) |
| TG | |
| 5′-GGAGCGTGGACCTTGGACTCACCGCACCGTGTTGTGGATCTCGAATACACC | (SEQ ID NO:359) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:360) |
| 5′-GGAAACGAGTCGTGGCCGCCCTACTC | (SEQ ID NO:361) |
| 5′-GAGCTTGGTCTGTGGGAACTCTGTTC | (SEQ ID NO:362) |
| 5′-GCGACTTCACCTTACCTAACC | (SEQ ID NO:363) |
| 5′-GAAAGGGACTCACCGTTCCTCATC | (SEQ ID NO:364) |
| 5′-AAGAGGGCCCCACCTAGCCCAGTA | (SEQ ID NO:365) |
| 5′-CAGAAGGAGCCACCGCCTCCA | (SEQ ID NO:366) |
| ********** | |

FIG. 13g, 8 helix structure used in the fixed size array, Tile M:

| | |
|---|---|
| 5′-GCTTCACATAAGAATGGAAGCCCTGGGTCGTTCCGTAGGATTCCTGAAGTC | (SEQ ID NO:367) |
| GCTTTT | |
| 5′-GCAGTCTTGGAGGCGGACATTCCGTCGGTTTGGCGGGACGTTTCCTCTTCC | (SEQ ID NO:368) |
| TTTTGTGAC | |
| 5′-AAGGAAGAGGAAACGTGGAGACACCAGCGTGGTATCACCCTTGTGGCAGCA | (SEQ ID NO:369) |
| CCTTAGTGGGCTTCCATTCTTAT | |
| 5′-GGTTAGGTAAGGACCGAGGACTATCCGATTCGGACTAAGGACGGCTCACTA | (SEQ ID NO:370) |
| CC | |
| 5′-GGCTTCGATGCCCTGCTGCCTGGCTCCGGTCCCCTCACTCCTGAGTCCCTT | (SEQ ID NO:371) |
| TC | |
| 5′-GATGAGGAACGGACTATGGACGCTCCGAGTAGGACAAGGGACGACTCGTTT | (SEQ ID NO:372) |
| CC | |
| 5′-GAGTAGGGCGGCCTGATACCTGAGTCCAAGGTCCTGCAACCTGGGGCCCTC | (SEQ ID NO:373) |
| TT | |
| 5′-TACTGGGCTAGGACATGGGACAACACGGTGCGGACGCTGGACAGACCAAGC | (SEQ ID NO:374) |
| TC | |
| 5′-GAACAGAGTTCCCTGTCTCCTGTATTCGAGATCCTGGTTCCTGGCTCCTTC | (SEQ ID NO:375) |
| TG | |
| 5′-GGAGCGTGGACCTTGGACTCACCGCACCGTGTTGTGGATCTCGAATACACC | (SEQ ID NO:376) |
| CGCCAAACCGACGGAATGTGGAACCACCCATGTGGTTGCACCATAGTGGAGTCA | |
| CCTCGGTGGAATCCTACGGAACGACCCACCGAATCGGATAGTGGGGACCGGAGC | |
| CACCTACTC | |
| 5′-GGTAGTGAGCCGTGGGCATCGAAGCC | (SEQ ID NO:377) |
| 5′-GGAAACGAGTCGTGGCCGCCCTACTC | (SEQ ID NO:378) |
| 5′-GAGCTTGGTCTGTGGGAACTCTGTTC | (SEQ ID NO:379) |
| 5′-GCGACTTCACCTTACCTAACC | (SEQ ID NO:380) |
| 5′-GAAAGGGACTCACCGTTCCTCATC | (SEQ ID NO:381) |
| 5′-AAGAGGGCCCCACCTAGCCCAGTA | (SEQ ID NO:382) |
| 5′-CAGAAGGAGCCACCGCCTCCA | (SEQ ID NO:383) |
| FIG. 17: | |
| GATGGCGACATCCTGCCGCTATGATTACACAGCCTGAGCATTGACACG | (SEQ ID NO:391) |
| AATGCTCACCGATCA | (SEQ ID NO:392) |
| CGACCATGATCGGACGATACTACATGCCAGTTGGACTAACGGCGCTAC | (SEQ ID NO:393) |
| CCGTTAGTGGATGTC | (SEQ ID NO:394) |
| TGTAGTATCGTGGCTGTGTAATCATAGCGGCACCAACTGGCA | (SEQ ID NO:395) |

We claim:

1. A finite nucleic acid tiling array, comprising a plurality of nucleic acid tiles joined to one another via sticky ends, wherein each nucleic acid tile comprises one or more sticky ends, and wherein a sticky end for a given nucleic acid tile is complementary to a single sticky end of another nucleic acid tile in the nucleic acid tiling array; wherein the nucleic acid tiles are present at predetermined positions within the nucleic acid tiling array as a result of programmed base pairing between the sticky ends of the nucleic acid tiles.

2. The finite nucleic acid tiling array of claim 1, wherein one or more boundary tiles in the nucleic acid tiling array further comprise modification of one or more polynucleotides that terminate further self-assembly of the nucleic acid tiles.

3. The finite nucleic acid tiling array of claim 1, wherein the nucleic acid tiling array comprises an indexing feature to orient the tiling array.

4. The finite nucleic acid tiling array of claim 1, wherein each sticky end for a given nucleic acid tile is unique to it, and wherein each sticky end for a given nucleic acid tile is complementary to a single sticky end of one other nucleic acid tile in the nucleic acid tiling array.

5. The finite nucleic acid tiling array of claim 1, wherein the number of unique tiles present in the nucleic acid tiling array is determined by a formula selected from the group consisting of:
(a) N/m, where m is 2, 3, 4, or 6 and represents a symmetry of the nucleic acid tiling array, and wherein N/m is an integral number; and
(b) N/m+1, where m is 2, 3, 4, or 6 and represents a symmetry of the nucleic acid tiling array, and wherein N/m is not an integral number.

6-15. (canceled)

16. The nucleic acid tiling array of claim 1, wherein a plurality of the nucleic acid tiles further comprise a nucleic acid probe capable of binding to a target, wherein the nucleic acid probe is attached to the core polynucleotide structure.

17. The nucleic acid tiling array of claim 16, wherein each nucleic acid probe is unique to the nucleic acid tile on which it is found.

18-19. (canceled)

20. The nucleic acid tiling array of claim 16, further comprising bound ligand.

21-22. (canceled)

23. A method of making the nucleic acid tiling array of claim 1, comprising
(a) forming nucleic acid tiles, comprising combining a stoichiometric amount of each polynucleotide in the nucleic acid tile under conditions suitable for specific hybridization of the polynucleotides to form the nucleic acid tile;
(b) combining the nucleic acid tiles, wherein a sticky end for a given nucleic acid tile is complementary to a single sticky end of another nucleic acid tile in the nucleic acid tiling array, and wherein each sticky end of a single nucleic acid tile specifically base pairs with a single sticky end on another nucleic acid tile, wherein the combining occurs under conditions suitable to promote specific hybridization of the sticky ends between different nucleic acid tiles;
(c) wherein the specific hybridization of the sticky ends between different nucleic acid tiles results in formation of a finite nucleic acid tiling array.

24-25. (canceled)

26. A method for detecting a ligand of interest, comprising:
(a) contacting the nucleic acid tiling array of claim 1 with a test sample thought to contain a ligand for which a probe is attached to the nucleic acid tiling array, under conditions to promote binding between the probe and the ligand; and
(b) detecting presence of the ligand bound to the probe on the nucleic acid tiling array.

27. (canceled)

28. The method of claim 26, wherein the method is used to detect hybridization between a nucleic acid probe and the ligand.

29-32. (canceled)

33. A nucleic acid tiling array, comprising:
(a) one or more nucleic acid tiles, wherein each nucleic acid tile in the nucleic acid tiling array comprises a plurality of nucleic acid probes capable of binding to a target, wherein the nucleic acid probes are attached at predetermined locations on the nucleic acid tile; and
(b) an indexing feature;
wherein the nucleic acid tiling array is of a predetermined size.

34. The nucleic acid tiling array of claim 33, comprising three or more nucleic acid tiles.

35. The nucleic acid tiling of claim 33 wherein each nucleic acid tile comprises nucleic acid probes unique to that tile.

36. The nucleic acid tiling array of claim 33, comprising:
(a) a nucleic acid thread strand;
(b) a plurality of helper nucleic acid strands that are complementary to the nucleic acid thread strand; wherein a plurality of the helper nucleic acid strands further comprises a nucleic acid probe; and wherein the nucleic acid thread strand is folded into a desired shape by hybridization to the helper strands;
wherein the nucleic acid thread strand is not complementary to any of the nucleic acid probes, and wherein the predetermined size of the array is determined by the length and shape of the nucleic acid thread strand.

37. The nucleic acid tiling array of claim 36 further comprising nucleic acid filler strands that hybridize to the nucleic acid thread strand.

38. The nucleic acid tiling array of claim 36, wherein a plurality of the nucleic acid filler strands further comprises a nucleic acid probe.

39. The nucleic acid tiling array of claim 36, wherein each of the nucleic acid probes is unique.

40. The nucleic acid tiling array of claim 33, wherein the target is selected from the group consisting of DNA, RNA, polypeptides, lipids, carbohydrates, other organic molecules, inorganic molecules and metallic particles, magnets, and quantum dots.

41. The nucleic acid tiling array of claim 40, further comprising bound ligand.

42. The nucleic acid tiling array of claim 41, wherein the bound ligand is selected from the group consisting of DNA, RNA, polypeptides, lipids, carbohydrates, other organic molecules, inorganic molecules and metallic particles, magnets, and quantum dots.

43. (canceled)

44. The nucleic acid tiling array of claim 33, wherein one or more of the helper strands protrude from one or more larger nucleic acid structures.

45. The nucleic acid tiling array of claim 44, wherein the larger nucleic acid structures comprise nucleic acid tiles.

46. The nucleic acid tiling array of claim 44, wherein the larger nucleic acid structures comprise nucleic acid tiling arrays.

47. The nucleic acid tiling array of claim 1, further comprising one or more chemical modifications to permit affinity separation of the nucleic acid tiling array.


SEQUENCE LISTING (395 sequences)

SEQ ID NO: 1 - DNA, 35 bp, Artificial Sequence
  Synthetic
gctaccctgtagacccgtttctcacgggacgcctc

SEQ ID NO: 2 - DNA, 20 bp, Artificial Sequence
  Synthetic
tttgaggcgtggtgctcttt

SEQ ID NO: 3 - DNA, 35 bp, Artificial Sequence
  Synthetic
gagcaccggatctaagtcgttccgacggacgaacc

SEQ ID NO: 4 - DNA, 28 bp, Artificial Sequence
  Synthetic
aaatcccggttcgtgggcatcaacccaa

SEQ ID NO: 5 - DNA, 35 bp, Artificial Sequence
  Synthetic
gatgccctgaccgagtccccatagatggacaagcc

SEQ ID NO: 6 - DNA, 20 bp, Artificial Sequence
  Synthetic
tttggcttgtggcacttttt

SEQ ID NO: 7 - DNA, 35 bp, Artificial Sequence
  Synthetic
aagtgccaggtcgaaatgcacacgtaggacattca

SEQ ID NO: 8 - DNA, 20 bp, Artificial Sequence
  Synthetic
ttttgaatgtgggtagcttt

SEQ ID NO: 9 - DNA, 100 bp, Artificial Sequence
  Synthetic
gatcccccgtgagaattttacgggtctacacctacgtgtgttttcatttcgaccaccatctatggttttggactcggtcaccgtcggaacttttgactta

SEQ ID NO: 10 - DNA, 43 bp, Artificial Sequence
  Synthetic
gggatttgctaccctgtagacatctccatgccaaaacctggcc

SEQ ID NO: 11 - DNA, 29 bp, Artificial Sequence
  Synthetic
ggagatttccgtttctcacgggacgcctc

SEQ ID NO: 12 - DNA, 20 bp, Artificial Sequence
  Synthetic
tttgaggcgtggtgctcttt

SEQ ID NO: 13 - DNA, 42 bp, Artificial Sequence
  Synthetic
gagcaccggatctaagtcgttccgacggacgaaccgctgttc

SEQ ID NO: 14 - DNA, 14 bp, Artificial Sequence
  Synthetic
ggttcgtgggcatc

SEQ ID NO: 15 - DNA, 49 bp, Artificial Sequence
  Synthetic
gcacgatgatgccctgaccgagtccccatagatggacaagccgcttcac

SEQ ID NO: 16 - DNA, 14 bp, Artificial Sequence
  Synthetic
ggcttgtggcactt

SEQ ID NO: 17 - DNA, 49 bp, Artificial Sequence
  Synthetic
agactgcaagtgccaggtcgaaatgcacacgtaggacattcattgggtt

SEQ ID NO: 18 - DNA, 14 bp, Artificial Sequence
  Synthetic
tgaatgtgggtagc

SEQ ID NO: 19 - DNA, 100 bp, Artificial Sequence; identical to SEQ ID NO: 9
  Synthetic

SEQ ID NO: 20 - DNA, 36 bp, Artificial Sequence
  Synthetic
gctaccctgtagacatctcccacgcatcgcggtacg

SEQ ID NO: 21 - DNA, 29 bp, Artificial Sequence
  Synthetic
ggagatttccgtttctcacgggacgcctc

SEQ ID NO: 22 - DNA, 20 bp, Artificial Sequence
  Synthetic
tttgaggcgtggtgctcttt

SEQ ID NO: 23 - DNA, 35 bp, Artificial Sequence; identical to SEQ ID NO: 3
  Synthetic

SEQ ID NO: 24 - DNA, 28 bp, Artificial Sequence
  Synthetic
gacgcaaggttcgtgggcatctctgagc

SEQ ID NO: 25 - DNA, 35 bp, Artificial Sequence; identical to SEQ ID NO: 5
  Synthetic

SEQ ID NO: 26 - DNA, 28 bp, Artificial Sequence
  Synthetic
aacccagggcttgtggcactttgccgac

SEQ ID NO: 27 - DNA, 35 bp, Artificial Sequence; identical to SEQ ID NO: 7
  Synthetic

SEQ ID NO: 28 - DNA, 28 bp, Artificial Sequence
  Synthetic
atcgtgctgaatgtgggtagcgaacagc

SEQ ID NO: 29 - DNA, 100 bp, Artificial Sequence; identical to SEQ ID NO: 9
  Synthetic

SEQ ID NO: 30 - DNA, 43 bp, Artificial Sequence
  Synthetic
ttgcgtcgctaccctgtagacatctccccagccgggcgtggct

SEQ ID NO: 31 - DNA, 29 bp, Artificial Sequence
  Synthetic
ggagatttccgtttctcacgggacgcctc

SEQ ID NO: 32 - DNA, 20 bp, Artificial Sequence
  Synthetic
tttgaggcgtggtgctcttt

SEQ ID NO: 33 - DNA, 35 bp, Artificial Sequence; identical to SEQ ID NO: 3
  Synthetic

SEQ ID NO: 34 - DNA, 20 bp, Artificial Sequence
  Synthetic
tttggttcgtgggcatcttt

SEQ ID NO: 35 - DNA, 42 bp, Artificial Sequence
  Synthetic
gatgccctgaccgagtccccatagatggacaagcccgctgat

SEQ ID NO: 36 - DNA, 14 bp, Artificial Sequence
  Synthetic
ggcttgtggcactt

SEQ ID NO: 37 - DNA, 49 bp, Artificial Sequence
  Synthetic
gccagataagtgccaggtcgaaatgcacacgtaggacattcagctcaga

SEQ ID NO: 38 - DNA, 14 bp, Artificial Sequence
  Synthetic
tgaatgtgggtagc

SEQ ID NO: 39 - DNA, 100 bp, Artificial Sequence; identical to SEQ ID NO: 9
  Synthetic

SEQ ID NO: 40 - DNA, 36 bp, Artificial Sequence
  Synthetic
gctaccctgtagacatctccatcatcgtcgacgatg

SEQ ID NO: 41 - DNA, 29 bp, Artificial Sequence
  Synthetic
ggagatttccgtttctcacgggacgcctc

SEQ ID NO: 42 - DNA, 28 bp, Artificial Sequence
  Synthetic
gcagtctgaggcgtggtgctcgtgaagc

SEQ ID NO: 43 - DNA, 35 bp, Artificial Sequence; identical to SEQ ID NO: 3
  Synthetic

SEQ ID NO: 44 - DNA, 28 bp, Artificial Sequence
  Synthetic
atgcgagggttcgtgggcatcaccatgt

SEQ ID NO: 45 - DNA, 35 bp, Artificial Sequence; identical to SEQ ID NO: 5
  Synthetic

SEQ ID NO: 46 - DNA, 28 bp, Artificial Sequence
  Synthetic
taggatcggcttgtggcacttgtctgta

SEQ ID NO: 47 - DNA, 35 bp, Artificial Sequence; identical to SEQ ID NO: 7
  Synthetic

SEQ ID NO: 48 - DNA, 20 bp, Artificial Sequence
  Synthetic
ttttgaatgtgggtagcttt

SEQ ID NO: 49 - DNA, 100 bp, Artificial Sequence; identical to SEQ ID NO: 9
  Synthetic

SEQ ID NO: 50 - DNA, 43 bp, Artificial Sequence
  Synthetic
ctcgcatgctaccctgtagacatctcctgctcgacacgcaact

SEQ ID NO: 51 - DNA, 36 bp, Artificial Sequence
  Synthetic
ggagatttccgtttctcacgggacgcctcgtcggca

SEQ ID NO: 52 - DNA, 14 bp, Artificial Sequence
  Synthetic
gaggcgtggtgctc

SEQ ID NO: 53 - DNA, 49 bp, Artificial Sequence
  Synthetic
ctgggttgagcaccggatctaagtcgttccgacggacgaaccgccactt

SEQ ID NO: 54 - DNA, 14 bp, Artificial Sequence
  Synthetic
ggttcgtgggcatc

SEQ ID NO: 55 - DNA, 49 bp, Artificial Sequence
  Synthetic
actattggatgccctgaccgagtccccatagatggacaagccacctaga

SEQ ID NO: 56 - DNA, 14 bp, Artificial Sequence
  Synthetic
ggcttgtggcactt

SEQ ID NO: 57 - DNA, 49 bp, Artificial Sequence
  Synthetic
ttgtgacaagtgccaggtcgaaatgcacacgtaggacattcaacatggt

SEQ ID NO: 58 - DNA, 14 bp, Artificial Sequence
  Synthetic
tgaatgtgggtagc

SEQ ID NO: 59 - DNA, 100 bp, Artificial Sequence; identical to SEQ ID NO: 9
  Synthetic

SEQ ID NO: 60 - DNA, 36 bp, Artificial Sequence
  Synthetic
gctaccctgtagacatctccacccccggctgcaaca

SEQ ID NO: 61 - DNA, 29 bp, Artificial Sequence
  Synthetic
ggagatttccgtttctcacgggacgcctc

SEQ ID NO: 62 - DNA, 28 bp, Artificial Sequence
  Synthetic
atctggcgaggcgtggtgctcatcagcg

SEQ ID NO: 63 - DNA, 35 bp, Artificial Sequence; identical to SEQ ID NO: 3
  Synthetic

SEQ ID NO: 64 - DNA, 20 bp, Artificial Sequence
  Synthetic
tttggttcgtgggcatcttt

SEQ ID NO: 65 - DNA, 35 bp, Artificial Sequence; identical to SEQ ID NO: 5
  Synthetic

SEQ ID NO: 66 - DNA, 28 bp, Artificial Sequence
  Synthetic
ggcgatcggcttgtggcactttccgata

SEQ ID NO: 67 - DNA, 35 bp, Artificial Sequence; identical to SEQ ID NO: 7
  Synthetic

SEQ ID NO: 68 - DNA, 28 bp, Artificial Sequence
  Synthetic
caatagttgaatgtgggtagcaagtggc

SEQ ID NO: 69 - DNA, 100 bp, Artificial Sequence; identical to SEQ ID NO: 9
  Synthetic

SEQ ID NO: 70 - DNA, 36 bp, Artificial Sequence
  Synthetic
gctaccctgtagacatctccaatagcttgagttgcg

SEQ ID NO: 71 - DNA, 36 bp, Artificial Sequence
  Synthetic
ggagatttccgtttctcacgggacgcctctacagac

SEQ ID NO: 72 - DNA, 14 bp, Artificial Sequence
  Synthetic
gaggcgtggtgctc

SEQ ID NO: 73 - DNA, 49 bp, Artificial Sequence
  Synthetic
gatcctagagcaccggatctaagtcgttccgacggacgaaccgcctaat

SEQ ID NO: 74 - DNA, 14 bp, Artificial Sequence
  Synthetic
ggttcgtgggcatc

SEQ ID NO: 75 - DNA, 42 bp, Artificial Sequence
  Synthetic
tacggaggatgccctgaccgagtccccatagatggacaagcc

SEQ ID NO: 76 - DNA, 20 bp, Artificial Sequence
  Synthetic
tttggcttgtggcacttttt

SEQ ID NO: 77 - DNA, 35 bp, Artificial Sequence; identical to SEQ ID NO: 7
  Synthetic

SEQ ID NO: 78 - DNA, 20 bp, Artificial Sequence
  Synthetic
ttttgaatgtgggtagcttt

SEQ ID NO: 79 - DNA, 100 bp, Artificial Sequence; identical to SEQ ID NO: 9
  Synthetic

SEQ ID NO: 80 - DNA, 36 bp, Artificial Sequence
  Synthetic
gctaccctgtagacatctccaggttgcttatcatcc

SEQ ID NO: 81 - DNA, 29 bp, Artificial Sequence
  Synthetic
ggagatttccgtttctcacgggacgcctc

SEQ ID NO: 82 - DNA, 28 bp, Artificial Sequence
  Synthetic
gtcacaagaggcgtggtgctctctaggt

SEQ ID NO: 83 - DNA, 35 bp, Artificial Sequence; identical to SEQ ID NO: 3
  Synthetic

SEQ ID NO: 84 - DNA, 28 bp, Artificial Sequence
  Synthetic
ttatgtgggttcgtgggcatcaatccct

SEQ ID NO: 85 - DNA, 35 bp, Artificial Sequence; identical to SEQ ID NO: 5
  Synthetic

SEQ ID NO: 86 - DNA, 20 bp, Artificial Sequence
  Synthetic
tttggcttgtggcacttttt

SEQ ID NO: 87 - DNA, 35 bp, Artificial Sequence; identical to SEQ ID NO: 7
  Synthetic

SEQ ID NO: 88 - DNA, 28 bp, Artificial Sequence
  Synthetic
ctccgtatgaatgtgggtagcattaggc

SEQ ID NO: 89 - DNA, 100 bp, Artificial Sequence; identical to SEQ ID NO: 9
  Synthetic

SEQ ID NO: 90 - DNA, 43 bp, Artificial Sequence
  Synthetic
cacataagctaccctgtagacatctccgcgaatggttggtcag

SEQ ID NO: 91 - DNA, 36 bp, Artificial Sequence
  Synthetic
ggagatttccgtttctcacgggacgcctctatcgga

SEQ ID NO: 92 - DNA, 14 bp, Artificial Sequence
  Synthetic
gaggcgtggtgctc

SEQ ID NO: 93 - DNA, 42 bp, Artificial Sequence
  Synthetic
gatcgccgagcaccggatctaagtcgttccgacggacgaacc

SEQ ID NO: 94 - DNA, 20 bp, Artificial Sequence
  Synthetic
tttggttcgtgggcatcttt

SEQ ID NO: 95 - DNA, 35 bp, Artificial Sequence; identical to SEQ ID NO: 5
  Synthetic

SEQ ID NO: 96 - DNA, 20 bp, Artificial Sequence
  Synthetic
tttggcttgtggcacttttt

SEQ ID NO: 97 - DNA, 42 bp, Artificial Sequence
  Synthetic
aagtgccaggtcgaaatgcacacgtaggacattcaagggatt

SEQ ID NO: 98 - DNA, 14 bp, Artificial Sequence
  Synthetic
tgaatgtgggtagc

SEQ ID NO: 99 - DNA, 100 bp, Artificial Sequence; identical to SEQ ID NO: 9
  Synthetic

SEQ ID NO: 100 - DNA, 43 bp, Artificial Sequence
  Synthetic
ttttgctaccctgtagacccgtttctcacgggacgcctctttt

SEQ ID NO: 101 - DNA, 46 bp, Artificial Sequence
  Synthetic
ttttgagcaccggatctaagtcgttccgacggacgaaccgctgttc

SEQ ID NO: 102 - DNA, 49 bp, Artificial Sequence; identical to SEQ ID NO: 15
  Synthetic

SEQ ID NO: 103 - DNA, 46 bp, Artificial Sequence
  Synthetic
agactgcaagtgcctggtcgaaatgcacacgtaggacattcatttt

SEQ ID NO: 104 - DNA, 14 bp, Artificial Sequence
  Synthetic
gaggcgtggtgctc

SEQ ID NO: 105 - DNA, 14 bp, Artificial Sequence
  Synthetic
ggttcgtgggcatc

SEQ ID NO: 106 - DNA, 14 bp, Artificial Sequence
  Synthetic
ggcttgtggcactt

SEQ ID NO: 107 - DNA, 14 bp, Artificial Sequence
  Synthetic
tgaatgtgggtagc

SEQ ID NO: 108 - DNA, 100 bp, Artificial Sequence; identical to SEQ ID NO: 9
  Synthetic

SEQ ID NO: 109 - DNA, 35 bp, Artificial Sequence; identical to SEQ ID NO: 1
  Synthetic

SEQ ID NO: 110 - DNA, 35 bp, Artificial Sequence; identical to SEQ ID NO: 3
  Synthetic

SEQ ID NO: 111 - DNA, 35 bp, Artificial Sequence; identical to SEQ ID NO: 5
  Synthetic

SEQ ID NO: 112 - DNA, 35 bp, Artificial Sequence
  Synthetic
aagtgcctggtcgaaatgcacacgtaggacattca

SEQ ID NO: 113 - DNA, 22 bp, Artificial Sequence
  Synthetic
ttttgaggcgtggtgctctttt

SEQ ID NO: 114 - DNA, 28 bp, Artificial Sequence
  Synthetic
gacgcaaggttcgtgggcatctctgagc

SEQ ID NO: 115 - DNA, 28 bp, Artificial Sequence
  Synthetic
aacccagggcttgtggcactttgccgac

SEQ ID NO: 116 - DNA, 28 bp, Artificial Sequence
  Synthetic
atcgtgctgaatgtgggtagcgaacagc

SEQ ID NO: 117 - DNA, 100 bp, Artificial Sequence; identical to SEQ ID NO: 9
  Synthetic

SEQ ID NO: 118 - DNA, 46 bp, Artificial Sequence
  Synthetic
ttgcgtcgctaccctgtagacccgtttctcacgggacgcctctttt

SEQ ID NO: 119 - DNA, 46 bp, Artificial Sequence
  Synthetic
ttttgagcaccggatctaagtcgttccgacggacgaaccctcgcat

SEQ ID NO: 120 - DNA, 49 bp, Artificial Sequence
  Synthetic
acatggtgatgccctgaccgagtccccatagatggacaagccgatccta

SEQ ID NO: 121 - DNA, 49 bp, Artificial Sequence
  Synthetic
tacagacaagtgcctggtcgaaatgcacacgtaggacattcagctcaga

SEQ ID NO: 122 - DNA, 14 bp, Artificial Sequence
  Synthetic
gaggcgtggtgctc

SEQ ID NO: 123 - DNA, 14 bp, Artificial Sequence
  Synthetic
ggttcgtgggcatc

SEQ ID NO: 124 - DNA, 14 bp, Artificial Sequence
  Synthetic
ggcttgtggcactt

SEQ ID NO: 125 - DNA, 14 bp, Artificial Sequence
  Synthetic
tgaatgtgggtagc

SEQ ID NO: 126 - DNA, 100 bp, Artificial Sequence; identical to SEQ ID NO: 9
  Synthetic

SEQ ID NO: 127 - DNA, 35 bp, Artificial Sequence; identical to SEQ ID NO: 1
  Synthetic

SEQ ID NO: 128 - DNA, 35 bp, Artificial Sequence; identical to SEQ ID NO: 3
  Synthetic

SEQ ID NO: 129 - DNA, 35 bp, Artificial Sequence; identical to SEQ ID NO: 5
  Synthetic

SEQ ID NO: 130 - DNA, 35 bp, Artificial Sequence; identical to SEQ ID NO: 112
  Synthetic

SEQ ID NO: 131 - DNA, 22 bp, Artificial Sequence
  Synthetic
ttttgaggcgtggtgctctttt

SEQ ID NO: 132 - DNA, 28 bp, Artificial Sequence
  Synthetic
gcagtctggttcgtgggcatcgtgaagc

SEQ ID NO: 133 - DNA, 28 bp, Artificial Sequence
  Synthetic
atcagcgggcttgtggcacttatctggc

SEQ ID NO: 134 - DNA, 28 bp, Artificial Sequence
  Synthetic
accatgttgaatgtgggtagcatgcgag

SEQ ID NO: 135 - DNA, 100 bp, Artificial Sequence; identical to SEQ ID NO: 9
  Synthetic

SEQ ID NO: 136 - DNA, 49 bp, Artificial Sequence
  Synthetic
cgctgatgctaccctgtagacccgtttctcacgggacgcctcgtcggca

SEQ ID NO: 137 - DNA, 49 bp, Artificial Sequence
  Synthetic
ctgggttgagcaccggatctaagtcgttccgacggacgaaccgcctaat

SEQ ID NO: 138 - DNA, 49 bp, Artificial Sequence
  Synthetic
tacggaggatgccctgaccgagtccccatagatggacaagccagggatt

SEQ ID NO: 139 - DNA, 49 bp, Artificial Sequence
  Synthetic
cacataaaagtgcctggtcgaaatgcacacgtaggacattcagccagat

SEQ ID NO: 140 - DNA, 14 bp, Artificial Sequence
  Synthetic
gaggcgtggtgctc

SEQ ID NO: 141 - DNA, 14 bp, Artificial Sequence
  Synthetic
ggttcgtgggcatc

SEQ ID NO: 142 - DNA, 14 bp, Artificial Sequence
  Synthetic
ggcttgtggcactt

SEQ ID NO: 143 - DNA, 14 bp, Artificial Sequence
  Synthetic
tgaatgtgggtagc

SEQ ID NO: 144 - DNA, 100 bp, Artificial Sequence; identical to SEQ ID NO: 9
  Synthetic

SEQ ID NO: 145 - DNA, 35 bp, Artificial Sequence; identical to SEQ ID NO: 1
  Synthetic

SEQ ID NO: 146 - DNA, 35 bp, Artificial Sequence; identical to SEQ ID NO: 3
  Synthetic

SEQ ID NO: 147 - DNA, 35 bp, Artificial Sequence; identical to SEQ ID NO: 5
  Synthetic

SEQ ID NO: 148 - DNA, 35 bp, Artificial Sequence; identical to SEQ ID NO: 112
  Synthetic

SEQ ID NO: 149 - DNA, 28 bp, Artificial Sequence
  Synthetic
gtctgtagaggcgtggtgctctaggatc

SEQ ID NO: 150 - DNA, 28 bp, Artificial Sequence
  Synthetic
ttatgtgggttcgtgggcatcaatccct

SEQ ID NO: 151 - DNA, 28 bp, Artificial Sequence
  Synthetic
caatagtggcttgtggcacttaagtggc

SEQ ID NO: 152 - DNA, 28 bp, Artificial Sequence
  Synthetic
ctccgtatgaatgtgggtagcattaggc

SEQ ID NO: 153 - DNA, 100 bp, Artificial Sequence; identical to SEQ ID NO: 9
  Synthetic

SEQ ID NO: 154 - DNA, 49 bp, Artificial Sequence
  Synthetic
actattggctaccctgtagacccgtttctcacgggacgcctcgccactt

SEQ ID NO: 155 - DNA, 49 bp, Artificial Sequence
  Synthetic
actattggagcaccggatctaagtcgttccgacggacgaaccgccactt

SEQ ID NO: 156 - DNA, 49 bp, Artificial Sequence
  Synthetic
actattggatgccctgaccgagtccccatagatggacaagccgccactt

SEQ ID NO: 157 - DNA, 49 bp, Artificial Sequence
  Synthetic
actattgaagtgcctggtcgaaatgcacacgtaggacattcagccactt

SEQ ID NO: 158 - DNA, 14 bp, Artificial Sequence
  Synthetic
gaggcgtggtgctc

SEQ ID NO: 159 - DNA, 14 bp, Artificial Sequence
  Synthetic
ggttcgtgggcatc

SEQ ID NO: 160 - DNA, 14 bp, Artificial Sequence
  Synthetic
ggcttgtggcactt

SEQ ID NO: 161 - DNA, 14 bp, Artificial Sequence
  Synthetic
tgaatgtgggtagc

SEQ ID NO: 162 - DNA, 100 bp, Artificial Sequence; identical to SEQ ID NO: 9
  Synthetic

SEQ ID NO: 163 - DNA, 60 bp, Artificial Sequence
  Synthetic
agggattataagaatggaagccctgggtcgttccgtaggattcctgaagtcgcttatgtg

SEQ ID NO: 164 - DNA, 60 bp, Artificial Sequence
  Synthetic
agggatttggaggcggacattccgtcggtttggcgggacgtttcctcttccttttatgtg

SEQ ID NO: 165 - DNA, 74 bp, Artificial Sequence
  Synthetic
aaggaagaggaaacgtggagacaccagcgtggtatcacccttgtggcagcaccttagtgggcttccattcttat

SEQ ID NO: 166 - DNA, 53 bp, Artificial Sequence
  Synthetic
ggttaggtaaggaccgaggactatccgattcggactaaggacggctcactacc

SEQ ID NO: 167 - DNA, 53 bp, Artificial Sequence
  Synthetic
ggcttcgatgccctgctgcctggctccggtcccctgactcctgagtccctttc

SEQ ID NO: 168 - DNA, 53 bp, Artificial Sequence
  Synthetic
gatgaggaacggactatggacgctccgagtaggacaagggacgactcgtttcc

SEQ ID NO: 169 - DNA, 53 bp, Artificial Sequence
  Synthetic
gagtagggcggcctgatacctgagtccaaggtcctgcaacctggggccctctt

SEQ ID NO: 170 - DNA, 53 bp, Artificial Sequence
  Synthetic
tactgggctaggacatgggacaacacggtgcggacgctggacagaccaagctc

SEQ ID NO: 171 - DNA, 53 bp, Artificial Sequence
  Synthetic
gaacagagttccctgtctcctgtattcgagatcctggttcctggctccttctg

SEQ ID NO: 172 - DNA, 168 bp, Artificial Sequence
  Synthetic
ggagcgtggaccttggactcaccgcaccgtgttgtggatctcgaatacacccgccaaaccgacggaatgtggaaccacccatgtggttgcaccatagtggagtcacctcggtggaatcctacggaacgacccaccgaatcggatagtggggaccggagccacctactc

SEQ ID NO: 173 - DNA, 26 bp, Artificial Sequence
  Synthetic
ggtagtgagccgtgggcatcgaagcc

SEQ ID NO: 174 - DNA, 26 bp, Artificial Sequence
  Synthetic
ggaaacgagtcgtggccgccctactc

SEQ ID NO: 175 - DNA, 26 bp, Artificial Sequence
  Synthetic
gagcttggtctgtgggaactctgttc

SEQ ID NO: 176 - DNA, 21 bp, Artificial Sequence
  Synthetic
gcgacttcaccttacctaacc

SEQ ID NO: 177 - DNA, 24 bp, Artificial Sequence
  Synthetic
gaaagggactcaccgttcctcatc

SEQ ID NO: 178 - DNA, 24 bp, Artificial Sequence
  Synthetic
aagagggccccacctagcccagta

SEQ ID NO: 179 - DNA, 21 bp, Artificial Sequence
  Synthetic
cagaaggagccaccgcctcca

SEQ ID NO: 180 - DNA, 60 bp, Artificial Sequence
  Synthetic
acctagaataagaatggaagccctgggtcgttccgtaggattcctgaagtcgcctccgta

SEQ ID NO: 181 - DNA, 60 bp, Artificial Sequence
  Synthetic
gatcgcctggaggcggacattccgtcggtttggcgggacgtttcctcttccttgtcacaa

SEQ ID NO: 182 - DNA, 74 bp, Artificial Sequence; identical to SEQ ID NO: 165
  Synthetic

SEQ ID NO: 183 - DNA, 53 bp, Artificial Sequence; identical to SEQ ID NO: 166
  Synthetic

SEQ ID NO: 184 - DNA, 53 bp, Artificial Sequence; identical to SEQ ID NO: 167
  Synthetic

SEQ ID NO: 185 - DNA, 53 bp, Artificial Sequence; identical to SEQ ID NO: 168
  Synthetic

SEQ ID NO: 186 - DNA, 53 bp, Artificial Sequence; identical to SEQ ID NO: 169
  Synthetic

SEQ ID NO: 187 - DNA, 53 bp, Artificial Sequence; identical to SEQ ID NO: 170
  Synthetic

SEQ ID NO: 188 - DNA, 53 bp, Artificial Sequence; identical to SEQ ID NO: 171
  Synthetic

SEQ ID NO: 189 - DNA, 168 bp, Artificial Sequence; identical to SEQ ID NO: 172
  Synthetic

SEQ ID NO: 190 - DNA, 26 bp, Artificial Sequence
  Synthetic
ggtagtgagccgtgggcatcgaagcc

SEQ ID NO: 191 - DNA, 26 bp, Artificial Sequence
  Synthetic
ggaaacgagtcgtggccgccctactc

SEQ ID NO: 192 - DNA, 26 bp, Artificial Sequence
  Synthetic
gagcttggtctgtgggaactctgttc

SEQ ID NO: 193 - DNA, 21 bp, Artificial Sequence
  Synthetic
gcgacttcaccttacctaacc

SEQ ID NO: 194 - DNA, 24 bp, Artificial Sequence
  Synthetic
gaaagggactcaccgttcctcatc

SEQ ID NO: 195 - DNA, 24 bp, Artificial Sequence
  Synthetic
aagagggccccacctagcccagta

SEQ ID NO: 196 - DNA, 21 bp, Artificial Sequence
  Synthetic
cagaaggagccaccgcctcca

SEQ ID NO: 197 - DNA, 60 bp, Artificial Sequence
  Synthetic
tatcggaataagaatggaagccctgggtcgttccgtaggattcctgaagtcgcattaggc

SEQ ID NO: 198 - DNA, 60 bp, Artificial Sequence
  Synthetic
aatcccttggaggcggacattccgtcggtttggcgggacgtttcctcttcctttacggag

SEQ ID NO: 199 - DNA, 74 bp, Artificial Sequence; identical to SEQ ID NO: 165
  Synthetic

SEQ ID NO: 200 - DNA, 53 bp, Artificial Sequence; identical to SEQ ID NO: 166
  Synthetic

SEQ ID NO: 201 - DNA, 53 bp, Artificial Sequence; identical to SEQ ID NO: 167
  Synthetic

SEQ ID NO: 202 - DNA, 53 bp, Artificial Sequence; identical to SEQ ID NO: 168
  Synthetic

SEQ ID NO: 203 - DNA, 53 bp, Artificial Sequence; identical to SEQ ID NO: 169
  Synthetic

SEQ ID NO: 204 - DNA, 53 bp, Artificial Sequence; identical to SEQ ID NO: 170
  Synthetic

SEQ ID NO: 205 - DNA, 53 bp, Artificial Sequence; identical to SEQ ID NO: 171
  Synthetic

SEQ ID NO: 206 - DNA, 168 bp, Artificial Sequence; identical to SEQ ID NO: 172
  Synthetic

SEQ ID NO: 207 - DNA, 26 bp, Artificial Sequence
  Synthetic
ggtagtgagccgtgggcatcgaagcc

SEQ ID NO: 208 - DNA, 26 bp, Artificial Sequence
  Synthetic
ggaaacgagtcgtggccgccctactc

SEQ ID NO: 209 - DNA, 26 bp, Artificial Sequence
  Synthetic
gagcttggtctgtgggaactctgttc

SEQ ID NO: 210 - DNA, 21 bp, Artificial Sequence
  Synthetic
gcgacttcaccttacctaacc

SEQ ID NO: 211 - DNA, 24 bp, Artificial Sequence
  Synthetic
gaaagggactcaccgttcctcatc

SEQ ID NO: 212 - DNA, 24 bp, Artificial Sequence
  Synthetic
aagagggccccacctagcccagta

SEQ ID NO: 213 - DNA, 21 bp, Artificial Sequence
  Synthetic
cagaaggagccaccgcctcca

SEQ ID NO: 214 - DNA, 60 bp, Artificial Sequence
  Synthetic
actattgataagaatggaagccctgggtcgttccgtaggattcctgaagtcgcgatccta

SEQ ID NO: 215 - DNA, 60 bp, Artificial Sequence
  Synthetic
gtctgtatggaggcggacattccgtcggtttggcgggacgtttcctcttccttgcctaat

SEQ ID NO: 216 - DNA, 74 bp, Artificial Sequence; identical to SEQ ID NO: 165
  Synthetic

SEQ ID NO: 217 - DNA, 53 bp, Artificial Sequence; identical to SEQ ID NO: 166
  Synthetic

SEQ ID NO: 218 - DNA, 53 bp, Artificial Sequence; identical to SEQ ID NO: 167
  Synthetic

SEQ ID NO: 219 - DNA, 53 bp, Artificial Sequence; identical to SEQ ID NO: 168
  Synthetic

SEQ ID NO: 220 - DNA, 53 bp, Artificial Sequence; identical to SEQ ID NO: 169
  Synthetic

SEQ ID NO: 221 - DNA, 53 bp, Artificial Sequence; identical to SEQ ID NO: 170
  Synthetic

SEQ ID NO: 222 - DNA, 53 bp, Artificial Sequence; identical to SEQ ID NO: 171
  Synthetic

SEQ ID NO: 223 - DNA, 168 bp, Artificial Sequence; identical to SEQ ID NO: 172
  Synthetic

SEQ ID NO: 224 - DNA, 26 bp, Artificial Sequence
  Synthetic
ggtagtgagccgtgggcatcgaagcc

SEQ ID NO: 225 - DNA, 26 bp, Artificial Sequence
  Synthetic
ggaaacgagtcgtggccgccctactc

SEQ ID NO: 226 - DNA, 26 bp, Artificial Sequence
  Synthetic
gagcttggtctgtgggaactctgttc

SEQ ID NO: 227 - DNA, 21 bp, Artificial Sequence
  Synthetic
gcgacttcaccttacctaacc

SEQ ID NO: 228 - DNA, 24 bp, Artificial Sequence
  Synthetic
gaaagggactcaccgttcctcatc

SEQ ID NO: 229 - DNA, 24 bp, Artificial Sequence
  Synthetic
aagagggccccacctagcccagta

SEQ ID NO: 230 - DNA, 21 bp, Artificial Sequence
  Synthetic
cagaaggagccaccgcctcca

SEQ ID NO: 231 - DNA, 60 bp, Artificial Sequence
  Synthetic
tacagacataagaatggaagccctgggtcgttccgtaggattcctgaagtcgcgccactt

SEQ ID NO: 232 - DNA, 60 bp, Artificial Sequence
  Synthetic
ggcgatctggaggcggacattccgtcggtttggcgggacgtttcctcttccttcacataa

SEQ ID NO: 233 - DNA, 74 bp, Artificial Sequence; identical to SEQ ID NO: 165
  Synthetic

SEQ ID NO: 234 - DNA, 53 bp, Artificial Sequence; identical to SEQ ID NO: 166
  Synthetic

SEQ ID NO: 235 - DNA, 53 bp, Artificial Sequence; identical to SEQ ID NO: 167
  Synthetic

SEQ ID NO: 236 - DNA, 53 bp, Artificial Sequence; identical to SEQ ID NO: 168
  Synthetic

SEQ ID NO: 237 - DNA, 53 bp, Artificial Sequence; identical to SEQ ID NO: 169
  Synthetic

SEQ ID NO: 238 - DNA, 53 bp, Artificial Sequence; identical to SEQ ID NO: 170
  Synthetic

SEQ ID NO: 239 - DNA, 53 bp, Artificial Sequence; identical to SEQ ID NO: 171
  Synthetic

SEQ ID NO: 240 - DNA, 168 bp, Artificial Sequence; identical to SEQ ID NO: 172
  Synthetic

SEQ ID NO: 241 - DNA, 26 bp, Artificial Sequence
  Synthetic
ggtagtgagccgtgggcatcgaagcc

SEQ ID NO: 242 - DNA, 26 bp, Artificial Sequence
  Synthetic
ggaaacgagtcgtggccgccctactc

SEQ ID NO: 243 - DNA, 26 bp, Artificial Sequence
  Synthetic
gagcttggtctgtgggaactctgttc

SEQ ID NO: 244 - DNA, 21 bp, Artificial Sequence
  Synthetic
gcgacttcaccttacctaacc

SEQ ID NO: 245 - DNA, 24 bp, Artificial Sequence
  Synthetic
gaaagggactcaccgttcctcatc

SEQ ID NO: 246 - DNA, 24 bp, Artificial Sequence
  Synthetic
aagagggccccacctagcccagta

SEQ ID NO: 247 - DNA, 21 bp, Artificial Sequence
  Synthetic
cagaaggagccaccgcctcca

SEQ ID NO: 248 - DNA, 57 bp, Artificial Sequence
  Synthetic
ttttataagaatggaagccctgggtcgttccgtaggattcctgaagtcgctgtacca

SEQ ID NO: 249 - DNA, 57 bp, Artificial Sequence
  Synthetic
agactgctggaggcggacattccgtcggtttggcgggacgtttcctcttcctttttt

SEQ ID NO: 250 - DNA, 74 bp, Artificial Sequence; identical to SEQ ID NO: 165
  Synthetic

SEQ ID NO: 251 - DNA, 53 bp, Artificial Sequence; identical to SEQ ID NO: 166
  Synthetic

SEQ ID NO: 252 - DNA, 53 bp, Artificial Sequence; identical to SEQ ID NO: 167
  Synthetic

SEQ ID NO: 253 - DNA, 53 bp, Artificial Sequence; identical to SEQ ID NO: 168
  Synthetic

SEQ ID NO: 254 - DNA, 53 bp, Artificial Sequence; identical to SEQ ID NO: 169
  Synthetic

SEQ ID NO: 255 - DNA, 53 bp, Artificial Sequence; identical to SEQ ID NO: 170
  Synthetic

SEQ ID NO: 256 - DNA, 53 bp, Artificial Sequence; identical to SEQ ID NO: 171
  Synthetic

SEQ ID NO: 257 - DNA, 168 bp, Artificial Sequence; identical to SEQ ID NO: 172
  Synthetic

SEQ ID NO: 258 - DNA, 26 bp, Artificial Sequence
  Synthetic
ggtagtgagccgtgggcatcgaagcc

SEQ ID NO: 259 - DNA, 26 bp, Artificial Sequence
  Synthetic
ggaaacgagtcgtggccgccctactc

SEQ ID NO: 260 - DNA, 26 bp, Artificial Sequence
  Synthetic
gagcttggtctgtgggaactctgttc

SEQ ID NO: 261 - DNA, 21 bp, Artificial Sequence
  Synthetic
gcgacttcaccttacctaacc

SEQ ID NO: 262 - DNA, 24 bp, Artificial Sequence
  Synthetic
gaaagggactcaccgttcctcatc

SEQ ID NO: 263 - DNA, 24 bp, Artificial Sequence
  Synthetic
aagagggccccacctagcccagta

SEQ ID NO: 264 - DNA, 21 bp, Artificial Sequence
  Synthetic
cagaaggagccaccgcctcca

SEQ ID NO: 265 - DNA, 57 bp, Artificial Sequence
  Synthetic
ttttataagaatggaagccctgggtcgttccgtaggattcctgaagtcgcgagcgta

SEQ ID NO: 266 - DNA, 60 bp, Artificial Sequence
  Synthetic
tctaggttggaggcggacattccgtcggtttggcgggacgtttcctcttcctttggtaca

SEQ ID NO: 267 - DNA, 74 bp, Artificial Sequence; identical to SEQ ID NO: 165
  Synthetic

SEQ ID NO: 268 - DNA, 53 bp, Artificial Sequence; identical to SEQ ID NO: 166
  Synthetic

SEQ ID NO: 269 - DNA, 53 bp, Artificial Sequence; identical to SEQ ID NO: 167
  Synthetic

SEQ ID NO: 270 - DNA, 53 bp, Artificial Sequence; identical to SEQ ID NO: 168
  Synthetic

SEQ ID NO: 271 - DNA, 53 bp, Artificial Sequence; identical to SEQ ID NO: 169
  Synthetic

SEQ ID NO: 272 - DNA, 53 bp, Artificial Sequence; identical to SEQ ID NO: 170
  Synthetic

SEQ ID NO: 273 - DNA, 53 bp, Artificial Sequence; identical to SEQ ID NO: 171
  Synthetic

SEQ ID NO: 274 - DNA, 168 bp, Artificial Sequence; identical to SEQ ID NO: 172
  Synthetic

SEQ ID NO: 275 - DNA, 26 bp, Artificial Sequence
  Synthetic
ggtagtgagccgtgggcatcgaagcc

SEQ ID NO: 276 - DNA, 26 bp, Artificial Sequence
  Synthetic
ggaaacgagtcgtggccgccctactc

SEQ ID NO: 277 - DNA, 26 bp, Artificial Sequence
  Synthetic
gagcttggtctgtgggaactctgttc

SEQ ID NO: 278 - DNA, 21 bp, Artificial Sequence
  Synthetic
gcgacttcaccttacctaacc

SEQ ID NO: 279 - DNA, 24 bp, Artificial Sequence
  Synthetic
gaaagggactcaccgttcctcatc

SEQ ID NO: 280 - DNA, 24 bp, Artificial Sequence
  Synthetic
aagagggccccacctagcccagta

SEQ ID NO: 281 - DNA, 21 bp, Artificial Sequence
  Synthetic
cagaaggagccaccgcctcca

SEQ ID NO: 282 - DNA, 57 bp, Artificial Sequence
  Synthetic
ttttataagaatggaagccctgggtcgttccgtaggattcctgaagtcgcatcagcg

SEQ ID NO: 283 - DNA, 60 bp, Artificial Sequence
  Synthetic
tccgatatggaggcggacattccgtcggtttggcgggacgtttcctcttcctttacgctc

SEQ ID NO: 284 - DNA, 74 bp, Artificial Sequence; identical to SEQ ID NO: 165
  Synthetic

SEQ ID NO: 285 - DNA, 53 bp, Artificial Sequence; identical to SEQ ID NO: 166
  Synthetic

SEQ ID NO: 286 - DNA, 53 bp, Artificial Sequence; identical to SEQ ID NO: 167
  Synthetic

SEQ ID NO: 287 - DNA, 53 bp, Artificial Sequence; identical to SEQ ID NO: 168
  Synthetic

SEQ ID NO: 288 - DNA, 53 bp, Artificial Sequence; identical to SEQ ID NO: 169
  Synthetic

SEQ ID NO: 289 - DNA, 53 bp, Artificial Sequence; identical to SEQ ID NO: 170
  Synthetic

SEQ ID NO: 290 - DNA, 53 bp, Artificial Sequence; identical to SEQ ID NO: 171
  Synthetic

SEQ ID NO: 291 - DNA, 168 bp, Artificial Sequence; identical to SEQ ID NO: 172
  Synthetic

SEQ ID NO: 292 - DNA, 26 bp, Artificial Sequence
  Synthetic
ggtagtgagccgtgggcatcgaagcc

SEQ ID NO: 293 - DNA, 26 bp, Artificial Sequence
  Synthetic
ggaaacgagtcgtggccgccctactc

SEQ ID NO: 294 - DNA, 26 bp, Artificial Sequence
  Synthetic
gagcttggtctgtgggaactctgttc

SEQ ID NO: 295 - DNA, 21 bp, Artificial Sequence
  Synthetic
gcgacttcaccttacctaacc

SEQ ID NO: 296 - DNA, 24 bp, Artificial Sequence
  Synthetic
gaaagggactcaccgttcctcatc

SEQ ID NO: 297 - DNA, 24 bp, Artificial Sequence
  Synthetic
aagagggccccacctagcccagta

SEQ ID NO: 298 - DNA, 21 bp, Artificial Sequence
  Synthetic
cagaaggagccaccgcctcca

SEQ ID NO: 299 - DNA, 57 bp, Artificial Sequence
  Synthetic
ttttataagaatggaagccctgggtcgttccgtaggattcctgaagtcgcatctggc

SEQ ID NO: 300 - DNA, 60 bp, Artificial Sequence
  Synthetic
caatagttggaggcggacattccgtcggtttggcgggacgtttcctcttccttcgctgat

SEQ ID NO: 301 - DNA, 74 bp, Artificial Sequence; identical to SEQ ID NO: 165
  Synthetic

SEQ ID NO: 302 - DNA, 53 bp, Artificial Sequence; identical to SEQ ID NO: 166
  Synthetic

SEQ ID NO: 303 - DNA, 53 bp, Artificial Sequence; identical to SEQ ID NO: 167
  Synthetic

SEQ ID NO: 304 - DNA, 53 bp, Artificial Sequence; identical to SEQ ID NO: 168
  Synthetic

SEQ ID NO: 305 - DNA, 53 bp, Artificial Sequence; identical to SEQ ID NO: 169
  Synthetic

SEQ ID NO: 306 - DNA, 53 bp, Artificial Sequence; identical to SEQ ID NO: 170
  Synthetic

SEQ ID NO: 307 - DNA, 53 bp, Artificial Sequence; identical to SEQ ID NO: 171
  Synthetic

SEQ ID NO: 308 - DNA, 168 bp, Artificial Sequence; identical to SEQ ID NO: 172
  Synthetic

SEQ ID NO: 309 - DNA, 26 bp, Artificial Sequence
  Synthetic
ggtagtgagccgtgggcatcgaagcc

SEQ ID NO: 310 - DNA, 26 bp, Artificial Sequence
  Synthetic
ggaaacgagtcgtggccgccctactc

SEQ ID NO: 311 - DNA, 26 bp, Artificial Sequence
  Synthetic
gagcttggtctgtgggaactctgttc

SEQ ID NO: 312 - DNA, 21 bp, Artificial Sequence
  Synthetic
gcgacttcaccttacctaacc

SEQ ID NO: 313 - DNA, 24 bp, Artificial Sequence
  Synthetic
gaaagggactcaccgttcctcatc

SEQ ID NO: 314 - DNA, 24 bp, Artificial Sequence
  Synthetic
aagagggccccacctagcccagta

SEQ ID NO: 315 - DNA, 21 bp, Artificial Sequence
  Synthetic
cagaaggagccaccgcctcca

SEQ ID NO: 316 - DNA, 54 bp, Artificial Sequence
  Synthetic
ttttataagaatggaagccctgggtcgttccgtaggattcctgaagtcgctttt

SEQ ID NO: 317 - DNA, 60 bp, Artificial Sequence
  Synthetic
aacccagtggaggcggacattccgtcggtttggcgggacgtttcctcttccttgccagat

SEQ ID NO: 318 - DNA, 74 bp, Artificial Sequence; identical to SEQ ID NO: 165
  Synthetic

SEQ ID NO: 319 - DNA, 53 bp, Artificial Sequence; identical to SEQ ID NO: 166
  Synthetic

SEQ ID NO: 320 - DNA, 53 bp, Artificial Sequence; identical to SEQ ID NO: 167
  Synthetic

SEQ ID NO: 321 - DNA, 53 bp, Artificial Sequence; identical to SEQ ID NO: 168
  Synthetic

SEQ ID NO: 322 - DNA, 53 bp, Artificial Sequence; identical to SEQ ID NO: 169
  Synthetic

SEQ ID NO: 323 - DNA, 53 bp, Artificial Sequence; identical to SEQ ID NO: 170
  Synthetic

SEQ ID NO: 324 - DNA, 53 bp, Artificial Sequence; identical to SEQ ID NO: 171
  Synthetic

SEQ ID NO: 325 - DNA, 168 bp, Artificial Sequence; identical to SEQ ID NO: 172
  Synthetic

SEQ ID NO: 326 - DNA, 26 bp, Artificial Sequence
  Synthetic
ggtagtgagccgtgggcatcgaagcc

SEQ ID NO: 327 - DNA, 26 bp, Artificial Sequence
  Synthetic
ggaaacgagtcgtggccgccctactc

SEQ ID NO: 328 - DNA, 26 bp, Artificial Sequence
  Synthetic
gagcttggtctgtgggaactctgttc

SEQ ID NO: 329 - DNA, 21 bp, Artificial Sequence
  Synthetic
gcgacttcaccttacctaacc

SEQ ID NO: 330 - DNA, 24 bp, Artificial Sequence
  Synthetic
gaaagggactcaccgttcctcatc

SEQ ID NO: 331 - DNA, 24 bp, Artificial Sequence
  Synthetic
aagagggccccacctagcccagta

SEQ ID NO: 332 - DNA, 21 bp, Artificial Sequence
  Synthetic
cagaaggagccaccgcctcca

SEQ ID NO: 333 - DNA, 57 bp, Artificial Sequence
  Synthetic
ctgggttataagaatggaagccctgggtcgttccgtaggattcctgaagtcgctttt

SEQ ID NO: 334 - DNA, 60 bp, Artificial Sequence
  Synthetic
tgccgactggaggcggacattccgtcggtttggcgggacgtttcctcttcctttaggatc

SEQ ID NO: 335 - DNA, 74 bp, Artificial Sequence; identical to SEQ ID NO: 165
  Synthetic

SEQ ID NO: 336 - DNA, 53 bp, Artificial Sequence; identical to SEQ ID NO: 166
  Synthetic

SEQ ID NO: 337 - DNA, 53 bp, Artificial Sequence; identical to SEQ ID NO: 167
  Synthetic

SEQ ID NO: 338 - DNA, 53 bp, Artificial Sequence; identical to SEQ ID NO: 168
  Synthetic

SEQ ID NO: 339 - DNA, 53 bp, Artificial Sequence; identical to SEQ ID NO: 169
  Synthetic

SEQ ID NO: 340 - DNA, 53 bp, Artificial Sequence; identical to SEQ ID NO: 170
  Synthetic

SEQ ID NO: 341 - DNA, 53 bp, Artificial Sequence; identical to SEQ ID NO: 171
  Synthetic

SEQ ID NO: 342 - DNA, 168 bp, Artificial Sequence; identical to SEQ ID NO: 172
  Synthetic

SEQ ID NO: 343 - DNA, 26 bp, Artificial Sequence
  Synthetic
ggtagtgagccgtgggcatcgaagcc

SEQ ID NO: 344 - DNA, 26 bp, Artificial Sequence
  Synthetic
ggaaacgagtcgtggccgccctactc

SEQ ID NO: 345 - DNA, 26 bp, Artificial Sequence
  Synthetic
gagcttggtctgtgggaactctgttc

SEQ ID NO: 346 - DNA, 21 bp, Artificial Sequence
  Synthetic
gcgacttcaccttacctaacc

SEQ ID NO: 347 - DNA, 24 bp, Artificial Sequence
  Synthetic
gaaagggactcaccgttcctcatc

SEQ ID NO: 348 - DNA, 24 bp, Artificial Sequence
  Synthetic
aagagggccccacctagcccagta

SEQ ID NO: 349 - DNA, 21 bp, Artificial Sequence
  Synthetic
cagaaggagccaccgcctcca

SEQ ID NO: 350 - DNA, 57 bp, Artificial Sequence
  Synthetic
gtcggcaataagaatggaagccctgggtcgttccgtaggattcctgaagtcgctttt

SEQ ID NO: 351 - DNA, 60 bp, Artificial Sequence
  Synthetic
gtgaagctggaggcggacattccgtcggtttggcgggacgtttcctcttccttaagtggc

SEQ ID NO: 352 - DNA, 74 bp, Artificial Sequence; identical to SEQ ID NO: 165
  Synthetic

SEQ ID NO: 353 - DNA, 53 bp, Artificial Sequence; identical to SEQ ID NO: 166
  Synthetic

SEQ ID NO: 354 - DNA, 53 bp, Artificial Sequence; identical to SEQ ID NO: 167
  Synthetic

SEQ ID NO: 355 - DNA, 53 bp, Artificial Sequence; identical to SEQ ID NO: 168
  Synthetic

SEQ ID NO: 356 - DNA, 53 bp, Artificial Sequence; identical to SEQ ID NO: 169
  Synthetic

SEQ ID NO: 357 - DNA, 53 bp, Artificial Sequence; identical to SEQ ID NO: 170
  Synthetic

SEQ ID NO: 358 - DNA, 53 bp, Artificial Sequence; identical to SEQ ID NO: 171
  Synthetic

SEQ ID NO: 359 - DNA, 168 bp, Artificial Sequence; identical to SEQ ID NO: 172
  Synthetic

SEQ ID NO: 360 - DNA, 26 bp, Artificial Sequence
  Synthetic
ggtagtgagccgtgggcatcgaagcc

SEQ ID NO: 361 - DNA, 26 bp, Artificial Sequence
  Synthetic
ggaaacgagtcgtggccgccctactc

SEQ ID NO: 362 - DNA, 26 bp, Artificial Sequence
  Synthetic
gagcttggtctgtgggaactctgttc

SEQ ID NO: 363 - DNA, 21 bp, Artificial Sequence
  Synthetic
gcgacttcaccttacctaacc

SEQ ID NO: 364 - DNA, 24 bp, Artificial Sequence
  Synthetic
gaaagggactcaccgttcctcatc

SEQ ID NO: 365 - DNA, 24 bp, Artificial Sequence
  Synthetic
aagagggccccacctagcccagta

SEQ ID NO: 366 - DNA, 21 bp, Artificial Sequence
  Synthetic
cagaaggagccaccgcctcca

SEQ ID NO: 367 - DNA, 57 bp, Artificial Sequence
  Synthetic
gcttcacataagaatggaagccctgggtcgttccgtaggattcctgaagtcgctttt

SEQ ID NO: 368 - DNA, 60 bp, Artificial Sequence
  Synthetic
gcagtcttggaggcggacattccgtcggtttggcgggacgtttcctcttccttttgtgac

SEQ ID NO: 369 - DNA, 74 bp, Artificial Sequence; identical to SEQ ID NO: 165
  Synthetic

SEQ ID NO: 370 - DNA, 53 bp, Artificial Sequence; identical to SEQ ID NO: 166
  Synthetic

SEQ ID NO: 371 - DNA, 53 bp, Artificial Sequence; identical to SEQ ID NO: 167
  Synthetic

SEQ ID NO: 372 - DNA, 53 bp, Artificial Sequence; identical to SEQ ID NO: 168
  Synthetic

SEQ ID NO: 373 - DNA, 53 bp, Artificial Sequence; identical to SEQ ID NO: 169
  Synthetic

SEQ ID NO: 374 - DNA, 53 bp, Artificial Sequence; identical to SEQ ID NO: 170
  Synthetic

SEQ ID NO: 375 - DNA, 53 bp, Artificial Sequence; identical to SEQ ID NO: 171
  Synthetic

SEQ ID NO: 376 - DNA, 168 bp, Artificial Sequence; identical to SEQ ID NO: 172
  Synthetic

SEQ ID NO: 377 - DNA, 26 bp, Artificial Sequence
  Synthetic
ggtagtgagccgtgggcatcgaagcc

SEQ ID NO: 378 - DNA, 26 bp, Artificial Sequence
  Synthetic
ggaaacgagtcgtggccgccctactc

SEQ ID NO: 379 - DNA, 26 bp, Artificial Sequence
  Synthetic
gagcttggtctgtgggaactctgttc

SEQ ID NO: 380 - DNA, 21 bp, Artificial Sequence
  Synthetic
gcgacttcaccttacctaacc

SEQ ID NO: 381 - DNA, 24 bp, Artificial Sequence
  Synthetic
gaaagggactcaccgttcctcatc

SEQ ID NO: 382 - DNA, 24 bp, Artificial Sequence
  Synthetic
aagagggccccacctagcccagta

SEQ ID NO: 383 - DNA, 21 bp, Artificial Sequence
  Synthetic
cagaaggagccaccgcctcca

SEQ ID NO: 384 - DNA, 15 bp, Artificial Sequence
  Synthetic
cgaaggagacgacca

SEQ ID NO: 385 - DNA, 16 bp, Artificial Sequence
  Synthetic
agttgcgtgtcgagca

SEQ ID NO: 386 - DNA, 16 bp, Artificial Sequence
  Synthetic
ggatgataagcaacct

SEQ ID NO: 387 - DNA, 16 bp, Artificial Sequence
  Synthetic
ctgaccaaccattcgc

SEQ ID NO: 388 - DNA, 16 bp, Artificial Sequence
  Synthetic
catacctgtcgatgca

SEQ ID NO: 389 - protein, 9 aa, Artificial Sequence
  Synthetic
CNNPMHQNC

SEQ ID NO: 390 - protein, 12 aa, Artificial Sequence
  Synthetic
LRRSSEAHNSIV

SEQ ID NO: 391 - DNA, 48 bp, Artificial Sequence
  Synthetic
gatggcgacatcctgccgctatgattacacagcctgagcattgacacg

SEQ ID NO: 392 - DNA, 15 bp, Artificial Sequence
  Synthetic
aatgctcaccgatca

SEQ ID NO: 393 - DNA, 48 bp, Artificial Sequence
  Synthetic
cgaccatgatcggacgatactacatgccagttggactaacggcgctac

SEQ ID NO: 394 - DNA, 15 bp, Artificial Sequence
  Synthetic
ccgttagtggatgtc

SEQ ID NO: 395 - DNA, 42 bp, Artificial Sequence
  Synthetic
tgtagtatcgtggctgtgtaatcatagcggcaccaactggca